(19) United States
(12) Patent Application Publication
(10) Pub. No.: US 2026/0280652 A1
(43) Pub. Date: Sep. 17, 2026

(54) CHANNEL STATE INFORMATION (CSI) PROCESSING CONFIGURATIONS

(71) Applicant: Intel Corporation, Santa Clara, CA (US)

(72) Inventors: Viktor Sergeev, Dublin (IE); Bishwarup Mondal, San Ramon, CA (US); Gang Xiong, Beaverton, OR (US); Sergey Panteleev, Maynooth (IE); Andrey Chervyakov, Maynooth (IE); Debdeep Chatterjee, San Jose, CA (US); Dae Won Lee, Portland, OR (US)

(21) Appl. No.: 19/665,811

(22) Filed: May 1, 2026

Related U.S. Application Data
(60) Provisional application No. 63/798,963, filed on May 2, 2025.

(51) Int. Cl. H04B 7/06; H04L 5/00; H04W 72/02

(52) U.S. Cl. CPC H04B 7/0626; H04L 5/0042; H04L 5/0094; H04W 72/02

(57) ABSTRACT

An apparatus for a user equipment (UE) configured for operation in a New Radio (NR) network includes processing circuitry and memory. The processing circuitry decodes configuration information for one or more channel state information (CSI) reports received from a base station. The processing circuitry maintains a state of one or more CSI processors of the UE, each CSI processor associated with a plurality of CSI compute resources, the state indicating occupancy of the CSI compute resources at a time instance. For a CSI report, one or more CSI compute resources of at least one CSI processor are allocated based on the state. A CSI processing event is determined for the CSI report based on the state of the one or more CSI processors, and content of the CSI report is encoded for transmission to the base station based on the CSI processing event.

### PRIORITY CLAIM

This application claims the benefit of priority to U.S. Provisional Application No. 63/798,963, filed May 2, 2025, and entitled “CHANNEL STATE INFORMATION PROCESSING ASSUMPTIONS ALIGNMENT,” which application is incorporated herein by reference in its entirety.

### BACKGROUND

Mobile communications have evolved significantly from early voice systems to today's highly sophisticated integrated communication platform. With the growing number of devices communicating with various network devices, the use of 3GPP LTE systems has increased. The penetration of mobile devices (user equipments or UEs) in modern society has continued to drive demand for a wide variety of networked devices in many disparate environments. Fifth-generation (5G) wireless systems (and beyond) are expected to enable even greater speed, connectivity, and usability. Next-generation 5G networks (or NR networks) and beyond (e.g., 6G networks) are expected to increase throughput, coverage, and robustness, while reducing latency and operational and capital expenditures. 5G NR (and beyond) networks will continue to evolve based on 3GPP LTE-Advanced, with additional potential new radio access technologies (RATs) to enrich people's lives with seamless wireless connectivity, delivering fast, rich content and services.

Further enhancements to the operation of LTE and NR systems in both licensed and unlicensed spectrum are expected in future releases of 5G and beyond communication systems. Such enhanced operations can include techniques for channel state information (CSI) configurations, such as CSI processing assumptions alignment.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate, generally, by way of example, but not by way of limitation, various aspects discussed in the present document.

FIG. 1A illustrates the architecture of a network, in accordance with some aspects.

FIG. 1B and FIG. 1C illustrate a non-roaming 5G system architecture, in accordance with some aspects.

FIG. 2, FIG. 3, FIG. 4, and FIG. 5 illustrate various systems, architectures, devices, and components that may implement aspects of disclosed embodiments.

FIG. 6 illustrates an example artificial intelligence (AI)-assisted communication architecture for communication between a UE and a RAN, in accordance with some aspects.

FIG. 7 illustrates an example RAN split architecture, in accordance with some aspects.

FIG. 8 is a time diagram with an example of CSI Report transmission from the UE, in accordance with some aspects.

FIG. 9 is a schematic representation of a CSI processor concept, in accordance with some aspects.

FIG. 10 is a schematic representation of CSI compute resources release and allocation procedures, in accordance with some aspects.

FIG. 11 illustrates the alignment of UE processing capabilities and base station (BS) assumptions on the number of Time Units (TU) and CSI Compute Resources (CCR), in accordance with some aspects.

FIG. 12 illustrates the alignment of UE processing capabilities and BS assumptions on the number of CCRs within a minimum processing time, in accordance with some aspects.

FIG. 13 illustrates a block diagram of a communication device such as an evolved Node-B (eNB), a new generation Node-B (gNB) (or another RAN node), an NCR, an access point (AP), a wireless station (STA), a mobile station (MS), or user equipment (UE), in accordance with some aspects.

### DETAILED DESCRIPTION

The following detailed description provides illustrative examples and embodiments of the present technological development, which pertains to alignment of Channel State Information (CSI) processing assumptions between a Base Station (BS) and a User Equipment (UE) within the context of 5G and beyond wireless communication systems. This technological development is generally directed toward frameworks and procedures for emulating UE CSI processing using one or more CSI Processors and associated CSI Compute Resources, including rules for allocation and release of CSI Compute Resources for CSI Reports and UE behavior for CSI processing events such as CSI processing overflow and failure to finish CSI processing, in next-generation networks, including 5G New Radio (NR) and future 6G systems. These techniques address challenges related to reconciling BS assumptions about UE CSI processing functionalities with actual UE computational capacity, memory, and latency across CSI configurations of varying complexity, varying time-domain behaviors for CSI measurements and CSI reporting, and UE implementations supporting parallel, pipelined, or serial processing of CSI Reports, thereby reducing system performance degradation associated with misalignment of CSI processing assumptions and supporting more efficient use of time and frequency resources allocated for CSI feedback.

The examples and embodiments described herein are provided for illustrative purposes only and are not intended to limit the scope of the described subject matter. Certain well-known elements, protocols, and processes may be omitted or simplified for clarity, as they are readily understood by those skilled in the art. Furthermore, various modifications, rearrangements, or substitutions of components and steps may be made without departing from the spirit and scope of the described subject matter, as defined by the appended claims. The described subject matter encompasses all such variations and equivalents that fall within the intended scope.

As used herein, the term “radio resource control (RRC) signaling” refers to higher-layer control plane signaling used to configure connection parameters, resource allocations, and operational behaviors between user equipment and a base station.

As used herein, the term “allocation” may refer to an operation by which one or more CSI compute resources of a CSI processor are assigned to a CSI report for a time instance, the operation being based on the state of the CSI processor and optionally corresponding to an add operation on a double-ended queue data structure.

As used herein, the term “alignment parameter” may refer to a parameter exchanged between a UE and a base station to reconcile UE processing functionalities with base station assumptions, including at least one of a number of time units associated with a number of CSI compute resources, a maximum number of CSI compute resources, a minimum processing time for a number of CSI compute resources, or a maximum number of CSI compute resource requests over a number of time units.

As used herein, the term “artificial intelligence or machine learning (AI/ML)” may refer to a class of algorithms or models, including trained neural networks, used for computation of CSI content for one or more CSI reports.

As used herein, the term “base station” may refer to a network node, including a gNodeB (gNB) in a New Radio (NR) network, configured to communicate with one or more user equipments over radio channels and to configure CSI measurements and CSI reporting at the user equipments.

As used herein, the term “beam management” may refer to a non-CSI feature associated with selection, measurement, or maintenance of directional transmission or reception beams between a base station and a user equipment.

As used herein, the term “channel quality indicator (CQI)” may refer to a component of a CSI report indicating at least one of a spectral efficiency, an effective signal-to-interference-and-noise ratio of a hypothetical downlink transmission, or a modulation and coding scheme recommended by the UE for a hypothetical downlink transmission at a specified quality of service.

As used herein, the term “channel state information (CSI)” may refer to information characterizing a radio channel between a base station and a user equipment, derived from measurements of reference signals and reported by the UE to the base station to assist scheduling, link adaptation, precoding, or spatial multiplexing.

As used herein, the term “CSI compute cost” may refer to a number of CSI compute resources to be allocated across one or more CSI processors for processing a CSI report, the number being determined as a function of one or more parameters of the CSI report, including at least one of a number of CSI-RS resources, a number of CSI-RS ports per CSI-RS resource, a CSI-RS bandwidth, a number of subbands, a PMI codebook, or a CSI report quantity.

As used herein, the term “CSI compute resource” may refer to an abstracted computational unit of a CSI processor that can be occupied by or allocated to a CSI report during a time instance, occupancy of CSI compute resources collectively representing a state of the CSI processor.

As used herein, the term “CSI interference measurement (CSI-IM)” may refer to a reference signal configuration used by a UE to measure interference for computation of CSI content.

As used herein, the term “CSI processing event” may refer to a condition determined based on the state of one or more CSI processors with respect to a CSI report, the condition corresponding to one of a normal CSI operation, a CSI processing overflow, or a failure to finish CSI processing for the CSI report.

As used herein, the term “CSI processing overflow” may refer to a condition in which a CSI compute cost for a CSI report is greater than the number of unoccupied CSI compute resources of the at least one CSI processor selected for allocation at the time instance.

As used herein, the term “CSI processor” may refer to an abstracted processing entity at a UE that is associated with a plurality of CSI compute resources and that is used to model occupancy and allocation of computational resources for CSI reports.

As used herein, the term “CSI reference resource” may refer to a specified location in a time domain relative to which CSI content of a CSI report is computed.

As used herein, the term “CSI reference signal (CSI-RS)” may refer to a reference signal transmitted by a base station and measured by a UE for determination of CSI content of a CSI report.

As used herein, the term “CSI reference signal resource indicator (CRI)” may refer to a component of a CSI report that indicates a CSI-RS resource selected by the UE and used for computation of other CSI components in the CSI report.

As used herein, the term “CSI report” may refer to a set of CSI content determined by a UE based on measurements of reference signals and transmitted to a base station, the CSI content including at least one of a CRI, an RI, a PMI, or a CQI.

As used herein, the term “CSI report quantity” may refer to a parameter of a CSI report configuration specifying the type of CSI content to be reported.

As used herein, the term “double-ended queue” may refer to a data structure supporting add and remove operations at either end, used to organize the plurality of CSI compute resources of a CSI processor, an allocation of a CSI compute resource corresponding to an add operation and a release of a CSI compute resource corresponding to a remove operation.

As used herein, the term “downlink control information (DCI)” may refer to control signaling transmitted by a base station to a UE over a physical downlink control channel, including signaling that triggers an aperiodic CSI report or indicates a CSI processor assigned to a CSI report.

As used herein, the term “failure to finish CSI processing” may refer to a condition in which, at a time instance corresponding to transmission of a CSI report, one or more CSI compute resources remain allocated to the CSI report.

As used herein, the term “front-end circuitry” may refer to circuitry of a UE coupled to one or more antennas and to processing circuitry, and configured to perform radio frequency operations associated with transmission and reception of signals.

As used herein, the term “link failure detection” may refer to a non-CSI feature associated with determining whether a radio link between a base station and a UE has failed.

As used herein, the term “New Radio (NR) network” may refer to a cellular communication network operating according to 5G NR specifications or successor specifications, such as 6G.

As used herein, the term “normal CSI operation” may refer to a CSI processing event in which the UE processes and transmits one or more CSI reports as configured by the base station without a CSI processing overflow or a failure to finish CSI processing.

As used herein, the term “out-of-range channel quality indicator (CQI)” may refer to a specified CQI value outside a defined valid CQI range, used to indicate a CSI processing event, such as a CSI processing overflow.

As used herein, the term “physical uplink control channel (PUCCH)” may refer to an uplink physical channel used for transmission of control information, including CSI reports, from a UE to a base station.

As used herein, the term “physical uplink shared channel (PUSCH)” may refer to an uplink physical channel used for transmission of data and, in some configurations, CSI reports, from a UE to a base station.

As used herein, the term “precoding matrix indicator (PMI)” may refer to a component of a CSI report indicating a precoding matrix recommended by the UE from a set of precoding matrices defined by a PMI codebook.

As used herein, the term “PMI codebook” may refer to a set of precoding matrices from which a PMI is selected, the codebook type being configurable and potentially associated with a specified CSI processor or CSI compute cost.

As used herein, the term “priority function” may refer to a function used to determine an order of allocation of CSI compute resources among a plurality of CSI reports starting processing in the same time instance, the function being a function of at least one of a CSI report identifier, a CSI report quantity, a PMI codebook, or a time-domain behavior.

As used herein, the term “processing circuitry” may refer to one or more hardware processors, including associated circuitry, configured to execute operations for decoding received signaling, maintaining state, allocating CSI compute resources, determining CSI processing events, and encoding signaling for transmission.

As used herein, the term “radio resource control (RRC) configuration” may refer to higher-layer signaling used by a base station to configure parameters at a UE, including configuration information for CSI reports and, in some cases, assignment of a CSI processor to a CSI report.

As used herein, the term “radio resource management for mobility” may refer to a non-CSI feature associated with measurements and procedures supporting UE mobility between cells or beams.

As used herein, the term “rank indicator (RI)” may refer to a component of a CSI report indicating a number of spatial layers recommended by the UE for downlink transmission.

As used herein, the term “release” may refer to an operation by which one or more CSI compute resources previously allocated to a CSI report are freed, either fully upon completion of a processing time period associated with the CSI report or partially on a periodic basis with a release time period.

As used herein, the term “specified combination of CSI bits” may refer to a predefined bit pattern transmitted in place of updated CSI content to indicate a CSI processing event, including at least one of all zero bits, an out-of-range CQI, or a dedicated bit indicating the CSI processing event.

As used herein, the term “state” may refer to information maintained at a UE or a base station that indicates occupancy of CSI compute resources of one or more CSI processors at a time instance, determined based on a number of occupied CSI compute resources at a previous time instance, a number of released CSI compute resources at the time instance, and a number of CSI compute resources newly occupied at the time instance.

As used herein, the term “time-domain behavior” may refer to a configured timing mode of a CSI report or an associated reference signal, including at least one of a periodic, semi-persistent, or aperiodic behavior.

As used herein, the term “time instance” may refer to a discrete unit of time, such as a symbol or slot, at which the state of a CSI processor is evaluated or at which CSI compute resources are allocated or released.

As used herein, the term “time unit” may refer to a unit of time used to characterize UE processing capacity in an alignment parameter, including units such as symbols or slots.

As used herein, the term “transceiver circuitry” may refer to circuitry of an apparatus coupled to processing circuitry and to one or more antennas, and configured to transmit and receive radio signals.

As used herein, the term “UE capability signaling” may refer to signaling transmitted by a UE to a base station that indicates processing functionalities of the UE, including at least one of a number of supported CSI processors, a plurality of CSI compute costs corresponding to processing across different numbers of CSI processors, or an alignment parameter.

As used herein, the term “user equipment (UE)” may refer to a wireless device configured for operation in an NR network and configured to receive configuration information for CSI reports from a base station, perform CSI measurements, and transmit CSI reports to the base station.

The problem addressed by the present solution concerns cellular communication systems, particularly their physical layer. The problem concerns the alignment of Channel State Information (CSI) processing assumptions between a Base Station (BS) and a User Equipment (UE). The problem arises in 5G New Radio (NR) systems and is also relevant to future 6G systems.

In such systems, the BS configures the UE with CSI Measurement Resources, such as CSI Reference Signals (CSI-RS) and CSI Interference Measurement (CSI-IM) signals, and with one or more CSI Reports. The UE measures the configured reference signals and transmits the CSI Reports to the BS over uplink channels. The BS uses the reported CSI to support operations, including scheduling, link adaptation, precoding, and spatial multiplexing for downlink data transmission.

The UE has finite computational resources and finite memory. The UE, therefore, cannot process an arbitrary number of CSI Reports of arbitrary complexity within an arbitrary time. The BS must also allow a certain latency for CSI processing at the UE. For proper operation, the BS operates under assumptions about the UE's CSI processing capabilities. These assumptions are used by the BS when deciding how many CSI measurements and CSI Reports to configure, the complexity of each CSI Report, and the time allowed for CSI processing.

The task of aligning BS assumptions about UE processing functionalities with the actual UE situation is non-trivial. Required processing time and computation complexity can vary across different configurations for CSI measurements and CSI Reports. Different UE implementations use different approaches for CSI processing. For example, processing complexity can depend on the number of CSI-RS resources, the number of CSI-RS ports per resource, the CSI-RS bandwidth, the number of configured subbands, the Precoding Matrix Indicator (PMI) codebook, and the CSI Report Quantity. CSI Reports may also have different time-domain behaviors, such as periodic, semi-persistent, or aperiodic transmission. CSI Reports may be processed in parallel or in series at the UE.

If the CSI processing assumptions at the BS are not aligned with the UE's actual situation, two outcomes can occur. In one outcome, the BS is constrained to configure fewer CSI measurements and/or fewer CSI Reports than the UE can actually process. In another outcome, the BS configures more CSI measurements and/or CSI Reports than the UE can process. In the second outcome, time and frequency resources used for downlink control information, for uplink channels carrying CSI Reports, and for reference signals associated with CSI Reports that the UE cannot process are consumed without yielding useful CSI feedback. In both outcomes, system performance is degraded relative to the case where the CSI processing assumptions are aligned.

Prior approaches have addressed aspects of this problem. In 4G Long Term Evolution (LTE), a fixed minimum CSI processing time and a fixed maximum number of CSI Reports per subframe were specified. CSI Processes were introduced, and UE capabilities were defined for the maximum number of CSI-RS ports per CSI-RS resource, the maximum number of CSI-RS resources per CSI Report, and the maximum total number of CSI-RS ports across CSI-RS resources. The LTE approach does not provide relaxation of CSI computation time or of the number of CSI Reports based on CSI Report complexity. This makes it difficult for a UE to support CSI Reporting for larger numbers of CSI-RS resources and ports and for higher-accuracy CSI, which correspond to higher per-report complexity.

In 5G NR, several mechanisms are specified. A CSI Processing Unit (CPU) feature defines a maximum number of occupied CPUs at the UE, with CPU occupancy rules governing how many CPUs a given CSI Report occupies based on the number of CSI-RS resources and the PMI codebook. Minimum CSI processing time requirements are specified for at least two categories of CSI configuration, with additional relaxation available for certain PMI codebooks and for cases involving different subcarrier spacing. Total complexity of triggered CSI Reports is bounded by a maximum number of active CSI-RS ports and active CSI-RS resources, and by maximum numbers of CSI-RS resources and ports per PMI codebook or per combination of PMI codebooks. These NR mechanisms provide more flexibility than the LTE approach but are defined as separate features. The number of CSI Reports, the complexity of each CSI Report, and the time requirements are interrelated. For example, more CSI Reports can be processed in a given time if each report is simpler, and the same number of reports can be processed faster if each is simpler. The existing NR mechanisms do not unify these interrelated parameters into a single framework.

As a result, existing approaches lack a unified framework for aligning CSI processing assumptions between the BS and the UE across varying CSI Report complexities, time-domain behaviors, and different UE processing architectures that support parallel, pipelined, or serial CSI Report processing.

Previous approaches to aligning CSI processing assumptions between a BS and a UE have been defined in 4G Long Term Evolution (LTE) and 5G New Radio (NR).

In LTE prior to Release 11, a UE is configured with one CSI Report per Component Carrier (CC), and UE complexity is treated as similar across CSI configurations. The minimum time for CSI processing is fixed at four subframes, corresponding to four milliseconds. The maximum number of CSI Reports that can be triggered in a single subframe is 5. Under these parameters, a UE dimensions its CSI processing block to process up to 20 CSI Reports across 4 subframes, with a latency of 4 subframes per CSI Report. This corresponds to the case of consecutive Aperiodic CSI triggering in each subframe.

LTE Release 11 introduces multiple CSI Processes. The UE reports a maximum number of CSI Processes per CC as part of its capability signaling. The CSI processing time is not changed relative to earlier releases.

LTE Releases 13 and 14 introduce support for full-dimensional Multiple-Input-Multiple-Output (MIMO), together with new Precoding Matrix Indicator (PMI) codebooks for up to sixteen and thirty-two CSI-RS ports, respectively. The CSI Process concept is reused. New UE capabilities are introduced to indicate the maximum number of CSI-RS ports per CSI-RS resource, the maximum number of CSI-RS resources per CSI Report, and the maximum total number of CSI-RS ports across CSI-RS resources. The CSI processing time is not changed.

A characteristic of the LTE approach is that no relaxation of CSI computation time or of the maximum number of CSI Reports is provided based on CSI Report complexity. The same requirements apply regardless of per-report complexity. This makes it difficult for a UE to support CSI Reporting for larger numbers of CSI-RS resources and ports, and for higher-accuracy CSI, each of which corresponds to higher per-report complexity.

In NR, CSI processing alignment is supported through several features. A minimum CSI processing time is defined separately for lower- and higher-complexity CSI configurations. The number of CSI Reports that can be processed simultaneously at the UE is bounded by the number of CSI Processing Units (CPUs), and CPU occupancy rules determine how many CPUs each CSI Report occupies, based on factors such as the number of CSI-RS resources and the configured PMI codebook. A maximum number of active CSI-RS ports and a maximum number of active CSI-RS resources are defined. Further constraints include the maximum number of CSI-RS ports per CSI-RS resource, the maximum number of CSI-RS resources per CSI Report, the maximum number of total CSI-RS resources per PMI codebook type, and the maximum number of total CSI-RS resources per PMI codebook type across configurations with mixed PMI codebook types. Additional CSI processing time relaxation may be applied to particular PMI codebooks with high PMI search complexity and to cases with different subcarrier spacings for CSI-RS associated with triggered CSI Reports.

The NR approach provides greater flexibility than the LTE approach by supporting multiple mechanisms for aligning UE processing functionalities with BS assumptions. The number of CSI Reports, the complexity of each CSI Report, and the time requirements are interrelated parameters, and in existing NR specifications, these parameters are addressed through separate features rather than through a unified framework.

The disclosed techniques provide a framework for aligning Channel State Information (CSI) processing assumptions between a Base Station (BS) and a User Equipment (UE) in cellular communication systems, including 5G New Radio (NR) and future 6G systems. The framework uses a set of abstracted entities and a set of defined rules. The BS and/or the UE emulate CSI processing at the UE by determining states of each abstracted entity with respect to the processing of one or more CSI Reports. Based on the determined states, the BS and/or the UE determine whether and how to transmit or receive the corresponding CSI Reports.

At the top level of the framework, a UE supports P CSI Processors. Each CSI Processor p, for p equal to 1, 2, and so on up to P, is associated with a number C_p of CSI Compute Resources. In one example, the UE indicates the number of CSI Processors P as part of UE capability signaling. In another example, the UE supports a minimum number of CSI Processors, denoted P_min. In one example, two different CSI Processor types are supported within a single UE, where a first CSI Processor type has C_1 compute resources and a second CSI Processor type has C_2 compute resources, with C_1 not equal to C_2.

A subset of CSI Processors may correspond to a subset of CSI configurations. For example, a subset may correspond to CSI configurations using Artificial Intelligence/Machine Learning (AI/ML), to specific Precoding Matrix Indicator (PMI) codebooks, or to specific CSI Report Quantities. CSI processing alignment is then performed separately for that subset of CSI configurations. CSI Processors and CSI Compute Resources may also be used by non-CSI features that involve processing, such as link failure detection, Radio Resource Management (RRM) for mobility, and Beam Management. For example, a set of CSI Processing Units (CPUs) may be dedicated to CRI/L1-RSRP (Layer 1 Reference Signal Received Power) computation, channel covariance matrix computation, AI/ML-based CSI computation, or a mix of these computation types.

At a given time instance t, such as a symbol or slot, the state of a CSI Processor p is represented by a number c_p(t) of occupied CSI Compute Resources. The number c_p(t) is determined at the UE and/or at the BS based on the number of occupied CSI Compute Resources in the previous time instance, c_p(t−1), the number of released CSI Compute Resources in the current time instance, denoted c_p\hat{ }(−)(t), and the number of CSI Compute Resources newly occupied in the current time instance, denoted c_p\hat{ }(+)(t). One example uses the recurrence c_p(t)=c_p(t−1)+c_p\hat{ }(+)(t)− c_p\hat{ }(−)(t).

In one example, CSI Compute Resources for a CSI Processor operate as a double-ended queue (deque). Allocation of CSI Compute Resources corresponds to an “Add to Front” or “Add to Rear” operation. Release of CSI Compute Resources corresponds to a “Remove from Rear” or “Remove from Front” operation.

A CSI Compute Resource is assigned to a CSI Report. In one example, a unique identifier n_ID of the CSI Report is stored per CSI Processor and per CSI Compute Resource for each time instance t. For example, O_{p,t}(f)=n_ID, where O_{p,t} is a data structure that stores CSI Report identifiers, such as a vector or a deque, f is the index of the CSI Compute Resource with f equal to 1, 2, and so on up to C_p, p is the CSI Processor index, and t is the time instance. When a CSI Compute Resource f is not assigned to a CSI Report for CSI Processor p at time instance t, O_{p,t}(f) may be empty or may store a specified sentinel value such as −1, infinity, or NaN. A CSI Compute Resource may also be tagged with additional information, such as the used PMI codebook or the CSI Report Quantity, to differentiate CSI Report configurations. The time instance corresponding to the allocation of a CSI Compute Resource may be determined implicitly from n_ID or stored in a separate data structure.

In another example, CSI processing for multiple CSI Reports or CSI configurations may overlap on a subset of CSI Compute Resources for a CSI Processor. A CSI Compute Resource may correspond to a list of CSI Report identifiers or CSI configuration identifiers. Full overlap of CSI Reports on the same set of CSI Compute Resources corresponds to parallel processing of the CSI Reports at the UE. Partial overlap of CSI Reports on a subset of CSI Compute Resources corresponds to pipelined processing of the CSI Reports at the UE. In one example, support for such overlap is indicated via UE capability.

The framework uses a parameter referred to as the CSI Compute Cost. The CSI Compute Cost corresponds to the number of allocated CSI Compute Resources across CSI Processors assumed at the UE and/or at the BS for a CSI Report. In one example, for a CSI Report n, the UE and/or the BS determines a CSI Compute Cost x_n(p(k,K)) for a set of CSI Processors p(k,K) selected from the set {1, 2, . . . , P}, with k equal to 1, 2, . . . , K and K equal to 1, 2, . . . , P. In another example, when CSI Processors are equivalent, the CSI Compute Cost is expressed as x_n(k,K), determined per CSI Processor k for K CSI Processors. In a further example, when two CSI Processor types are supported, the CSI Compute Cost is expressed as x_n(k,K,1) for the first type and x_n(k,K,2) for the second type. If a CSI Report n does not support calculation on a given CSI Processor type, the CSI Compute Cost for that type is either undefined or treated as infinity. In one example, a CSI Report is mapped to a single CSI Processor (K=1), and the CSI Compute Cost is denoted by x_n.

In one example, the CSI Compute Cost is determined as a function x_n=f(Y, E, F, D). Y=[Y_1, Y_2, . . . ] is a set of specified parameters. E=[E_1, E_2, . . . ] is a set of parameters indicated by the UE via UE capability signaling. F=[F_1, F_2, . . . , F_D] is the number of CSI-RS ports per CSI-RS resource. D is the number of CSI-RS resources. In one example, the CSI Compute Cost corresponds to a linear function of the number of CSI-RS resources, given by f(Y, E, F, D)=Y_1+D*Y_2. In another example, the CSI Compute Cost corresponds to a linear function of the total number of CSI-RS ports across CSI-RS resources, given by f(Y, E, F, D)=Y_1+(F_1+F_2+ . . . +F_D)*Y_2. The coefficients Y_1 and Y_2 may be fixed values specified in the standard, such as Y_1=Y_2=1, or may vary depending on CSI configuration, such as the PMI codebook.

In one example, Y and E are specified or indicated via UE capability signaling, per the PMI codebook and/or per the CSI Report Quantity. The specification or indication may further depend on the number of CSI-RS resources, the number of CSI-RS ports, and channel bandwidth parameters, such as CSI-RS bandwidth, the number of subbands, or the number of carriers. In another example, Y and E are specified or indicated per PMI codebook and/or per CSI Report Quantity, but are invariant to CSI-RS resources, CSI-RS ports, and channel bandwidth.

In a further example, the UE indicates multiple CSI Compute Costs x_n(k,K) and/or x_n(p(k,K)) corresponding to processing across K values from 1 to P. For instance, the CSI Compute Cost may be x_n(1,1)=4 for processing using K=1 CSI Processor, and may be x_n(1,2)=2 and x_n(2,2)=2 for processing using K=2 CSI Processors.

For allocation of CSI Compute Resources to a CSI Report, CSI Compute Resources on one or more CSI Processors are allocated according to the CSI Compute Cost for that CSI Report at a time instance t. In one example, the allocation operation corresponds to an “Add to Front” or “Add to Rear” operation on the deque data structure representing the CSI Processor.

The time instance t for CSI Compute Resource allocation corresponds to the assumed start of UE processing for the CSI Report. UE processing may include CSI measurements, CSI content computation, or both. In one example, t corresponds to the time instance for reception of control information, such as Downlink Control Information (DCI), that triggers the CSI Report. In this case, the end of the last symbol carrying the triggering information may be taken as the instance t. In another example, t corresponds to the location of the CSI reference resource in the time domain. In a further example, t corresponds to the latest time instance of the latest reference signal, such as CSI-RS or CSI Interference Measurement (CSI-IM), associated with the CSI Report before CSI Report transmission or before the CSI reference resource.

The framework includes procedures for the selection of a CSI Processor to which a CSI Report is assigned. In one example, the selected CSI Processor g is determined based on the minimum value of c_p(t) across all CSI Processors in the time instance of CSI Compute Resource allocation, expressed as g=argmin(c_p(t), for p=1, 2, . . . , P). In another example, g is selected as the CSI Processor with the minimum index p for which the number of unoccupied CSI Compute Resources, C_p−c_p(t), exceeds the CSI Compute Cost of the CSI Report. In a further example, the CSI Processor g assigned to a CSI Report is indicated by the BS in DCI and/or configured via Radio Resource Control (RRC) signaling. In another example, the selection of the CSI Processor is based on Component Carrier (CC), PMI codebook, CSI Report Quantity, CSI Report identifier, or another information element associated with the CSI Report.

The framework includes procedures for prioritizing CSI Reports when processing more than one CSI Report that starts at the same time instance t. In one example, CSI Compute Resources are allocated for the CSI Reports in the order determined by a priority function PRI, in ascending or descending order. The priority function PRI may be a function of CSI Report identifier, CSI Report Quantity, PMI codebook, time-domain behavior, or another information element associated with the CSI Report. In another example, the order of CSI Compute Resource allocation for multiple CSI Reports is indicated by the BS or configured via higher-layer signaling.

The framework includes procedures for the release of CSI Compute Resources. In one example, CSI Compute Resources are fully released per the CSI Report. All CSI Compute Resources previously allocated for a CSI Report n are released at time instance t+T_n, where t is the time instance in which the CSI Compute Resources were allocated, and T_n is a time period assumed at the UE and/or at the BS for processing the CSI Report n. In one example, T_n is specified or is indicated by the UE as part of UE capability signaling for a subset of CSI Report configurations, such as configurations defined by the number of CSI-RS ports or CSI-RS resources, CSI Report Quantity, or PMI codebook.

In another example, CSI Compute Resources are released partially. For a CSI Processor p at a time instance t, either before or after allocation of CSI Compute Resources, the number of occupied CSI Compute Resources c_p(t) is updated as c_p(t)=max(c_p(t−1)−c_p\hat{ }(−)(t), 0), where c_p\hat{ }(−)(t) is the number of released CSI Compute Resources in time instance t. In one example, c_p\hat{ }(−)(t) is specified or indicated via UE capability signaling. In another example, the release of CSI Compute Resources is periodic with a time period T_P. Under this periodic release, c_p\hat{ }(−)(t) is equal to 0 for time instances where mod(t, T_P) is not 0, and c_p\hat{ }(−)(t) is equal to c_p\hat{ }(−) for time instances where mod(t, T_P) equals 0. The value c_p\hat{ }(−) is specified or indicated via UE capability signaling.

Based on the state of the CSI Processors, the UE and/or the BS determines a CSI processing event. The CSI processing event may include one of normal CSI operation, a CSI processing overflow, or a failure to finish CSI processing for a CSI Report. In the case of normal CSI operation, the UE processes and transmits the CSI Reports as configured by the BS.

A CSI processing overflow event occurs when the CSI Compute Cost for a CSI Report exceeds the number of available unoccupied CSI Compute Resources for the CSI Processor p selected for CSI Compute Resource allocation at the time of allocation. When multiple CSI Reports start processing at the same time instance, the determination of which CSI Reports experience the overflow event is based on the CSI Report ordering provided by the priority function PRI. In one example of UE behavior upon a CSI processing overflow for a CSI Report, the UE is not expected to update the CSI Report. In another example, the UE does not transmit the CSI Report, or omits it from Physical Uplink Shared Channel (PUSCH) or Physical Uplink Control Channel (PUCCH) transmissions. In a further example, the UE indicates a specified CSI bit combination for the CSI Report. For example, all bits may be set to zero, or Channel Quality Indicator (CQI) bits may be set to indicate an out-of-range CQI. Alternatively, the event may be explicitly indicated by using a dedicated bit in the CSI Report. In another example, upon a CSI processing overflow, CSI Compute Resources for the CSI Report are distributed across multiple CSI Processors, if permitted by UE capability or by specification.

A failure to finish CSI processing for a CSI Report occurs when, at the time instance t_R corresponding to transmission of the CSI Report, one or more CSI Compute Resources remain assigned to the CSI Report. In one example of UE behavior upon such a failure, the UE is not expected to update the CSI Report. In another example, the UE does not transmit the CSI Report, or omits it from PUSCH or PUCCH transmissions. In a further example, the UE indicates a specified combination of CSI bits, such as all zeros or an out-of-range CQI, or explicitly indicates the event using a dedicated bit in the CSI Report.

The framework also provides several options for aligning the BS and the UE with respect to UE processing capacity. In one aspect, the BS and the UE are aligned with respect to processing capacity expressed in time units (TUs) associated with CSI Compute Resources. For example, a processing capacity of 6 TUs per 4 CSI Compute Resources is abstracted as a fully or partially parallel processing unit of 4 CSI Compute Resources, while a processing capacity of 3 TUs per 3 CSI Compute Resources is abstracted as a fully or partially parallel processing unit of 2 CSI Compute Resources. In another aspect, the BS and the UE are aligned with respect to a maximum number of CSI Compute Resources, such as a maximum of 20 CSI Compute Resources. In another aspect, the BS and the UE are aligned on a minimum processing time for N CSI Compute Resources, such as 4 TUs for 5 CSI Compute Resources. In a further aspect, the BS and the UE are aligned with respect to the maximum number of CSI Compute Resource requests over N TUs, such as 20 CSI Compute Resources for 4 TUs or 20 CSI Compute Resources for 5 TUs.

The disclosed techniques address the technical challenge of reconciling BS assumptions about UE CSI processing functionalities with actual UE computational capacity, memory, and latency. The framework unifies, within a single abstracted model, the number of CSI Reports, per-report complexity, and time requirements. These parameters are interrelated: more CSI Reports can be processed in a given time if each report is simpler, and a given number of reports can be processed more quickly if each is simpler. By mapping each CSI Report to a CSI Compute Cost expressed as a number of CSI Compute Resources, and by defining allocation, release, and event-handling rules, the framework allows the BS and the UE to maintain consistent assumptions about the state of CSI processing at the UE.

The framework supports CSI Reports with different time-domain behaviors, including periodic, semi-persistent, and aperiodic transmission, and supports parallel, pipelined, and serial processing of CSI Reports at the UE. The framework also supports CSI configurations with different PMI codebooks, including codebooks used for AI/ML-based CSI, and supports scenarios in which CSI Processors and CSI Compute Resources are shared with non-CSI processing tasks such as link failure detection, mobility, and Beam Management.

Applying the framework allows the BS to configure CSI measurements and CSI Reports consistent with the UE's processing capacity, and for the UE to exhibit predictable behavior when configured processing exceeds that capacity, through defined overflow and failure-to-finish procedures. This reduces the occurrence of wasted time and frequency resources associated with DCI, PUSCH, PUCCH, and reference signals for CSI Reports that the UE would otherwise be unable to process. This also supports improved system performance compared to approaches where CSI processing assumptions are not aligned.

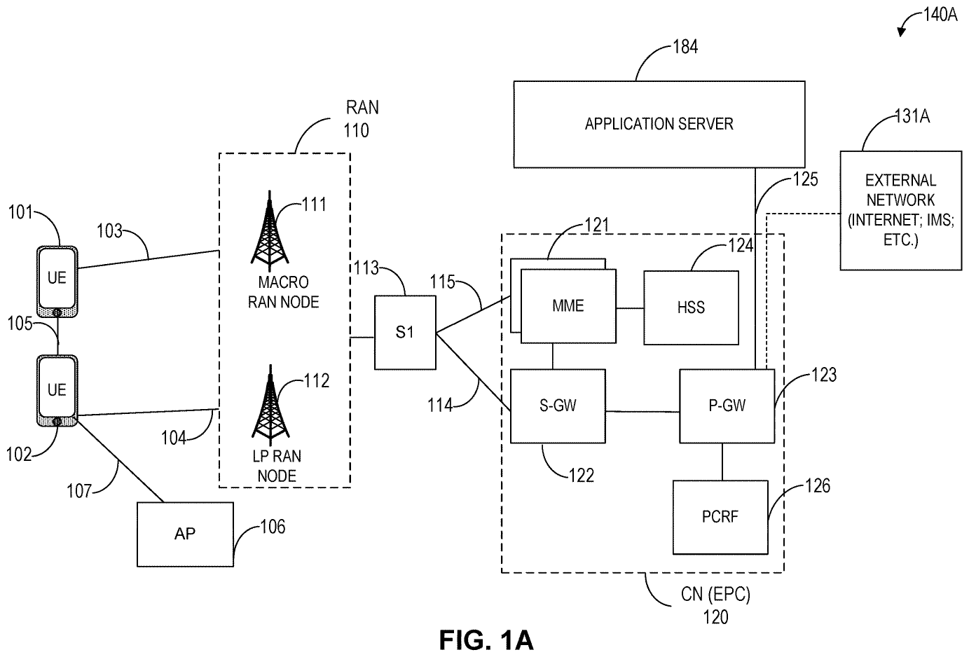

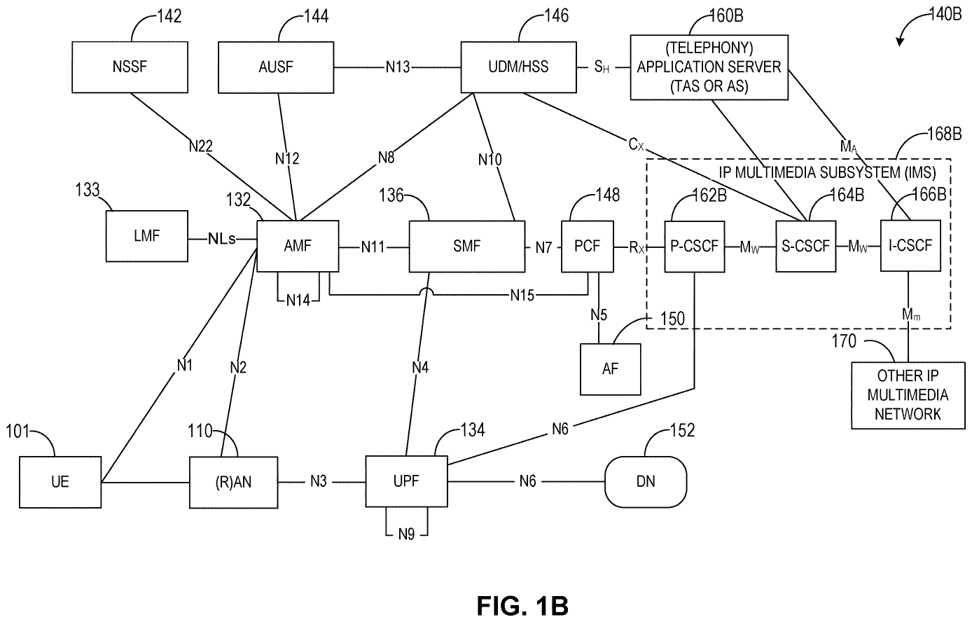

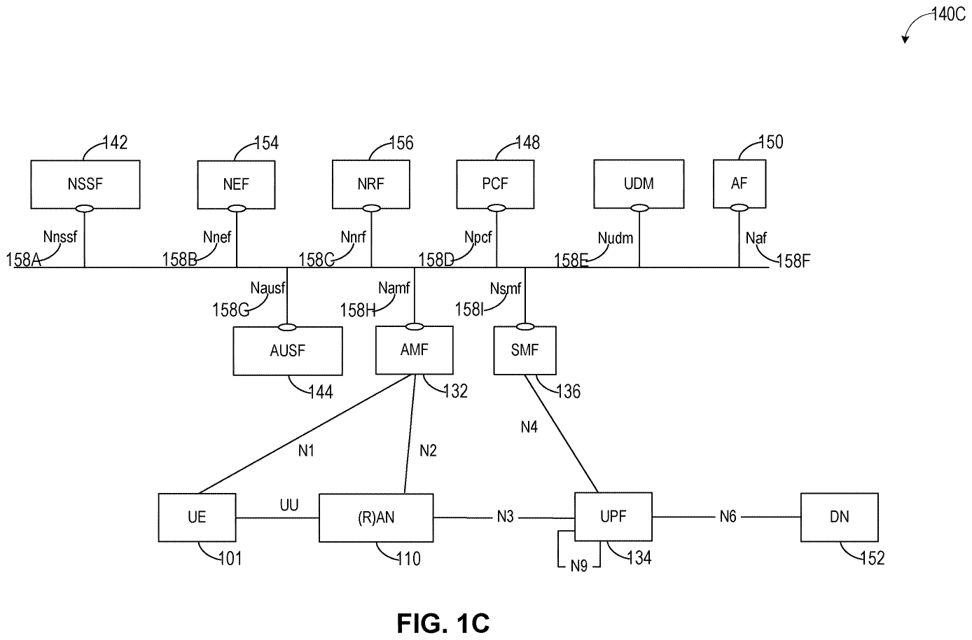

The disclosed techniques pertain to FIG. 1A-FIG. 13, which illustrate various systems, devices, and components that may implement aspects of disclosed embodiments in different communication systems, such as LTE (EUTRA) and 5G-NR (and beyond) networks. UEs, base stations (such as gNBs), and/or other nodes (e.g., satellites or other computing nodes) discussed herein can be configured to perform the disclosed techniques.

FIG. 1A illustrates the architecture of a network in accordance with some aspects. The communication network 140A is illustrated as including user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. UE 101 and UE 102 can be collectively referred to herein as UEs 101, and UE 101 can be used to perform one or more of the techniques disclosed herein.

Any of the radio links described herein (e.g., as used in the communication network 140A or any other illustrated network) may operate according to any exemplary radio communication technology and/or standard.

LTE and LTE-Advanced are standards for high-speed wireless data communications for UEs, such as mobile telephones. In LTE-Advanced and various wireless systems, carrier aggregation is a technology that allows multiple carrier signals operating on different frequencies to be used to carry communications for a single UE, thereby increasing the bandwidth available to a single device. In some aspects, carrier aggregation may be used where one or more component carriers operate on unlicensed frequencies.

Aspects described herein can be used in the context of any spectrum management scheme, including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, DFT-S-OFDM, SC-FDMA, SC-OFDM, filter bank-based multicarrier (FBMC), OFDMA, etc.) and, in particular, 3GPP NR (New Radio) by allocating the OFDM carrier data bit vectors to the corresponding symbol resources.

In some aspects, any of the UE 101 and UE 102 can include an Internet-of-Things (IoT) UE or a Cellular IoT (CIoT) UE, which can include a network access layer designed for low-power IoT applications utilizing short-lived UE connections. In some aspects, any of the UE 101 and UE 102 can include a narrowband (NB) IoT UE (e.g., an enhanced NB-IoT (eNB-IoT) UE and a Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe), or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure) with short-lived connections. The IoT UEs may execute background applications (e.g., keep-alive messages, status updates, etc.) to facilitate the connections of the IoT network.

In some aspects, any of the UE 101 and UE 102 can include enhanced MTC (eMTC) UEs or further enhanced MTC (FeMTC) UEs.

The UE 101 and UE 102 may be configured to connect, e.g., communicatively coupled, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UE 101 and UE 102 utilize connections 103 and 104, respectively, each of which includes a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can include a local wireless connection, such as, for example, a connection consistent with any IEEE 802.11 protocol, according to which the AP 106 can include a wireless fidelity (Wi-Fi) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can include ground stations (e.g., terrestrial access points) or satellite stations providing coverage within a geographic area (e.g., a cell). In some aspects, communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN nodes, and one or more RAN nodes for providing femtocells or picocells (e.g., cells having smaller coverage areas, smaller user capacity, or higher bandwidth compared to macrocells), e.g., a low-power (LP) RAN node or an unlicensed spectrum-based secondary RAN node.

Any of the communication nodes 111 and 112 can terminate the air interface protocol and can be the first point of contact for UE 101 and UE 102. In some aspects, any of the communication nodes 111 and 112 can fulfill various logical functions for the RAN 110, including, but not limited to, the radio network controller (RNC) functions such as radio bearer management, uplink, and downlink dynamic radio resource management, data packet scheduling, and mobility management. In an example, any of the communication nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in FIGS. 1B-1C). In this aspect, the S1 interface 113 is split into two parts: the S1-U interface 114, which carries user traffic data between the communication nodes 111 and 112 and the serving gateway (S-GW) 122, and the S1-mobility management entity (MME) interface 115, which is a signaling interface between the communication nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access, such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110 and route data packets between the RAN 110 and the CN 120. In addition, the S-GW 122 may be a local mobility anchor point for inter-RAN node handovers and may also provide an anchor for inter-3GPP mobility. Other responsibilities of the S-GW 122 may include lawful intercept, charging, and some policy enforcement.

The P-GW 123 may terminate an SGi interface toward a PDN. The P-GW 123 may route data packets between the EPC network (e.g., CN 120) and external networks, such as a network including the application server 184 (alternatively referred to as application function (AF)) via an Internet Protocol (IP) interface 125. The P-GW 123 can also communicate data to external networks 131A, including the Internet, the IP Multimedia Subsystem (IMS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including a 5G new radio network using communications in the licensed (5G NR) and the unlicensed (5G NR-U) spectrum. One of the current enablers of IoT is the narrowband IoT (NB-IoT).

An NG system architecture can include the RAN 110 and a 5G core network (e.g., CN 120). RAN 110 in an NG system can be referred to as NG-RAN. The RAN 110 can include a plurality of nodes, such as gNBs and NG-eNBs. The CN 120 (also referred to as a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces and the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a master node (MN), and an NG-eNB can be a secondary node (SN) in a 5G architecture. In some aspects, the master/primary node may operate in a licensed band, and the secondary node may operate in an unlicensed band.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, location management function (LMF) 133, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility, and can also include network slice selection functionality. The SMF 136 can be configured to set up and manage various sessions in accordance with network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The LMF 133 may be used in connection with 5G positioning functionalities. In some aspects, LMF 133 receives measurements and assistance information from the RAN 110 and the mobile device (e.g., UE 101) via the AMF 132 over the N1 interface to compute the position of the UE 101. In some aspects, NR positioning protocol A (NRPPa) may be used to carry the positioning information between NG-RAN and LMF 133 over a next-generation control plane interface (NG-C). In some aspects, LMF 133 configures the UE using the LTE positioning protocol (LPP) via AMF 132. The RAN 110 configures the UE 101 using radio resource control (RRC) protocol over LTE-Uu and NR-Uu interfaces.

In some aspects, the 5G system architecture 140B configures different reference signals to enable positioning measurements. Example reference signals that may be used for positioning measurements include the positioning reference signal (NR PRS) in the downlink and the sounding reference signal (SRS) for positioning in the uplink. The downlink positioning reference signal (PRS) is a reference signal configured to support downlink-based positioning methods.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1), or an interrogating CSCF (I-CSCF) 166B. The P-CSCF 162B can be configured to be the first contact point for the UE 102 within the IMS 168B. The S-CSCF 164B can be configured to handle the session states in the network, and the E-CSCF can be configured to handle certain aspects of emergency sessions, such as routing an emergency request to the correct emergency center or PSAP. The I-CSCF 166B can be configured to function as the contact point within an operator's network for all IMS connections destined to a subscriber of that network operator or a roaming subscriber currently located within that network operator's service area. In some aspects, the I-CSCF 166B can be connected to another IP multimedia network 170, e.g., an IMS operated by a different network operator.

In some aspects, the UDM/HSS 146 can be coupled to an application server (AS) 160B, which can include a telephony application server (TAS) or another AS. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between the AMF 132 and the NSSF 142, not shown). Other reference point representations not shown in FIG. 1B can also be used.

FIG. 1C illustrates a 5G system architecture 140C and a service-based representation. In addition to the network entities illustrated in FIG. 1B, the 5G system architecture 140C can also include a network exposure function (NEF) 154 and a network repository function (NRF) 156. In some aspects, 5G system architectures can be service-based, and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, the 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

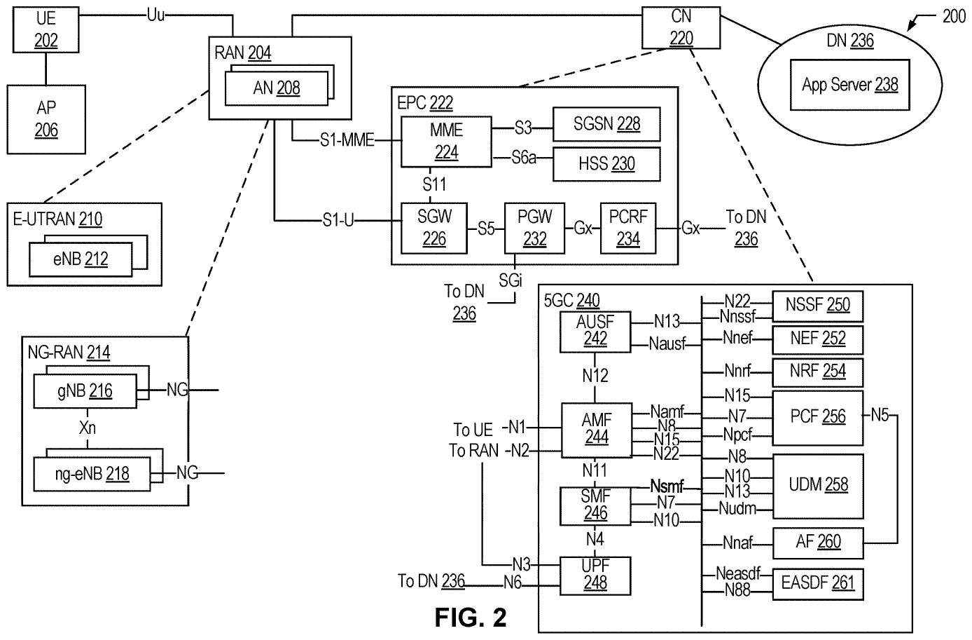

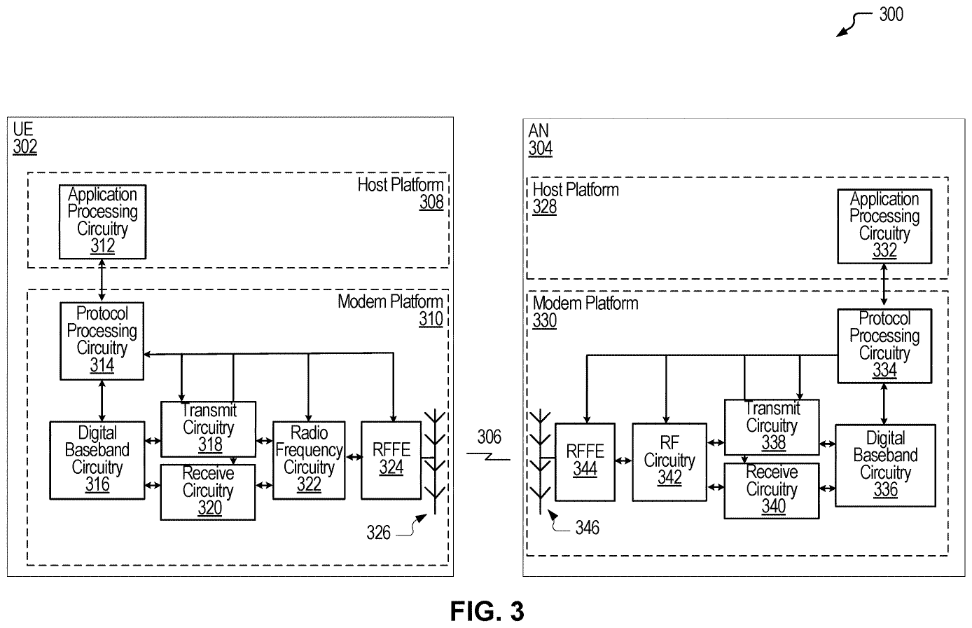

FIG. 2 depicts an example network architecture 200. The network architecture 200 may operate in accordance with 3GPP technical specifications for LTE or 5G/NR systems, and one or more devices within the network architecture 200 can implement the disclosed techniques. However, the example embodiments are not limited in this regard, and the described examples may apply to other networks that benefit from the principles described herein, such as future 3GPP systems or the like.

The network architecture 200 includes a UE 202, which is any mobile or non-mobile computing device designed to communicate with a RAN 204 via an over-the-air connection. The UE 202 is communicatively coupled with the RAN 204 by a Uu interface, which may be applicable to both LTE and NR systems. Examples of the UE 202 include, but are not limited to, a smartphone, tablet computer, wearable device (e.g., smart watch, fitness tracker, smart glasses, smart clothing/fabrics, head-mounted displays, smart shoes, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein.

Additionally or alternatively, the UE 202 can be a reduced capability (RedCap) UE, which is a UE with reduced capabilities as specified in clause 4.2.21.1 in 3GPP TS 38.306 v17.4.0 (2023-03-30) (“TS 38.306”).

The network architecture 200 may include a set of UEs 202 coupled directly with one another via a D2D, ProSe, PC5, and/or SL interface, and/or any other suitable interface such as any of those discussed herein. These UEs 202 may be M2M/D2D/MTC/IoT devices and/or vehicular systems that communicate using physical sidelink channels such as, but not limited to, PSBCH, PSDCH, PSSCH, PSCCH, PSFCH, and the like. The UE 202 may perform blind decoding attempts of SL channels/links according to the various examples herein.

In some examples, the UE 202 may additionally communicate with an AP 206 via an over-the-air (OTA) connection. The AP 206 manages a WLAN connection, which may serve to offload some or all network traffic from the RAN 204. The connection between the UE 202 and the AP 206 may be consistent with any IEEE 802.11 protocol. Additionally, the UE 202, RAN 204, and AP 206 may utilize cellular-WLAN aggregation/integration (e.g., LWA/LWIP). Cellular-WLAN aggregation may involve the UE 202 being configured by the RAN 204 to utilize both cellular radio resources and WLAN resources.

The RAN 204 includes one or more access network nodes (ANs) 208. The ANs 208 terminate air interface(s) for the UE 202 by providing access to stratum protocols, including RRC, PDCP, RLC, MAC, and PHY/L1 protocols. In this manner, the AN 208 enables data/voice connectivity between the CN 220 and the UE 202. The ANs 208 may be a macrocell base station or a low-power base station for providing femtocells, picocells, or other like cells having smaller coverage areas, smaller user capacity, or higher bandwidth compared to macrocells, or some combination thereof. In these implementations, an AN 208 can be referred to as a BS, gNB, RAN node, eNB, ng-eNB, NodeB, RSU, TRxP, and the like.

One example implementation is a “CU/DU split” architecture where the ANs 208 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like) (see, e.g., TS 38.401). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 208 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architecture, arrangement, and/or configuration can be used.

The set of ANs may be coupled with one another via an X2 interface (if the RAN 204 is an LTE RAN or Evolved Universal Terrestrial Radio Access Network (E-UTRAN) 210) or an Xn interface (if the RAN 204 is an NG-RAN 214). The X2/Xn interfaces, which may be separated into control/user plane interfaces in some examples, may allow the ANs to communicate information related to handovers, data/context transfers, mobility, load management, interference coordination, and the like.

The ANs of the RAN 204 may each manage one or more cells, cell groups, component carriers, and the like to provide the UE 202 with an air interface for network access. The UE 202 may be simultaneously connected with a set of cells provided by the same or different ANs 208 of the RAN 204. For example, the UE 202 and RAN 204 may use carrier aggregation to allow the UE 202 to connect with a set of component carriers, each corresponding to a Pcell or Scell. In dual connectivity scenarios, a first AN 208 may be a master node that provides an MCG, and a second AN 208 may be a secondary node that provides an SCG. The first/second ANs 208 may be any combination of eNB, gNB, ng-eNB, and the like.

The RAN 204 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

Additionally or alternatively, individual UEs 202 provide radio information to one or more ANs 208 and/or one or more edge compute nodes (e.g., edge servers/hosts and the like). The radio information may be in the form of one or more measurement reports and may include, for example, signal strength measurements, signal quality measurements, and/or the like. Each measurement report is tagged with a timestamp and the location of the measurement (e.g., the UE's 202 current location). As examples, the measurements collected by the UEs 202 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion (SINAD) ratio, carrier-to-interference plus noise ratio (CINR), Additive White Gaussian Noise (AWGN), energy per bit to noise power density ratio (Eb/NO), energy per chip to interference power density ratio (Ec/IO), energy per chip to noise power density ratio (Ec/NO), peak-to-average power ratio (PAPR), reference signal received power (RSRP), Reference Signal Received Path Power (RSRPP), reference signal received quality (RSRQ), received signal strength indicator (RSSI), received channel power indicator (RCPI), received signal to noise indicator (RSNI), Received Signal Code Power (RSCP), reference signal carrier phase (RSCP), reference signal carrier phase difference (RSCPD), carrier phase positioning (CPP), Reference Signal Time Difference (RSTD), Sidelink Synchronization Signal Block (S-SSB) measurements including SSB_RP (Received (linear) average power of the resource elements that carry NR SSB signals and channels, measured at the UE antenna connector or radiated interface boundary) and/or the like, Relative Time Difference (RTD), receiver (Rx) time delay, Rx Timing Error, transmitter (Tx) time delay, Tx Timing Error, NR E-CID, Observed Time Difference Of Arrival (OTDOA), average noise plus interference (ANPI), GNSS timing of cell frames for UE positioning for E-UTRAN or 5G/NR (e.g., a timing between an AP or RAN node reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v17.0.0 (2022-03-31) (“[TS36214]”), 3GPP TS 38.215 v17.3.0 (2023-03-30) (“[TS38215]”), 3GPP TS 38.314 v17.2.0 (2023-01-13) (“[TS38314]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), and/or the like. Additionally or alternatively, any of the measurements above (or a combination of measurements) may be collected by one or more ANs 208 and provided to the edge compute node(s).

Additionally or alternatively, the measurements can include one or more of the following measurements: measurements related to Data Radio Bearer (DRB) (e.g., number of DRBs attempted to be set up, number of DRBs successfully set up, number of released active DRBs, in-session activity time for DRB, number of DRBs attempted to be resumed, number of DRBs successfully resumed, and the like); measurements related to Radio Resource Control (RRC) (e.g., mean number of RRC connections, maximum number of RRC connections, mean number of stored inactive RRC connections, maximum number of stored inactive RRC connections, number of attempted, successful, and/or failed RRC connection establishments, and the like); measurements related to UE Context (UECNTX); measurements related to Radio Resource Utilization (RRU) (e.g., DL total PRB usage, UL total PRB usage, distribution of DL total PRB usage, distribution of UL total PRB usage, DL PRB used for data traffic, UL PRB used for data traffic, DL total available PRBs, UL total available PRBs, and the like); measurements related to Registration Management (RM); measurements related to Session Management (SM) (e.g., number of PDU sessions requested to be set up; number of PDU sessions successfully set up; number of PDU sessions failed to be set up, and the like); measurements related to GTP Management (GTP); measurements related to IP Management (IP); measurements related to Policy Association (PA); measurements related to Mobility Management (MM) (e.g., for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, and the like); measurements related to Virtualized Resource(s) (VR); measurements related to Carrier (CARR); measurements related to QoS Flows (QF) (e.g., number of released active QoS flows, number of QoS flows attempted to release, in-session activity time for QoS flow, in-session activity time for a UE 202, number of QoS flows attempted to set up, number of QoS flows successfully established, number of QoS flows failed to set up, number of initial QoS flows attempted to set up, number of initial QoS flows successfully established, number of initial QoS flows failed to set up, number of QoS flows attempted to modify, number of QoS flows successfully modified, number of QoS flows failed to modify, and the like); measurements related to Application Triggering (AT); measurements related to Short Message Service (SMS); measurements related to Power, Energy and Environment (PEE); measurements related to NF service (NFS); measurements related to Packet Flow Description (PFD); measurements related to Random Access Channel (RACH); measurements related to Measurement Report (MR); measurements related to Layer 1 Measurement (L1M); measurements related to Network Slice Selection (NSS); measurements related to Paging (PAG); measurements related to Non-IP Data Delivery (NIDD); measurements related to external parameter provisioning (EPP); measurements related to traffic influence (TI); measurements related to Connection Establishment (CE); measurements related to Service Parameter Provisioning (SPP); measurements related to Background Data Transfer Policy (BDTP); measurements related to Data Management (DM); and/or any other performance measurements such as those discussed in 3GPP TS 28.552 v17.3.1 (2021-06-24) (“[TS28552]”), 3GPP TS 32.425 v17.1.0 (2021-06-24) (“[TS32425]”), and/or the like.

The radio information may be reported in response to a trigger event and/or on a periodic basis. Additionally or alternatively, individual UEs 202 report radio information either at a low periodicity or a high periodicity depending on a data transfer that is to take place and/or other information about the data transfer. Additionally or alternatively, the edge compute node(s) may request the measurements from the ANs 208 at low or high periodicity, or the ANs 208 may provide the measurements to the edge compute node(s) at low or high periodicity. Additionally or alternatively, the edge compute node(s) may obtain other relevant data from other edge compute node(s), core network functions (NFs), application functions (AFs), and/or other UEs 202, such as Key Performance Indicators (KPIs), with the measurement reports or separately from the measurement reports.

Additionally or alternatively, in cases where there is a discrepancy in the observation data from one or more UEs, one or more RAN nodes, and/or core network NFs (e.g., missing reports, erroneous data, and the like), simple imputations may be performed to supplement the obtained observation data, such as, for example, substituting values from previous reports and/or historical data, applying an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., it exceeds an acceptable range or bounds), such values may be dropped for the current learning/training episode or epoch. For example, during packet delivery, delay bounds may be defined or configured, and packets determined to have been received after the delay bound may be dropped.

The UE 202 can also perform reference signal (RS) measurement and reporting procedures to provide the network with information about the quality of one or more wireless channels and/or the communication media in general, and this information can be used to optimize various aspects of the communication system. As examples, the measurement and reporting procedures performed by the UE 202 can include those discussed in 3GPP TS 38.211 v17.4.0 (2023-01-04) (“[TS38211]”), 3GPP TS 38.212 v17.4.0 (2023-01-04) (“[TS38212]”), 3GPP TS 38.213 v17.4.0 (2023-01-04) (“[TS38213]”), 3GPP TS 38.214 v17.4.0 (2023-01-04) (“[TS38214]”), [TS38215], 3GPP TS 38.101-1 v18.0.0 (2023-01-12) (“[TS38.101-1]”), 3GPP TS 38.104 v18.0.0 (2023-01-10) (“[TS38104]”), 3GPP TS 38.133 v18.0.0 (2023-01-12) (“[TS38133]”), [TS38331], and/or the like. The physical signals and/or RS can include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), and sounding reference signal (SRS).

In any of the examples discussed herein, any suitable data collection and/or measurement mechanism(s) may be used to collect the observation data. For example, data marking (e.g., sequence numbering and the like), packet tracing, signal measurement, data sampling, and/or timestamping techniques may be used to determine any of the aforementioned metrics/observations. The collection of data may be based on the occurrence of events that trigger the collection of the data. Additionally or alternatively, data collection may take place at the initiation or termination of an event. The data collection can be continuous, discontinuous, and/or have start and stop times. The data collection techniques/mechanisms may be specific to an HW configuration/implementation or non-HW-specific or may be based on various software parameters (e.g., OS type and version, and the like). Various configurations may be used to define any of the aforementioned data collection parameters. Such configurations may be defined by suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., MAMS [RFC8743]), IEEE/WiFi (e.g., [IEEE80211], [WiMAX], [IEEE1609.0], and the like), and/or any other like standards such as those discussed herein.

In V2X scenarios, the UE 202 or AN 208 may be or act as a roadside unit (RSU), which may refer to any transportation infrastructure entity used for V2X communications. An RSU may be implemented in or by a suitable AN or a stationary (or relatively stationary) UE. An RSU implemented in or by a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, and media, as well as applications/software to sense and control ongoing vehicular and pedestrian traffic. The RSU may provide very low-latency communications required for high-speed events, such as crash avoidance, traffic warnings, and the like. Additionally or alternatively, the RSU may provide other cellular/WLAN communications services. The components of the RSU may be packaged in a weatherproof enclosure suitable for outdoor installation and may include a network interface controller to provide a wired connection (e.g., Ethernet) to a traffic signal controller or a backhaul network. Furthermore, one or more V2X RATs may be employed, which allow V2X nodes to communicate directly with one another, with infrastructure equipment (e.g., AN 208), and/or other devices/nodes. In some implementations, at least two distinct V2X RATs may be used, including WLAN V2X (W-V2X) RATs based on IEEE V2X technologies (e.g., DSRC for the U.S. and ITS-G5 for Europe) and cellular V2X (C-V2X) RATs based on 3GPP V2X technologies (e.g., LTE V2X, 5G/NR V2X, and beyond). In one example, the C-V2X RAT may utilize a C-V2X air interface, and the WLAN V2X RAT may utilize a W-V2X air interface.

The W-V2X RATs include, for example, IEEE Guide for Wireless Access in Vehicular Environments (WAVE) Architecture, IEEE Standards Association, IEEE 1609.0-2019 (10 Apr. 2019) (“[IEEE16090]”), V2X Communications Message Set Dictionary, SAE Int'l (23 Jul. 2020) (“[J2735_202007]”), Intelligent Transport Systems in the 5 GHz frequency band (ITS-G5), the [IEEE80211p](which is the layer 1 (L1) and layer 2 (L2) part of WAVE, DSRC, and ITS-G5), and/or IEEE Standard for Air Interface for Broadband Wireless Access Systems, IEEE Std 802.16-2017, pp. 1-2726 (2 Mar. 2018) (“[WiMAX]”). The term “DSRC” refers to vehicular communications in the 5.9 GHz frequency band that is generally used in the United States, while “ITS-G5” refers to vehicular communications in the 5.9 GHz frequency band in Europe. Since any number of different RATs are applicable (including [IEEE80211p] RATs) that may be used in any geographic or political region, the terms “DSRC” (used, among other regions, in the U.S.) and “ITS-G5” (used, among other regions, in Europe) may be used interchangeably. The access layer for the ITS-G5 interface is outlined in ETSI EN 302 663 V1.3.1 (2020-01) (hereinafter, “[EN302663]”), which describes the access layer of the ITS-S reference architecture. The ITS-G5 access layer comprises [IEEE80211](which now incorporates [IEEE80211p]) and features for Decentralized Congestion Control (DCC) methods, as discussed in ETSI TS 102 687 V1.2.1 (2018-04) (“[TS102687]”). The access layer for 3GPP LTE-V2X-based interface(s) is outlined in, inter alia, ETSI EN 303 613 V1.1.1 (2020-01), 3GPP TS 23.285 v16.2.0 (2019-12); and 3GPP 5G/NR-V2X is outlined in, inter alia, 3GPP TR 23.786 v16.1.0 (2019-06) and 3GPP TS 23.287 v18.0.0 (2023-03-31) (“[TS23287]”).

In examples where the RAN 204 is an E-UTRAN 210 with one or more eNBs 212, the E-UTRAN 210 provides an LTE air interface (Uu) with the parameters and characteristics at least as discussed in 3GPP TS 36.300 v17.2.0 (2022-09-30) (“[TS36300]”). In examples where the RAN 204 is a next-generation (NG)-RAN 214 with a set of gNBs 216. Each gNB 216 connects with 5G-enabled UEs 202 using a 5G-NR air interface (also referred to as the Uu interface), with parameters and characteristics as discussed in [TS38300], among many other 3GPP standards. Where the NG-RAN 214 includes a set of ng-eNBs 218, the one or more ng-eNBs 218 connect with a UE 202 via the 5G Uu and/or LTE Uu interface. The gNBs 216 and the ng-eNBs 218 connect with the 5GC 240 through respective NG interfaces, which include an N2 interface, an N3 interface, and/or other interfaces. The gNB 216 and the ng-eNB 218 are connected over an Xn interface. Additionally, individual gNBs 216 are connected via respective Xn interfaces, and individual ng-eNBs 218 are connected via respective Xn interfaces. In some examples, the NG interface may be split into two parts: an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN 214 and an AMF 244 (e.g., N2 interface).

The NG-RAN 214 may provide a 5G-NR air interface (which may also be referred to as a Uu interface) with the following characteristics: variable SCS; CP-OFDM for DL, CP-OFDM, and DFT-s-OFDM for UL; polar, repetition, simplex, and Reed-Muller codes for control and LDPC for data. The 5G-NR air interface may rely on CSI-RS, PDSCH/PDCCH DMRS, similar to the LTE air interface. The 5G-NR air interface may not use a CRS but may use PBCH DMRS for PBCH demodulation, PTRS for phase tracking for PDSCH, and a tracking reference signal for time tracking. The 5G-NR air interface may operate on FR1 bands that include bands from 410 MHz to 7125 MHz or FR2 bands that include bands from 24.25 GHz to 71 GHz. The 5G-NR air interface may include an SSB, which is an area of a downlink resource grid that includes PSS/SSS/PBCH.

The 5G-NR air interface may utilize BWPs for various purposes. For example, BWP can be used to adapt the SCS dynamically. For example, the UE 202 can be configured with multiple BWPs, with each BWP configuration having a different SCS. When a BWP change is indicated to the UE 202, the SCS of the transmission is changed as well. Another use case example of BWP is related to power saving. In particular, multiple BWPs can be configured for the UE 202 with different amounts of frequency resources (e.g., PRBs) to support data transmission under different traffic loading scenarios. A BWP containing a smaller number of PRBs can be used for data transmission with a small traffic load while allowing power saving at the UE 202 and, in some cases, at the gNB 216. A BWP with a larger number of PRBs can be used for scenarios with higher traffic load.

In some implementations, individual gNBs 216 can include a gNB-CU and a set of gNB-DUs. Additionally or alternatively, gNBs 216 can include one or more RUs. In these implementations, the gNB-CU may be connected to each gNB-DU via respective F1 interfaces. In network sharing with multiple cell ID broadcasts, each cell identity associated with a subset of PLMNs corresponds to a gNB-DU, and the gNB-CU is connected to share the same physical-layer cell resources. For resiliency, a gNB-DU may be connected to multiple gNB-CUs by an appropriate implementation. Additionally, a gNB-CU can be separated into the gNB-CU control plane (gNB-CU-CP) and the gNB-CU user plane (gNB-CU-UP). The gNB-CU-CP is connected to a gNB-DU through an F1 control plane interface (F1-C), the gNB-CU-UP is connected to the gNB-DU through an F1 user plane interface (F1-U), and the gNB-CU-UP is connected to the gNB-CU-CP through an E1 interface. In some implementations, one gNB-DU is connected to only one gNB-CU-CP, and one gNB-CU-UP is connected to only one gNB-CU-CP. For resiliency, a gNB-DU and/or a gNB-CU-UP may be connected to multiple gNB-CU-CPs by an appropriate implementation. One gNB-DU can be connected to multiple gNB-CU-UPs under the control of the same gNB-CU-CP, and one gNB-CU-UP can be connected to multiple DUs under the control of the same gNB-CU-CP. Data forwarding between gNB-CU-UPs during intra-gNB-CU-CP handover within a gNB may be supported by Xn-U.

Similarly, individual ng-eNBs 218 can include an ng-eNB-CU and a set of ng-eNB-DUs. In these implementations, the ng-eNB-CU and each ng-eNB-DU are connected via respective W1 interfaces. An ng-eNB can include an ng-eNB-CU-CP, one or more ng-eNB-CU-UP(s), and one or more ng-eNB-DU(s). An ng-eNB-CU-CP and an ng-eNB-CU-UP are connected via the E1 interface. An ng-eNB-DU is connected to an ng-eNB-CU-CP via the W1-C interface and to an ng-eNB-CU-UP via the W1-U interface. The general principle described herein with respect to gNB aspects also applies to ng-eNB aspects and corresponding E1 and W1 interfaces if not explicitly specified otherwise.

The node hosting the user plane part of the PDCP protocol layer (e.g., gNB-CU, gNB-CU-UP, and for EN-DC, MeNB, or SgNB, depending on the bearer split) performs user inactivity monitoring. Further, it informs its inactivity or (re)activation to the node having a control plane connection towards the core network (e.g., over E1, X2, or the like). The node hosting the RLC protocol layer (e.g., gNB-DU) may perform user inactivity monitoring and further inform its inactivity or (re)activation to the node hosting the control plane (e.g., gNB-CU or gNB-CU-CP).

In these implementations, the NG-RAN 214 is layered into a Radio Network Layer (RNL) and a Transport Network Layer (TNL). The NG-RAN 214 architecture (e.g., the NG-RAN logical nodes and their interfaces) is part of the RNL. For each NG-RAN interface (e.g., NG, Xn, F1, and the like), the related TNL protocol and the functionality are specified, for example, in TS 38.401. The TNL provides services for user plane transport and/or signaling transport. In NG-Flex configurations, each NG-RAN node is connected to all AMFs, 244 of which are AMF sets within an AMF region, supporting at least one slice, also supported by the NG-RAN node. The AMF Set and the AMF Region are defined in TS 23.501.

The RAN 204 is communicatively coupled to CN 220, which includes network elements and/or network functions (NFs) to provide various functions to support data and telecommunications services to customers/subscribers (e.g., UE 202). The components of the CN 220 may be implemented in one physical node or separate physical nodes. In some examples, NFV may be utilized to virtualize any or all of the functions provided by the network elements of the CN 220 onto physical compute/storage resources in servers, switches, and the like. A logical instantiation of the CN 220 may be referred to as a network slice, and a logical instantiation of a portion of the CN 220 may be referred to as a network sub-slice.

The CN 220 may be an LTE CN 220 (also referred to as an Evolved Packet Core (EPC) 222). The EPC 222 may include MME 224, SGW 226, SGSN 228, HSS 230, PGW 232, and PCRF 234 coupled with one another over interfaces (or “reference points”) as shown. The NFs in the EPC 222 are briefly introduced as follows.

The MME 224 implements mobility management functions to track the UE 202's current location and facilitate paging, bearer activation/deactivation, handovers, gateway selection, authentication, and the like. The SGW 226 terminates an S1 interface toward the RAN and routes data packets between the RAN and the EPC 222. The SGW 226 may serve as a local mobility anchor point for inter-RAN node handovers and as an anchor for inter-3GPP mobility. Other responsibilities may include lawful intercept, charging, and some policy enforcement. The SGSN 228 tracks the UE 202's location and performs security functions and access control. The SGSN 228 also performs inter-EPC node signaling for mobility between different RAT networks; PDN and S-GW selection as specified by MME 224; MME 224 selection for handovers; and the like.

The S3 reference point between the MME 224 and the SGSN 228 enables the exchange of user and bearer information for inter-3GPP access network mobility in idle/active states. The HSS 230 includes a database for network users, including subscription-related information to support the network entities' handling of communication sessions. The HSS 230 can support routing/roaming, authentication, authorization, naming/addressing resolution, location-dependent services, and the like.

An S6a reference point between the HSS 230 and the MME 224 may enable the transfer of subscription and authentication data for authenticating/authorizing user access to the EPC 222. The PGW 232 may terminate an SGi interface toward a data network (DN) 236 that may include an application (app)/content server 238. The PGW 232 routes data packets between the EPC 222 and the DN 236. The PGW 232 is communicatively coupled with the SGW 226 by an S5 reference point to facilitate user plane tunneling and tunnel management. The PGW 232 may further include a node for policy enforcement and charging data collection (e.g., PCEF). Additionally, the SGi reference point may communicatively couple the PGW 232 with the same or different DN 236. The PGW 232 may be communicatively coupled with a PCRF 234 via a Gx reference point. The PCRF 234 is the policy and charging control element of the EPC 222. The PCRF 234 is communicatively coupled to the app/content server 238 to determine appropriate QoS and charging parameters for service flows. The PCRF 234 also provisions associated rules into a PCEF (via Gx reference point) with appropriate TFT and QCI.

The CN 220 may be a 5GC 240, including an AUSF 242, AMF 244, SMF 246, UPF 248, NSSF 250, NEF 252, NRF 254, PCF 256, UDM 258, and AF 260 coupled with one another over various interfaces as shown. The NFs in the 5GC 240 are briefly introduced as follows.

The AUSF 242 stores data for UE 202 authentication and handles authentication-related functionality. The AUSF 242 may facilitate a common authentication framework for various access types.

The AMF 244 allows other functions of the 5GC 240 to communicate with the UE 202 and the RAN 204, and to subscribe to notifications about mobility events for the UE 202. The AMF 244 is also responsible for registration management (e.g., UE 202 registration), connection management, reachability management, mobility management, lawful interception of AMF-related events, and access authentication and authorization. The AMF 244 provides transport for SM messages between the UE 202 and the SMF 246 and acts as a transparent proxy for routing SM messages. The AMF 244 also provides transport for SMS messages between the UE 202 and an SMSF. The AMF 244 interacts with the AUSF 242 and the UE 202 to perform various security-anchor and context-management functions. Furthermore, the AMF 244 is a termination point for a RAN-CP interface, which includes the N2 reference point between the RAN 204 and the AMF 244. The AMF 244 is also a termination point of NAS (N1) signaling and performs NAS ciphering and integrity protection.

The AMF 244 also supports NAS signaling with the UE 202 over an N3IWF interface. The N3IWF provides access to untrusted entities. N3IWF may be a termination point for the N2 interface between the RAN 204 and the AMF 244 for the control plane, and may be a termination point for the N3 reference point between the RAN 204 and the UPF 248 for the user plane. As such, the AMF 244 handles N2 signaling from the SMF 246 and the AMF 244 for PDU sessions and quality of service, encapsulates/de-encapsulates packets for IPSec and N3 tunneling, marks N3 user-plane packets in the uplink, and enforces quality of service corresponding to N3 packet marking taking into account quality of service requirements associated with such marking received over N2. N3IWF may also relay UL and DL control-plane NAS signaling between the UE 202 and AMF 244 via an N1 reference point between the UE 202 and the AMF 244, and relay uplink and downlink user-plane packets between the UE 202 and UPF 248. The N3IWF also provides mechanisms for IPsec tunnel establishment with the UE 202. The AMF 244 may exhibit a Namf service-based interface and may be a termination point for an N14 reference point between two AMFs 244 and an N17 reference point between the AMF 244 and a 5G-EIR (not shown by FIG. 2).

The SMF 246 is responsible for SM (e.g., session establishment, tunnel management between UPF 248 and AN 208); UE IP address allocation and management (including optional authorization); selection and control of UP function; configuring traffic steering at UPF 248 to route traffic to the proper destination; termination of interfaces toward policy control functions; controlling part of policy enforcement, charging, and quality of service; lawful intercept (for SM events and interface to LI system); termination of SM parts of NAS messages; downlink data notification; initiating AN-specific SM information, sent via AMF 244 over N2 to AN 208; and determining SSC mode of a session. SM refers to the management of a PDU session, and a PDU session or “session” refers to a PDU connectivity service that provides or enables the exchange of PDUs between the UE 202 and the DN 236. The SMF 246 may also include the following functionalities to support edge computing enhancements (see, e.g., [TS23548]): selection of EASDF 261 and provision of its address to the UE as the DNS server for the PDU session; usage of EASDF 261 services as defined in [TS23548]; and for supporting the application layer architecture defined in [TS23558], provision and updates of ECS address configuration information to the UE. Discovery and selection procedures for EASDFs 261 are discussed in [TS23501]§ 6.3.23.

The UPF 248 acts as an anchor point for intra-RAT and inter-RAT mobility, an external PDU session point of interconnect to DN 236, and a branching point to support multi-homed PDU sessions. The UPF 248 also performs packet routing and forwarding, packet inspection, enforces user plane part of policy rules, lawfully intercepts packets (UP collection), performs traffic usage reporting, performs quality of service handling for a user plane (e.g., packet filtering, gating, UL/DL rate enforcement), performs uplink traffic verification (e.g., SDF-to-QoS flow mapping), transport-level packet marking in the uplink and downlink, and performs downlink packet buffering and downlink data notification triggering. UPF 248 may include an uplink classifier to support routing traffic flows to a data network.

The NSSF 250 selects a set of network slice instances serving the UE 202. The NSSF 250 also determines allowed NSSAI and the mapping to the subscribed S-NSSAIs, if needed. The NSSF 250 also determines an AMF set to be used to serve the UE 202 or a list of candidate AMFs 244 based on a suitable configuration and possibly by querying the NRF 254. The selection of a set of network slice instances for the UE 202 may be triggered by the AMF 244 with which the UE 202 is registered by interacting with the NSSF 250; this may lead to a change of AMF 244. The NSSF 250 interacts with the AMF 244 via an N22 reference point and may communicate with another NSSF in a visited network via an N31 reference point (not shown).

The NEF 252 securely exposes services and capabilities provided by 3GPP NFs for third-party, internal exposure/re-exposure, AFs 260, edge computing, or fog computing systems (e.g., edge compute node, and the like). In such examples, the NEF 252 may authenticate, authorize, or throttle the AFs. NEF 252 may also translate information exchanged with the AF 260 and information exchanged with internal network functions. For example, the NEF 252 may translate between an AF-Service-Identifier and an internal 5GC information. NEF 252 may also receive information from other NFs based on the capabilities of other NFs that are exposed. This information may be stored at the NEF 252 as structured data or at a data storage NF using standardized interfaces. The stored information can then be re-exposed by the NEF 252 to other NFs and AFs or used for other purposes, such as analytics.

The NRF 254 supports service discovery functions, receives NF discovery requests from NF instances, and provides information on the discovered NF instances to the requesting NF instances. NRF 254 also maintains information on available NF instances and their supported services. The NRF 254 also supports service discovery functions, wherein the NRF 254 receives an NF Discovery Request from an NF instance or an SCP (not shown) and provides information about the discovered NF instances to the NF instance or SCP.

The PCF 256 provides policy rules to control plane functions and enforces them, and it may also support a unified policy framework to govern network behavior. The PCF 256 may also implement a front end to access subscription information relevant to policy decisions from a unified data repository (UDR) within the UDM 258. In addition to communicating with functions via reference points, as shown, the PCF 256 also provides an Npcf service-based interface.

The UDM 258 handles subscription-related information to support the network entities' handling of communication sessions and stores UE 202's subscription data. For example, subscription data may be communicated via an N8 reference point between the UDM 258 and the AMF 244. The UDM 258 may include two parts: an application front end and a UDR. The UDR may store subscription data and policy data for the UDM 258 and the PCF 256, and/or structured data for exposure and application data (including PFDs for application detection and application request information for multiple UEs 202) for the NEF 252. The Nudr service-based interface may be exhibited by the UDR to allow the UDM 258, PCF 256, and NEF 252 to access a particular set of stored data, as well as to read, update (e.g., add, modify), delete, and subscribe to notification of relevant data changes in the UDR. The UDM 258 may include a UDM-FE, which is in charge of processing credentials, location management, subscription management, and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points, as shown, the UDM 258 may exhibit the Nudm service-based interface.

Edge Application Server Discovery Function (EASDF) 261 exhibits a Neasdf service-based interface and is connected to the SMF 246 via an N88 interface. One or multiple EASDF instances may be deployed within a PLMN, and interactions between 5GC NF(s) and the EASDF 261 take place within a PLMN. The EASDF 261 includes one or more of the following functionalities: registering to NRF 254 for EASDF 261 discovery and selection; handling the DNS messages according to the instruction from the SMF 246; and/or terminating DNS security if used. Handling the DNS messages according to the instruction from the SMF 246 includes one or more of the following functionalities: receiving DNS message handling rules and/or BaselineDNSPattern from the SMF 246; exchanging DNS messages from/with the UE 202; forwarding DNS messages to C-DNS or L-DNS for DNS query; adding EDNS client subnet (ECS) option into DNS query for an FQDN; reporting to the SMF 246 the information related to the received DNS messages; and/or buffering/discarding DNS messages from the UE 202 or DNS Server. The EASDF has direct user plane connectivity (e.g., without any NAT) with the PSA UPF over N6 for the transmission of DNS signaling exchanged with the UE. The deployment of a NAT between EASDF 261 and PSA UPF 248 may or may not be supported. Additional aspects of the EASDF 261 are discussed in [TS23548].

AF 260 provides application influence on traffic routing, provides access to NEF 252, and interacts with the policy framework for policy control. The AF 260 may influence UPF 248 (re)selection and traffic routing. Based on operator deployment, when AF 260 is considered to be a trusted entity, the network operator may permit AF 260 to interact directly with relevant NFs. In some implementations, the AF 260 is used for edge computing implementations.

The 5GC 240 may enable edge computing by selecting operator/3rd party services to be geographically close to the point where the UE 202 is attached to the network. This may reduce latency and network load. In edge computing implementations, the 5GC 240 may select a UPF 248 close to the UE 202 and execute traffic steering from the UPF 248 to DN 236 via the N6 interface. This may be based on the UE subscription data, UE location, and information provided by the AF 260, which allows the AF 260 to influence UPF (re)selection and traffic routing.

The DN 236 may represent various network operator services, Internet access, or third-party services provided by one or more servers, including, for example, app/content server 238. The DN 236 may be an external public operator, a private PDN, or an intra-operator packet data network, for example, for the provision of IMS services. In this example, the app/content server 238 can be coupled to an IMS via an S-CSCF or the I-CSCF. In some implementations, the DN 236 may represent one or more local area DNs (LADNs), which are DNs (or DN names (DNNs)) that are accessible by a UE 202 in one or more specific areas. Outside these specific areas, the UE 202 cannot access the LADN/DN.

Additionally, or alternatively, the DN 236 may be an edge DN 236, which is a (local) DN that supports the architecture for enabling edge applications. In these examples, the app/content server 238 may represent the physical hardware systems/devices providing app server functionality and/or the application software resident in the cloud or at an edge compute node that performs server function(s). In some examples, the app/content server 238 provides an edge hosting environment that supports the Edge Application Server's execution.

In some examples, the 5GS can use one or more edge compute nodes to provide an interface and offload processing of wireless communication traffic. In these examples, the edge compute nodes may be included in or co-located with one or more RANs. For example, the edge compute nodes can provide connectivity between the NG-RAN 214 and the UPF 248 in the 5GC 240. The edge compute nodes can use one or more NFV instances instantiated on virtualization infrastructure within the edge compute nodes to process wireless connections to and from the NG-RAN 214 and UPF 248.

In some implementations, the edge compute nodes provide a distributed computing environment for application and service hosting, as well as storage and processing resources, so that data and/or content can be processed in close proximity to subscribers (e.g., users of UEs 202) for faster response times. The edge compute nodes also support multitenancy run-time and hosting environment(s) for applications, including virtual appliance applications that may be delivered as packaged virtual machine (VM) images, middleware applications, and infrastructure services, content delivery services, including content caching, mobile big data analytics, and computational offloading, among others. Computational offloading involves moving computational tasks, workloads, applications, and/or services from UEs 202, CN 220, DN 236, and/or server(s) 238 to edge compute nodes, or vice versa. For example, a device application or client application operating in a UE 202 may offload application tasks or workloads to one or more edge compute nodes. In another example, an edge compute node may offload application tasks or workloads to a set of UEs 202 (e.g., for distributed machine learning computation and/or the like).

The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. Edge servers are physical computer systems that may include an edge platform and/or virtualization infrastructure and provide compute, storage, and network resources to edge computing applications. Each of the edge servers is disposed at an edge of a corresponding access network and is arranged to provide computing resources and/or various services (e.g., computational task and/or workload offloading, cloud-computing capabilities, IT services, and other like resources and/or services as discussed herein) in relatively close proximity to UEs 202. The VI of the edge compute nodes provides virtualized environments and virtualized resources for the edge hosts, and the edge computing applications may run as VMs and/or application containers on top of the VI.

In one example implementation, the ECT is and/or operates according to the MEC framework, as discussed in ETSI GR MEC 001 v3.1.1 (2022-01), ETSI GS MEC 003 v3.1.1 (2022-03), ETSI GS MEC 009 v3.1.1 (2021-06), ETSI GS MEC 010-1 v1.1.1 (2017-10), ETSI GS MEC 010-2 v2.2.1 (2022-02), ETSI GS MEC 011 v2.2.1 (2020-12), ETSI GS MEC 012 v2.2.1 (2022-02), ETSI GS MEC 013 v2.2.1 (2022-01), ETSI GS MEC 014 v2.1.1 (2021-03), ETSI GS MEC 015 v2.1.1 (2020-06), ETSI GS MEC 016 v2.2.1 (2020-04), ETSI GS MEC 021 v2.2.1 (2022-02), ETSI GR MEC 024 v2.1.1 (2019-11), ETSI GS MEC 028 v2.2.1 (2021-07), ETSI GS MEC 029 v2.2.1 (2022-01), ETSI MEC GS 030 v2.1.1 (2020-04), ETSI GR MEC 031 v2.1.1 (2020-10), U.S. Provisional App. No. 63/003,834, filed Apr. 1, 2020 (“[US'834]”), and Int'l App. No. PCT/US2020/066969, filed on Dec. 23, 2020 (“[PCT'696]”) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 v1.3.1 (2021-03), ETSI GS NFV 002 v1.2.1 (2014-12), ETSI GR NFV 003 v1.6.1 (2021-03), ETSI GS NFV 006 v2.1.1 (2021-01), ETSI GS NFV-INF 001 v1.1.1 (2015-01), ETSI GS NFV-INF 003 v1.1.1 (2014-12), ETSI GS NFV-INF 004 v1.1.1 (2015-01), ETSI GS NFV-MAN 001 v1.1.1 (2014-12), and/or Israel et al., OSM Release FIVE Technical Overview, ETSI Open Source MANO, OSM White Paper, 1st ed. (January 2019), https://osm.etsi.org/images/OSM-Whitepaper-TechContent-ReleaseFIVE-FINAL.pdf (collectively referred to as “[ETSINFV]”), the contents of each of which are hereby incorporated by reference in their entireties. Other virtualization technologies and/or service orchestration and automation platforms may be used, such as those discussed in E2E Network Slicing Architecture, GSMA, Official Doc. NG.127, v1.0 (3 Jun. 2021), https://www.gsma.com/newsroom/wp-content/uploads//NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.1.0 (2021-12-23) (“[TS28533]”), the contents of each of which are hereby incorporated by reference in their entireties.

In another example implementation, the ECT is and/or operates according to the O-RAN framework. Typically, front-end and back-end device vendors and carriers have worked closely to ensure compatibility. The flip side of such a working model is that it becomes quite difficult to plug and play with other devices, and this can hamper innovation. To combat this and to promote openness and interoperability at every level, several key players interested in the wireless domain (e.g., carriers, device manufacturers, academic institutions, and/or the like) formed the Open RAN Alliance (“O-RAN”) in 2018. The O-RAN network architecture is a building block for designing virtualized RAN on programmable hardware with radio access control powered by AI/ML. Various aspects of the O-RAN architecture are described in O-RAN Architecture Description v07.00, O-RAN Alliance WG1 (October 2022) (“[O-RAN.WG1.O-RAN-Architecture-Description]”); O-RAN Operations and Maintenance Architecture Specification v04.00, O-RAN Alliance WG1 (February 2021) (“[O-RAN.WG1.OAM-Architecture]”); O-RAN Operations and Maintenance Interface Specification v04.00, O-RAN Alliance WG1 (February 2021) (“[O-RAN.WG1.01-Interface.0]”); O-RAN Information Model and Data Models Specification v01.00, O-RAN Alliance WG1 (February 2021); O-RAN Working Group 1 Slicing Architecture v08.00 (October 2022); O-RAN Working Group 2 (Non-RT RIC and A1 interface WG) A1 interface: Application Protocol v03.02 (July 2021); O-RAN Working Group 1 Use Cases Detailed Specification v09.00 (October 2022) (“[O-RAN.WG1.Use-Cases]”); O-RAN Working Group 2 (Non-RT RIC and A1 interface WG) A1 interface: General Aspects and Principles v03.00 (October 2022) (“[O-RAN.WG2.A1GAP]”); O-RAN Working Group 2 (Non-RT RIC and A1 interface WG) A1 interface: Type Definitions v04.00 (October 2021); O-RAN Working Group 2 (Non-RT RIC and A1 interface WG) A1 interface: Transport Protocol v02.00 (October 2022); O-RAN Working Group 2 AI/ML workflow description and requirements v01.03, O-RAN Alliance WG2 (October 2021) (“[O-RAN.WG2.AIML]”); O-RAN Working Group 2 (Non-RT RIC and A1 interface WG) Non-RT RIC Architecture v02.01 (October 2022); O-RAN Working Group 2 Non-RT RIC: Functional Architecture v01.01, O-RAN Alliance WG2 (June 2021); O-RAN Working Group 2 (Non-RT RIC and A1 interface WG): R1 interface: General Aspects and Principles v03.00, O-RAN Alliance WG2 (October 2022); O-RAN Working Group 3 Near-Real-time RAN Intelligent Controller Architecture & E2 General Aspects and Principles v02.02 (July 2022) (“[O-RAN.WG3.E2GAP]”); O-RAN Working Group 3 Near-Real-time Intelligent Controller E2 Service Model (E2SM) v02.01 (March 2022) (“[O-RAN.WG3.E2SM]”); O-RAN Working Group 3 Near-Real-time Intelligent Controller E2 Service Model (E2SM), Cell Configuration and Control v01.00 (October 2022) (“[O-RAN.WG3.E2SM-CCC]”); O-RAN Working Group 3 Near-Real-time Intelligent Controller E2 Service Model (E2SM) KPM v02.03 (October 2022) (“[O-RAN.WG3.E2SM-KPM]”); O-RAN Working Group 3 Near-Real-time Intelligent Controller E2 Service Model (E2SM) RAN Function Network Interface (NI) v01.00 (February 2020) (“[O-RAN-WG3.E2SM-NI]”); O-RAN Working Group 3 Near-Real-time Intelligent Controller E2 Service Model (E2SM) RAN Control v01.03 (October 2022) (“[O-RAN.WG3.E2SM-RC]”); O-RAN Working Group 3, Near-Real-time Intelligent Controller, E2 Application Protocol (E2AP) v02.03 (October 2022) (“[O-RAN.WG3.E2AP]”); O-RAN Working Group 3 (Near-Real-time RAN Intelligent Controller and E2 Interface Working Group): Near-RT RIC Architecture v03.00 (October 2022) (“[O-RAN.WG3.RICARCH]”); O-RAN Working Group 4 (Open Fronthaul Interfaces WG) Control, User and Synchronization Plane Specification v09.00 (July 2022) (“[O-RAN-WG4.CUS.0]”); O-RAN Fronthaul Working Group 4 Cooperative Transport Interface Transport Control Plane Specification v02.00, O-RAN Alliance WG4 (June 2021); O-RAN Fronthaul Working Group 4 Cooperative Transport Interface Transport Management Plane Specification v02.00 (June 2021); O-RAN Fronthaul Working Group 4 (Open Fronthaul Interfaces WG): Management Plane Specification v09.00 (July 2022) (“[O-RAN.WG4.MP.0]”); O-RAN Alliance Working Group 5 01 Interface specification for O-CU-UP and O-CU-CP v04.00 (October 2022); O-RAN Alliance Working Group 5 01 Interface specification for O-DU v05.00 (October 2022); O-RAN Open F1/W1/E1/X2/Xn Interfaces Working Group Transport Specification v01.00, O-RAN Alliance WG5 (April 2020); O-RAN Working Group 6 (Cloudification and Orchestration) Cloud Architecture and Deployment Scenarios for O-RAN Virtualized RAN v04.00 (October 2022) (“[O-RAN.WG6.CADS]”); O-RAN Cloud Platform Reference Designs v02.00, O-RAN Alliance WG6 (February 2021); O-RAN Working Group 6 02 Interface General Aspects and Principles v02.00 (October 2022); O-RAN Working Group 6 (Cloudification and Orchestration Work Group); O-RAN Acceleration Abstraction Layer General Aspects and Principles v04.00 (October 2022); O-RAN Working Group 6: O-Cloud Notification API Specification for Event Consumersv03.00 (“[O-RAN.WG6.O-Cloud Notification API]”); O-RAN White Box Hardware Working Group Hardware Reference Design Specification for Indoor Pico Cell with Fronthaul Split Option 6 v02.00, O-RAN Alliance WG7 (October 2021) (“[O-RAN.WG7.IPC-HRD-Opt6]”); O-RAN WG7 Hardware Reference Design Specification for Indoor Picocell (FR1) with Split Architecture Option 7-2 v03.00, O-RAN Alliance WG7 (October 2021) (“[O-RAN.WG7.IPC-HRD-Opt7-2]”); O-RAN WG7 Hardware Reference Design Specification for Indoor Picocell (FR1) with Split Architecture Option 8 v03.00 (October 2021) (“[O-RAN.WG7.IPC-HRD-Opt8]”); O-RAN White Box Hardware Working Group Hardware Reference Design Specification for Outdoor Micro Cell with Split Architecture Option 7.2 v03.00, O-RAN Alliance WG7 (October 2022) (“[O-RAN.WG7.OMC-HRD-Opt7-2]”); O-RAN White Box Hardware Working Group Hardware Reference Design Specification for Outdoor Macro Cell with Split Architecture Option 7.2 v03.00, O-RAN Alliance WG7 (July 2022) (“[O-RAN.WG7.OMAC-HRD]”); O-RAN Open X-haul Transport Working Group Management interfaces for Transport Network Elements v04.00, O-RAN Alliance WG9 (July 2022); O-RAN Open X-haul Transport Working Group Synchronization Architecture and Solution Specification v02.00, O-RAN Alliance WG9 (March 2022); O-RAN Open Xhaul Transport WG9 WDM-based Fronthaul Transport v2.0, O-RAN Alliance WG9 (March 2022); O-RAN Open Transport Working Group 9 Xhaul Packet Switched Architectures and Solutions v03.00, O-RAN Alliance WG9 (July 2022) (“[O-RAN.WG9.XPSAAS]”); O-RAN Operations and Maintenance Architecture v07.00, O-RAN Alliance WG10 (July 2022) (“[O-RAN.WG10.OAM-Architecture]”); O-RAN Operations and Maintenance Interface Specification v07.00, O-RAN Alliance WG10 (July 2022); O-RAN Operations and Maintenance Interface Specification v08.00, O-RAN Alliance WG10 (October 2022) (“[O-RAN.WG10.O1-Interface.0]”); O-RAN: Towards an Open and Smart RAN, O-RAN Alliance, White Paper (October 2018); and U.S. application Ser. No. 17/484,743 filed on 24 Sep. 2021 (collectively referred to as “[O-RAN]”), the contents of each of which are hereby incorporated by reference in their entirety.

In another example implementation, the ECT is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v18.1.0 (2022-12-23) (“[TS23558]”), 3GPP TS 23.501 v18.0.0 (2022-12-21) (“[TS23501]”), 3GPP TS 23.548 v17.4.0 (2022-09-22) (“[TS23548]”), 3GPP TR 23.700-98 v18.0.0 (2022-12-23) (“[TR23700-98]”), 3GPP TS 23.222 v18.0.0 (2022-12-23) (“[TS23222]”), TS 33.122 v18.0.0 (2022-12-16) (“[TS33122]”), and 3GPP TS 29.222 v17.1.0 (2021-06-25) (“[TS29222]”), 3GPP TS 23.502 v18.0.0 (2022-12-21) (“[TS23502]”), 3GPP TS 29.522 v18.0.0 (2022-12-16) (“[TS29522]”), 3GPP TS 29.122 v18.0.0 (2022-12-16) (“[TS29122]”), 3GPP TS 23.682 v17.3.0 (2022-06-15) (“[TS23682]”), 3GPP TS 23.434 v18.3.0 (2022-12-23) (“[TS23434]”), and 3GPP TS 23.401 v18.0.0 (2022-12-21) (collectively referred to as “[SA6Edge]”), the contents of each of which are hereby incorporated by reference in their entireties.

In another example implementation, the ECT is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/(“[ISEO]”), the contents of which are hereby incorporated by reference in their entirety.

In another example implementation, the ECT operates according to the Multi-Access Management Services (MAMS) framework as discussed in Kanugovi et al., Multi-Access Management Services (MAMS), Internet Engineering Task Force (IETF), Request for Comments (RFC) 8743 (March 2020) (“[RFC8743]”), Ford et al., TCP Extensions for Multipath Operation with Multiple Addresses, IETF RFC 8684, (March 2020), De Coninck et al., Multipath Extensions for QUIC (MP-QUIC), IETF draft-deconinck-quic-multipath-07, IETF, QUIC Working Group (3 May 2021), Zhu, et al., User-Plane Protocols for Multiple Access Management Service, IETF draft-zhu-intarea-mams-user-protocol-09, IETF, INTAREA (4 Mar. 2020), and Zhu et al., Generic Multi-Access (GMA) Convergence Encapsulation Protocols, IETF RFC 9188 (February 2022) (collectively referred to as “[MAMS]”), the contents of each of which are hereby incorporated by reference in their entireties.

It should be understood that the aforementioned edge computing frameworks/ECTs and services deployment examples are only illustrative examples of ECTs and that the present techniques may be applicable to many other or additional edge computing/networking technologies in various combinations and layouts of devices located at the edge of a network, including the various edge computing networks/systems described herein. Further, the techniques disclosed herein may relate to other IoT edge network systems and configurations, and other intermediate processing entities and architectures may also be applicable to the disclosed techniques. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD), and/or Converged Multi-Access and Core (COMAC) systems; and/or the like. Further, the techniques disclosed herein may relate to other IoT edge network systems and configurations, and other intermediate processing entities and architectures may also be used for purposes of the disclosed techniques.

The 5GC 240 interfaces include reference points and service-based interfaces. The reference points include N1 (between the UE 202 and the AMF 244), N2 (between NG-RAN 214 and AMF 244), N3 (between NG-RAN 214 and UPF 248), N4 (between the SMF 246 and UPF 248), N5 (between PCF 256 and AF 260), N6 (between UPF 248 and DN 236), N7 (between SMF 246 and PCF 256), N8 (between UDM 258 and AMF 244), N9 (between two UPFs 248), N10 (between the UDM 258 and the SMF 246), N11 (between the AMF 244 and the SMF 246), N12 (between AUSF 242 and AMF 244), N13 (between AUSF 242 and UDM 258), N14 (between two AMFs 244; not shown), N15 (between PCF 256 and AMF 244 in case of a non-roaming scenario, or between the PCF 256 in a visited network and AMF 244 in case of a roaming scenario), N16 (between two SMFs 246; not shown), and N22 (between AMF 244 and NSSF 250). Other reference point representations not shown in FIG. 2 can also be used. The service-based representation of FIG. 2 represents NFs within the control plane that enable other authorized NFs to access their services. The service-based interfaces (SBIs) include Namf (SBI exhibited by AMF 244), Nsmf (SBI exhibited by SMF 246), Nnef (SBI exhibited by NEF 252), Npcf (SBI exhibited by PCF 256), Nudm (SBI exhibited by UDM 258), Naf (SBI exhibited by AF 260), Nnrf (SBI exhibited by NRF 254), Nnssf (SBI exhibited by NSSF 250), Nausf (SBI exhibited by AUSF 242). Other service-based interfaces (e.g., Nudr, N5g-eir, and Nudsf) not shown in FIG. 2 can also be used. In some examples, the NEF 252 can provide an interface to edge compute nodes, which can be used to process wireless connections with the NG-RAN 214.

In some implementations, the network architecture 200 may include an SMSF, which is responsible for SMS subscription checking and verification and relaying SM messages to/from the UE 202 to/from other entities, such as an SMS-GMSC/IWMSC/SMS-router. The SMS may also interact with AMF 244 and UDM 258 to notify the UE 202 that it is available for SMS transfer (e.g., by setting a UE not reachable flag and notifying UDM 258 when UE 202 becomes available for SMS).

The 5GS may also include an SCP (or individual instances of the SCP) that supports indirect communication; delegated discovery; message forwarding and routing to destination NF/NF service(s), communication security (e.g., authorization of the NF Service Consumer to access the NF Service Producer API) (see, e.g., 3GPP TS 33.501), load balancing, monitoring, overload control, and the like; and discovery and selection functionality for UDM(s) 258, AUSF(s) 242, UDR(s), PCF(s) 256 with access to subscription data stored in the UDR based on UE's SUPI, SUCI, or GPSI (see e.g., [TS23501]§ 6.3). Load balancing, monitoring, and overload control functionality provided by the SCP may be implementation-specific. The SCP may be deployed in a distributed manner. More than one SCP can be present in the communication path between various NF Services. The SCP, although not an NF instance, can also be deployed in a distributed, redundant, and scalable manner.

FIG. 3 schematically illustrates a wireless network 300 in accordance with various embodiments. The wireless network 300 may include a UE 302 in wireless communication with an AN 304. The UE 302 and AN 304 may be similar to, and substantially interchangeable with, like-named components described elsewhere herein.

The UE 302 may be communicatively coupled with the AN 304 via connection 306. Connection 306 is illustrated as an air interface to enable communicative coupling and can be consistent with cellular communications protocols such as an LTE protocol or a 5G NR protocol operating at FR2 (mmWave) or FR1 (sub-7 GHz) frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example, UDP) and Internet (for example, IP) operations.

The protocol processing circuitry 314 may implement one or more layer operations to facilitate the transmission or reception of data over connection 306. The layer operations implemented by the protocol processing circuitry 314 may include, for example, MAC, RLC, PDCP, RRC, and NAS operations.

The modem platform 310 may further include digital baseband circuitry 316 that may implement one or more layer operations that are “below” the layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency, or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, a mixer, intermediate frequency (IF) components, etc.; the receive circuitry 320 may include an analog-to-digital converter, a mixer, IF components, etc.; the RF circuitry 322 may include a low-noise amplifier, a power amplifier, power tracking components, etc.; the RFFE 324 may include filters (for example, surface/bulk acoustic wave filters), switches, antenna tuners, beamforming components (for example, phase-array antenna components), etc. The selection and arrangement of the components of the transmit circuitry 318, receive circuitry 320, RF circuitry 322, RFFE 324, and one or more antenna panels 326 (referred to generically as “transmit/receive components”) may be specific to details of a specific implementation, such as, for example, whether the communication is TDM or FDM, in FR2 (mmWave) or FR1 (sub-7 GHz) frequencies, etc. In some embodiments, the transmit/receive components may be arranged in multiple parallel transmit/receive chains, may be disposed of in the same or different chips/modules, etc.

In some embodiments, the protocol processing circuitry 314 may include one or more instances of control circuitry (not shown) to provide control functions for the transmit/receive components.

A UE reception may be established by and via the one or more antenna panels 326, RFFE 324, RF circuitry 322, receive circuitry 320, digital baseband circuitry 316, and protocol processing circuitry 314. In some embodiments, the one or more antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and one or more antenna panels 326. In some embodiments, the transmit components of the UE 302 may apply a spatial filter to the data to be transmitted to form a transmit beam emitted by the antenna elements of the one or more antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with the like-named components of the UE 302. In addition to performing data transmission/reception as described above, the components of the AN 304 may perform various logical functions that include, for example, RNC functions such as radio bearer management, uplink and downlink dynamic radio resource management, and data packet scheduling.

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400, including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400.

The one or more processors 410 may include, for example, a processor 412 and a processor 414. The one or more processors 410 may be, for example, a central processing unit (CPU), a reduced instruction set computing (RISC) processor, a complex instruction set computing (CISC) processor, a graphics processing unit (GPU), a digital signal processor (DSP) such as a baseband processor, an application-specific integrated circuit (ASIC), a field-programmable gate array (FPGA), a radio-frequency integrated circuit (RFIC), another processor (including those discussed herein), or any suitable combination thereof.

The memory/storage devices 420 may include a main memory, disk storage, or any suitable combination thereof. The memory/storage devices 420 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The one or more communication resources 430 may include interconnection or network interface controllers, components, or other suitable devices to communicate with one or more peripheral devices 404, one or more databases 406, or other network elements via a network 408. For example, the one or more communication resources 430 may include wired communication components (e.g., for coupling via USB, Ethernet, etc.), cellular communication components, near-field communication (NFC) components, Bluetooth® (or Bluetooth Low Energy) components, Wi-Fi components, and other communication components.

Instructions 450 may comprise software, a program, an application, an applet, an app, or other executable code for causing at least one of the one or more processors 410 to perform any one or more of the methodologies discussed herein. Instructions 450 may reside, completely or partially, within at least one of the one or more processors 410 (e.g., within the processor's cache memory), the memory/storage devices 420, or any suitable combination thereof. Furthermore, any portion of the instructions 450 may be transferred to the hardware resources 400 from any combination of one or more peripheral devices 404 or one or more databases 406. Accordingly, the memory of one or more processors 410, the memory/storage devices 420, one or more peripheral devices 404, and one or more databases 406 are examples of computer-readable and machine-readable media.

FIG. 5 illustrates another example network architecture 500. The network architecture 500 may operate in a manner consistent with 3GPP technical specifications or technical reports for 6G systems. In some examples, the network architecture 500 may operate concurrently with network architecture 200. For example, in some examples, network architecture 500 may share one or more frequency or bandwidth resources with network architecture 200. As one specific example, a UE (e.g., UE 502) may be configured to operate in both network architecture 500 and network architecture 200. Such a configuration may be based on a UE including circuitry configured for communication with the frequency and bandwidth resources of both network architectures 200 and 500. In general, several elements of network architecture 500 may share one or more characteristics with elements of network architecture 200. For the sake of brevity and clarity, such elements may not be repeated in the description of network architecture 500.

The network architecture 500 may include a UE 502, which may include any mobile or non-mobile computing device designed to communicate with a RAN 508 via an over-the-air connection. The UE 502 may be similar to, for example, UE 202. The UE 502 may be, but is not limited to, a smartphone, tablet computer, wearable computer device, desktop computer, laptop computer, in-vehicle infotainment, in-car entertainment device, instrument cluster, a head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not explicitly shown in FIG. 5, in some examples, the network architecture 500 may include a set of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not explicitly shown in FIG. 5, the UE 502 may be communicatively coupled with an AP, such as AP 206, as described with respect to FIG. 2. Additionally, although not explicitly shown in FIG. 5, in some examples, the RAN 508 may include one or more ANs, such as AN 208, as described with respect to FIG. 2. The RAN 508 and/or the AN of the RAN 508 may be referred to as a base station (BS), a RAN node, or using some other term or name.

The UE 502 and the RAN 508 may be configured to communicate via an air interface that may be referred to as a sixth-generation (6G) air interface. The 6G air interface may include one or more features, such as communication in terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally, or alternatively, be referred to as “millimeter wave” or “mmWave” frequency ranges.

The RAN 508 may allow for communication between the UE 502 and a 6G core network (CN) 510. Specifically, the RAN 508 may facilitate the transmission and reception of data between the UE 502 and the 6G CN 510. The 6G CN 510 may include various functions, such as NSSF 550, NEF 552, NRF 554, PCF 556, UDM 558, AF 560, SMF 546, and AUSF 542. The 6G CN 510 may additionally include UPF 548 and DN 539, as shown in FIG. 5.

Additionally, the RAN 508 may include various additional functions that are in addition to, or alternative to, the functions of a legacy cellular network, such as a 4G or 5G network. Two such functions may include a Compute Control Function (Comp CF) 524 and a Compute Service Function (Comp SF) 536. The Comp CF 524 and the Comp SF 536 may be parts or functions of the Computing Service Plane. Comp CF 524 may be a control plane function that provides functionalities such as management of the Comp SF 536, computing task context generation and management (e.g., create, read, modify, delete), interaction with the underlying computing infrastructure for computing resource management, etc. Comp SF 536 may be a user plane function that serves as the gateway to interface computing service users (such as UE 502) and computing nodes behind a Comp SF instance. Some functionalities of the Comp SF 536 may include parsing computing service data received from users to compute tasks executable by computing nodes, holding service mesh ingress gateway or service API gateway, service and charging policies enforcement, performance monitoring, and telemetry collection. In some examples, a Comp SF 536 instance may serve as the user plane gateway for a cluster of computing nodes. A Comp CF 524 instance may control one or more Comp SF 536 instances.

Two other such functions may include a Communication Control Function (Comm CF) 528 and a Communication Service Function (Comm SF) 538, which may be parts of the Communication Service Plane. The Comm CF 528 may be the control plane function for managing the Comm SF 538, communication session creation/configuration/releasing, and managing communication session context. The Comm SF 538 may be a user plane function for data transport. Comm CF 528 and Comm SF 538 may be considered as upgrades of SMF 246 and UPF 248, which were described with respect to a 5G system in FIG. 2. The upgrades provided by the Comm CF 528 and the Comm SF 538 may enable service-aware transport. For legacy (e.g., 4G or 5G) data transport, SMF 246 and UPF 248 may still be used.

Two other such functions may include a Data Control Function (Data CF) 522 and a Data Service Function (Data SF) 532, which may be parts of the Data Service Plane. Data CF 522 may be a control plane function and provides functionalities such as Data SF 532 management, Data service creation/configuration/releasing, Data service context management, etc. Data SF 532 may be a user plane function and serve as the gateway between data service users (such as UE 502 and the various functions of the 6G CN 510) and data service endpoints behind the gateway. Specific functionalities may include parsing data service user data and forwarding it to corresponding data service endpoints, generating charging data, and reporting data service status.

Another such function may be the Service Orchestration and Chaining Function (SOCF) 520, which may discover, orchestrate, and chain up communication/computing/data services provided by functions in the network. Upon receiving service requests from users, SOCF 520 may interact with one or more of Comp CF 524, Comm CF 528, and Data CF 522 to identify Comp SF 536, Comm SF 538, and Data SF 532 instances, configure service resources, and generate the service chain, which could contain multiple Comp SF 536, Comm SF 538, and Data SF 532 instances and their associated computing endpoints. Workload processing and data movement may then be conducted within the generated service chain. The SOCF 520 may also be responsible for maintaining, updating, and releasing a created service chain.

Another such function may be the service registration function (SRF) 514, which may act as a registry for system services provided in the user plane, such as services provided by service endpoints behind Comp SF 536 and Data SF 532 gateways and services provided by the UE 502. The SRF 514 may be considered a counterpart of NRF 254, which may act as the registry for network functions.

Other such functions may include an evolved service communication proxy (eSCP) and a service infrastructure control function (SICF) 526, which may provide service communication infrastructure for control plane services and user plane services. The eSCP may be related to the service communication proxy (SCP) of 5G, with the addition of user plane service communication proxy capabilities. The eSCP is therefore expressed in two parts: eCSP-C 512 and eSCP-U 534, for control plane service communication proxy and user plane service communication proxy, respectively. The SICF 526 may control and configure eCSP instances in terms of service traffic routing policies, access rules, load balancing configurations, performance monitoring, etc.

Another such function is the AMF 544. The AMF 544 may be similar to 244 but with additional functionality. Specifically, the AMF 544 may include potential functional repartition, such as moving the message forwarding functionality from the AMF 544 to the RAN 508.

Another such function is the service orchestration exposure function (SOEF) 518. The SOEF may be configured to expose service orchestration and chaining services to external users, such as applications.

The UE 502 may include an additional function that is referred to as a computing client service function (comp CSF) 504. The comp CSF 504 may have both the control plane functionalities and user plane functionalities and may interact with corresponding network-side functions, such as SOCF 520, Comp CF 524, Comp SF 536, Data CF 522, and/or Data SF 532, for service discovery, request/response, compute task workload exchange, etc. The comp CSF 504 may also work with network-side functions to decide whether a computing task should be run on the UE 502, the RAN 508, or an element of the 6G CN 510.

The UE 502 and/or the comp CSF 504 may include a service mesh proxy 506. The service mesh proxy 506 may act as a proxy for service-to-service communication in the user plane. Capabilities of the service mesh proxy 506 may include one or more of addressing, security, load balancing, and/or the like.

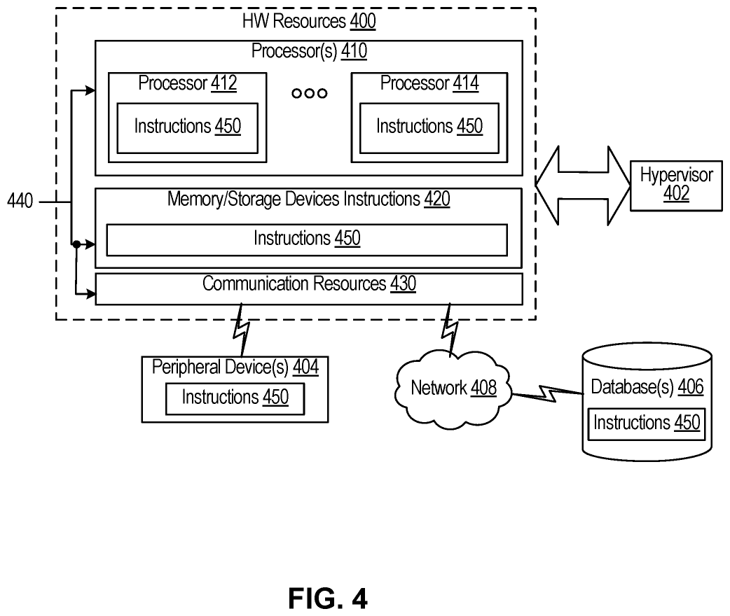

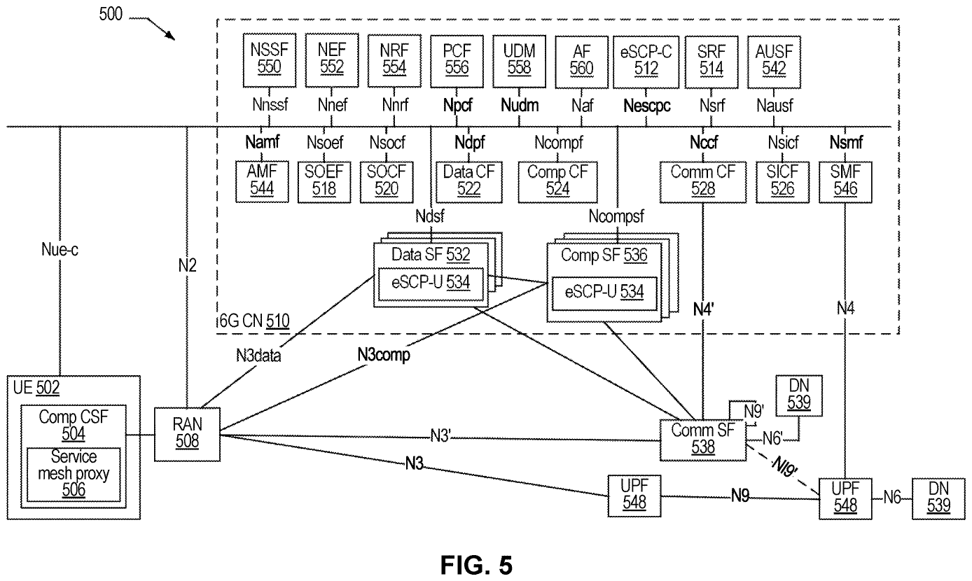

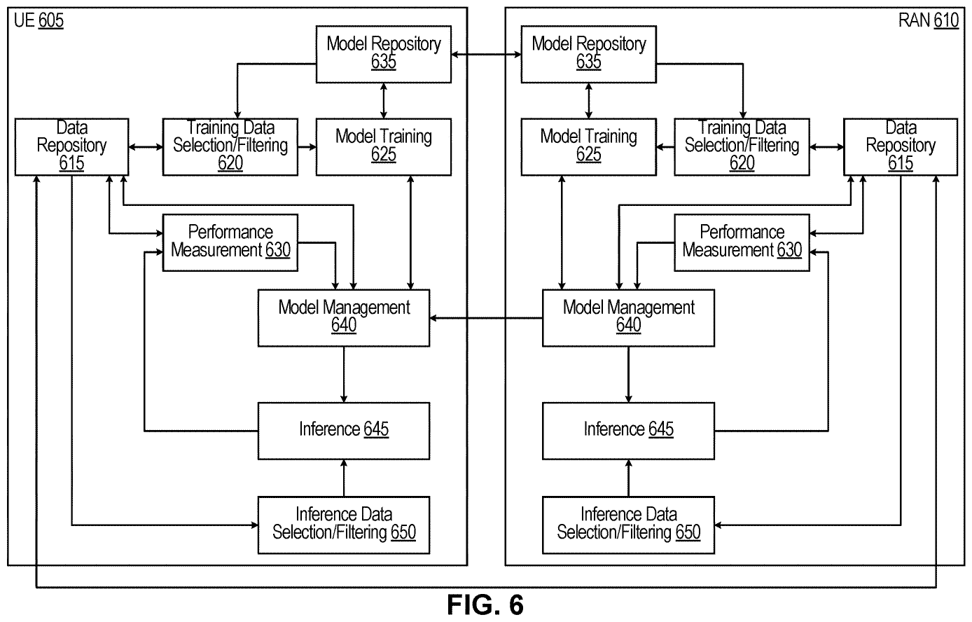

FIG. 6 depicts an example artificial intelligence (AI)-assisted communication architecture for communication between a UE 605 and a RAN 610. More specifically, as described in further detail below, AI/machine learning (ML) models may be used or leveraged to facilitate over-the-air communication between UE 605 and RAN 610.

In this example, the UE 605 and the RAN 610 operate in a manner consistent with 3GPP technical specifications and/or technical reports for 6G systems. In some examples, the wireless cellular communication between the UE 605 and the RAN 610 may be part of or operate concurrently with network architectures 500, 200, and/or some other network described herein.

The UE 605 may be similar to and share one or more features with UE 202, UE 302, UE 502, UE 702, hardware resources 400, and/or some other UE or device(s), such as any of those described herein. The UE 605 may be, but is not limited to, a smartphone, tablet computer, wearable computer device, desktop computer, laptop computer, in-vehicle infotainment, in-car entertainment device, instrument cluster, a head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc. The RAN 610 may be similar to, and share one or more features with, NG-RAN 214, RAN 508, and/or some other RAN described herein.

As may be seen in FIG. 6, the AI-related elements of UE 605 may be similar to the AI-related elements of RAN 610. For the sake of discussion herein, a description of the various elements will be provided from the point of view of the UE 605. However, it will be understood that such discussion or description will apply to equally named/numbered elements of RAN 610 unless explicitly stated otherwise.

As previously noted, the UE 605 may include various elements or functions that are related to AI/ML. Such elements may be implemented as hardware, software, firmware, and/or some combination thereof. For example, one or more of the elements may be implemented as part of the same hardware (e.g., a chip or a multi-processor chip), software (e.g., a computing program), or firmware as another element.

One such element may be a data repository 615. The data repository 615 may be responsible for data collection and storage. Specifically, the data repository 615 may collect and store RAN configuration parameters, measurement data, performance key performance indicators (KPIs), model performance metrics, etc., for model training, update, and inference. More generally, collected data is stored in the repository. Stored data can be discovered and extracted by other elements from the data repository 615. For example, as may be seen, the inference data selection/filtering element 650 may retrieve data from the data repository 615. In various examples, the UE 605 may be configured to discover and request data from the data repository 615 in the RAN and vice versa. More generally, the data repository 615 of the UE 605 may be communicatively coupled with the data repository 615 of the RAN 610 so that the respective data repositories of the UE and the RAN may share collected data.

Another such element may be a training data selection/filtering functional block 620. The training data selection/filtering functional block 620 may be configured to generate training, validation, and testing datasets for model training. Training data may be extracted from the data repository 615. Data may be selected/filtered based on the specific AI/ML model to be trained. Data may optionally be transformed/augmented/pre-processed (e.g., normalized) before being loaded into datasets. The training data selection/filtering functional block 620 may label data in datasets for supervised learning. The produced datasets may then be fed into the model training functional block 625.

As noted above, another such element may be the model training functional block 625. This functional block may be responsible for training and updating (re-training) AI/ML models. The selected model may be trained using the fed-in datasets (including training, validation, and testing) from the training data selection/filtering functional block. The model training functional block 625 may produce trained and tested AI/ML models that are ready for deployment. The produced, trained, and tested models can be stored in a model repository 635.

The model repository 635 may be responsible for the storage and exposure of AIL models (both trained and untrained). Trained/updated model(s) may be stored in the model repository 635. Model and model parameters may be discovered and requested by other functional blocks (e.g., the training data selection/filtering functional block 620 and/or the model training functional block 625). In some examples, the UE 605 may discover and request AI/ML models from the model repository 635 of the RAN 610. Similarly, the RAN 610 may be able to discover and/or request AI/ML models from the model repository 635 of the UE 605. In some examples, the RAN 610 may configure models and/or model parameters in the model repository 635 of the UE 605.

Another such element may be a model management functional block 640. The model management functional block 640 may be responsible for the management of the AI/ML model produced by the model training functional block 625. Such management functions may include the deployment of a trained model, monitoring model performance, etc. In model deployment, the model management functional block 640 may allocate and schedule hardware and/or software resources for inference based on received trained and tested models. As used herein, “inference” refers to the process of using trained AI/ML model(s) to generate data analytics, actions, policies, etc., based on input inference data. In performance monitoring, based on wireless performance KPIs and model performance metrics, the model management functional block 640 may decide to terminate the running model, start model re-training, select another model, etc. For example, the model management functional block 640 of the RAN 610 may be able to configure model management policies in the UE 605, as shown.

Another such element may be an inference data selection/filtering element 650. The inference data selection/filtering element 650 may be responsible for generating datasets for model inference at the inference functional block 645, as described below. Specifically, inference data may be extracted from the data repository 615. The inference data selection/filtering element 650 may select and/or filter the data based on the deployed AI/ML model. Data may be transformed/augmented/pre-processed following the same transformation/augmentation/pre-processing as those in training data selection/filtering, as described with respect to the training data selection/filtering functional block 620. The produced inference dataset may be fed into the inference functional block 645.

Another such element may be the inference functional block 645. The inference functional block 645 may be responsible for executing inference as described above. Specifically, the inference functional block 645 may consume the inference dataset provided by the inference data selection/filtering element 650 and generate one or more outcomes. Such outcomes may include data analytics, actions, policies, etc. The outcome(s) may be provided to the performance measurement functional block 630.

The performance measurement functional block 630 may be configured to measure model performance metrics (e.g., accuracy, model bias, run-time latency, etc.) of deployed and executing models based on the inference outcome(s) for monitoring purposes. Model performance data may be stored in the data repository 615.

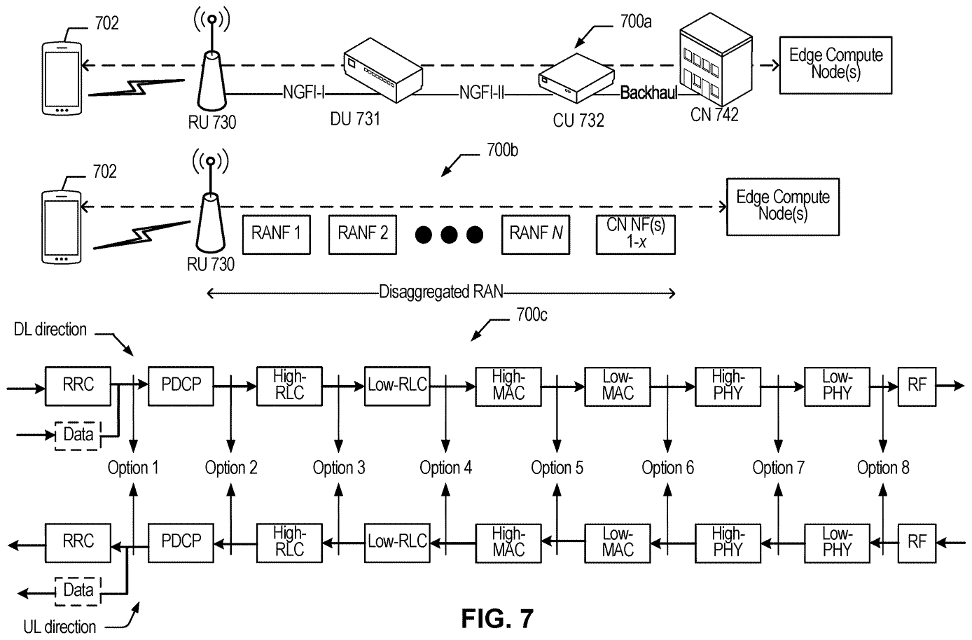

FIG. 7 depicts example RAN split architecture aspects. FIG. 7 shows an example network deployment including an example next-generation fronthaul (NGF) deployment 700a where a UE 702 is connected to an RU 730 (also referred to as a “remote radio unit 730”, “a remote radio head 730”, or “RRH 730”) via an air interface, the RU 730 is connected to a Digital Unit (DU) 731 via a NGF interface (NGFI)-I, the DU 731 is connected to a Central Unit (CU) 732 via an NGFI-II, and the CU 732 is connected to a core network (CN) 742 via a backhaul interface. In 3GPP NG-RAN implementations (see, e.g., [TS38401]), the DU 731 may be a distributed unit (the term “DU” may refer to a digital unit and/or a distributed unit unless the context dictates otherwise). UEs 702 may be the same or similar to UEs 202 and/or any other UE or user/client device discussed herein.

In some implementations, the NGF deployment 700a may be arranged in a distributed RAN (D-RAN) architecture where the CU 732, DU 731, and RU 730 reside at a cell site, and the CN 742 is located at a centralized site. Alternatively, the NGF deployment 700a may be arranged in a centralized RAN (C-RAN) architecture with centralized processing of one or more baseband units (BBUs) at the centralized site. In C-RAN architectures, the radio components are split into discrete components, which can be located in different locations. In one example C-RAN implementation, only the RU 730 is disposed at the cell site, and the DU 731, the CU 732, and the CN 742 are centralized or disposed at a central location. In another example C-RAN implementation, the RU 730 and the DU 731 are located at the cell site, and the CU 732 and the CN 742 are at the centralized site. In another example of C-RAN implementation, only the RU 730 is disposed at the cell site, the DU 731 and the CU 732 are located at a RAN hub site, and the CN 742 is at the centralized site.

The CU 732 is a central controller that can serve or otherwise connect to one or multiple DUs 731 and/or multiple RUs 730. The CU 732 is a network (logical) node hosting higher/upper layers of a network protocol functional split. For example, in the 3GPP NG-RAN and/or O-RAN architectures, a CU 732 hosts the radio resource control (RRC), Service Data Adaptation Protocol (SDAP), and Packet Data Convergence Protocol (PDCP) layers of a next-generation NodeB (gNB), or hosts the RRC and PDCP protocol layers when included in or operating as an E-UTRA-NR gNB (en-gNB). The SDAP sublayer performs mapping between quality of service flows and data radio bearers (DRBs) and marking quality of service flow IDs (QFI) in both DL and UL packets. The PDCP sublayer performs transfer of user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer-based SDU discard; routing for split bearers; duplication and duplicate discarding; reordering and in-order delivery; and/or out-of-order delivery. In various implementations, a CU 732 terminates respective F1 interfaces connected with corresponding DUs 731 (see, e.g., [TS38401]).

A CU 732 may include a CU-control plane (CP) entity (referred to herein as “CU-CP 732”) and a CU-user plane (UP) entity (referred to herein as “CU-UP 732”). The CU-CP 732 is a logical node hosting the RRC layer and the control plane part of the PDCP protocol layer of the CU 732 (e.g., a gNB-CU for an en-gNB or a gNB). The CU-CP 732 terminates an E1 interface connected with the CU-UP, and the F1-C interface is connected with a DU 731. The CU-UP 732 is a logical node hosting the user plane part of the PDCP protocol layer (e.g., for a gNB-CU 732 of an en-gNB), and the user plane part of the PDCP protocol layer and the SDAP protocol layer (e.g., for the gNB-CU 732 of a gNB). The CU-UP 732 terminates the E1 interface connected with the CU-CP 732 and the F1-U interface connected with a DU 731.

The DU 731 controls radio resources, such as time and frequency bands, locally in real time and allocates resources to one or more UEs. The DUs 731 are network (logical) nodes hosting middle and/or lower layers of the network protocol functional split. For example, in the 3GPP NG-RAN and/or O-RAN architectures, a DU 731 hosts the radio link control (RLC) medium access control (MAC), and high-physical (PHY) layers of the gNB or en-gNB, and its operation is at least partly controlled by the CU 732. The RLC sublayer operates in one or more of the Transparent Mode (TM), Unacknowledged Mode (UM), and Acknowledged Mode (AM). The RLC sublayer performs transfer of upper-layer PDUs; sequence numbering independent of the one in PDCP (UM and AM); error correction through ARQ (AM only); segmentation (AM and UM) and re-segmentation (AM only) of RLC SDUs; reassembly of SDUs (AM and UM); duplicate detection (AM only); RLC SDU discard (AM and UM); RLC re-establishment; and/or protocol error detection (AM only). The MAC sublayer performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding. In some implementations, a DU 731 can host a Backhaul Adaptation Protocol (BAP) layer (see e.g., 3GPP TS 38.340 v16.5.0 (2021-07-07)) and/or an F1 application protocol (F1AP) (see e.g., 3GPP TS 38.470 v16.5.0 (2021-07-01)), such as when the DU 731 is operating as an Integrated Access and Backhaul (IAB) node. One DU 731 supports one or multiple cells, and one cell is supported by only one DU 731. A DU 731 terminates the F1 interface connected with a CU 732. Alternatively, the DU 731 may be connected to one or more RRHs/RUs 730.

The RU 730 is a transmission/reception point (TRP) or other physical node that handles radio frequency (RF) processing functions. The RU 730 is a network (logical) node hosting lower layers based on a lower-layer functional split. For example, in 3GPP NG-RAN and/or O-RAN architectures, the RU 730 hosts low-PHY layer functions and RF processing of the radio interface based on a lower-layer functional split. The RU 730 may be similar to 3GPP's transmission/reception point (TRP) or RRH, but specifically includes the Low-PHY layer. Examples of low-PHY functions include Fast Fourier transform (FFT), inverse FFT (IFFT), physical random access channel (PRACH) extraction, and the like.

Each of the CUs 732, DUs 731, and RUs 730 is connected via its respective link, which may be any suitable wireless and/or wired link (e.g., fiber, copper, and the like). In some implementations, various combinations of the CU 732, DU 731, and RU 730 may correspond to one or more of the ANs 208 of FIG. 2. Additional aspects of CUs 732, DUs 731, and RUs 730 are discussed in [O-RAN], [TS38401], [TS38410], and [TS38300], the contents of each of which are hereby incorporated by reference in their entirety.

In some implementations, a fronthaul gateway function (FHGW) may be disposed between the DU 731 and the RU/RRU 730 (not shown by FIG. 7), where the interface between the DU 731 and the FHGW is an Open Fronthaul (e.g., Option 7-2x) interface, the interface between the FHGW function and the RU/RRU 730 is an Open Fronthaul (e.g., Option 7-2x) interface or any other suitable interface (e.g., option 7, option 8, or the like) including those that do not support Open Fronthaul (e.g., Option 7-2x). The FHGW may be packaged with one or more other functions (e.g., Ethernet switching and/or the like) in a physical device or appliance. In some implementations, a RAN controller may be communicatively coupled with the CU 732 and/or the DU 731.

NGFI (also referred to as “xHaul” or the like) is a two-level fronthaul architecture that separates the traditional RRU 730 to BBU connectivity in the C-RAN architecture into two levels, namely levels I and II. Level I connects the RU 730 via the NGFI-I to the DU 731, and level II connects the DU 731 via the NGFI-II to the CU 732, as shown by deployment 700a in FIG. 7. The NGFI-I and NGFI-II connections may be wired connections or wireless connections, which may utilize any suitable RAT such as any of those discussed herein. The purpose of the two-level architecture is to distribute (split) the RAN node protocol functions between CU 732 and DU 731 such that latencies are relaxed, giving more deployment flexibility. In general, the NGFI-I interfaces with the lower layers of the function split, which have stringent delay and data rate requirements. In contrast, NGFI-II interfaces with higher layers of the function split relative to the layers of the NGFI-I, relaxing the requirements for the fronthaul link. Examples of the NGFI fronthaul interfaces and functional split architectures include O-RAN 7.2x fronthaul (see e.g., [O-RAN.WG9.XPSAAS] and [O-RAN-WG4.CUS.0]), Enhanced Common Radio Interface (CPRI) based C-RAN fronthaul (see e.g., Common Public Radio Interface: eCPRI Interface Specification, eCPRI Specification v2.0 (2019-05-10), Common Public Radio Interface: Requirements for the eCPRI Transport Network, eCPRI Transport Network v1.2 (2018-06-25), and [O-RAN-WG4.CUS.0]), Radio over Ethernet (RoE) based C-RAN fronthaul (see, e.g., IEEE Standard for Radio over Ethernet Encapsulations and Mappings, IEEE Standards Association, IEEE 1914.3-2018 (Oct. 5, 2018) (“[IEEE1914.3]”)), and/or the like. Additional aspects of NGFI are also discussed in [O-RAN.WG9.XPSAAS], [O-RAN-WG4.CUS.0], IEEE Standard for Packet-based Fronthaul Transport Networks, IEEE Standards Association, IEEE 1914.1-2019 (Apr. 21, 2020) (“[IEEE1914.1]”), [IEEE1914.3], and Nasrallah et al., Ultra-Low Latency (ULL) Networks: A Comprehensive Survey Covering the IEEE TSN Standard and Related ULL Research, arXiv:1803.07673v1 [cs.NI](Mar. 20, 2018) (“[Nasrallah]”), the contents of each of which are hereby incorporated by reference in their entirety.

In one example, the deployment 700a may implement a low-level split (LLS) (also referred to as a “Lower Layer Functional Split 7-2x” or “Split Option 7-2x”) that runs between the RU 730 (e.g., an O-RU in O-RAN architectures) and the DU 731 (e.g., an O-DU in O-RAN architectures) (see, e.g., [O-RAN.WG7.IPC-HRD-Opt7-2], [O-RAN.WG7.OMAC-HRD], [O-RAN.WG7.OMC-HRD-Opt7-2], [O-RAN.WG7.OMC-HRD-Opt7-2]). In this example implementation, the NGFI-I is the Open Fronthaul interface described in the O-RAN Open Fronthaul Specification (see, e.g., [O-RAN-WG4.CUS.0]). Other LLS options may be used, such as the relevant interfaces described in other standards or specifications such as, for example, the 3GPP NG-RAN functional split (see e.g., [TS38401] and 3GPP TR 38.801 v14.0.0 (2017-04-03)), the Small Cell Forum for Split Option 6 (see e.g., 5G small cell architecture and product definitions: Configurations and Specifications for companies deploying small cells 2020-2025, Small Cell Forum, document 238.10.01 (Jul. 5, 2020) (“[SCF238]”), 5G NR FR1 Reference Design: The case for a common, modular architecture for 5G NR FR1 small cell distributed radio units, Small Cell Forum, document 251.10.01 (Dec. 15, 2021) (“[SCF251]”), and [O-RAN.WG7.IPC-HRD-Opt6]), the contents of each of which is hereby incorporated by reference in its entirety, and/or in O-RAN white-box hardware Split Option 8 (e.g., [O-RAN.WG7.IPC-HRD-Opt8]).

Additionally or alternatively, the CUs 732, DUs 731, and/or RUs 730 may be IAB nodes. IAB enables wireless relaying in an NG-RAN where a relaying node (referred to as an “IAB-node”) supports access and backhauling via 3GPP 5G/new radio (NR) links/interfaces. The terminating node of NR backhauling on the network side is referred to as an “IAB-donor,” which represents a RAN node (e.g., a gNB) with additional functionality to support IAB. Backhauling can occur via a single or multiple hops. All IAB nodes that are connected to an IAB-donor via one or multiple hops form a directed acyclic graph (DAG) topology with the IAB-donor as its root. The IAB-donor performs centralized resource, topology, and route management for the IAB topology. The IAB architecture is shown and described in [TS38300].

Although the NGF deployment 700a shows the CU 732, DU 731, RRH 730, and CN 742 as separate entities, in other implementations, some or all of these network nodes can be bundled, combined, or otherwise integrated into a single device or element, including collapsing some internal interfaces (e.g., F1-C, F1-U, E1, E2, and the like). At least the following implementations are possible: (i) integrating the CU 732 and the DU 731 (e.g., a CU-DU), which is connected to the RRH 730 via the NGFI-I; (ii) integrating the DU 731 and the RRH 730 (e.g., a DU-RRH), which is connected to the CU 732 via NGFI-II; (iii) integrating a RAN controller and the CU 732, which is connected to the DU 731 via NGFI-II; (iv) integrating the CU 732, the DU 731, and the RRH 730, which is connected to the CN 742 via a backhaul interface; and (v) integrating the network controller (or intelligent controller), the CU 732, the DU 731, and the RRH 730. Any of the aforementioned example implementations involving the CU 732 may also include integrating the CU-CP and CU-UP.

FIG. 7 also shows an example RAN disaggregation deployment 700b (also referred to as “disaggregated RAN 700b”) where the UE 702 is connected to the RRH 730, and the RRH 730 is communicatively coupled with one or more of the RAN functions (RANFs) 1-N (where N is a number). The RANFs 1-N are disaggregated and distributed geographically across several component segments and network nodes. In some implementations, each RANF 1-N is a software (SW) element executed on a physical compute node, and the RRH 730 includes radio-frequency (RF) circuitry (e.g., an RF propagation module for a particular RAT and/or the like). In this example, RANF 1 is operated on a physical compute node co-located with the RRH 730, and the other RANFs are located farther from the RRH 730. Additionally, in this example, CN 742 is also disaggregated into CN NFs 1-x (where x is a number) in the same or similar manner as the RANFs 1-N. However, in other implementations, the CN 742 is not disaggregated.

Network disaggregation (or disaggregated networking) involves separating networking equipment into functional components and allowing each component to be deployed individually. This may encompass separating SW elements (e.g., NFs) from specific HW elements and/or using APIs to enable software-defined networking (SDN) and/or NF virtualization (NFV). RAN disaggregation involves network disaggregation and the virtualization of various RANFs (e.g., RANFs 1-N in FIG. 7). The RANFs 1-N can be deployed across different physical sites and topologies in an RAN deployment, depending on the use case. This enables RANF distribution and deployment across different geographic areas, allowing RANFs to be broken out to support various use cases (e.g., low-latency use cases) and to support flexible RAN implementations. Disaggregation provides a common, uniform RAN platform that can assume a distinct profile based on its deployment location. This enables fewer fixed-function devices and a lower total cost of ownership compared to existing RAN architectures. Example RAN disaggregation frameworks include the Telecom Infra Project (TIP) OpenRAN, Cisco Open vRAN, [O-RAN], Open Optical & Packet Transport (OOPT), Reconfigurable Optical Add Drop Multiplexer (ROADM), and/or the like.

In a first example implementation, the RANFs 1-N disaggregate RAN HW and SW using commercial-off-the-shelf (COTS) HW and open interfaces (e.g., NGFI-I, NGFI-II, and the like). In this example implementation, each RANF 1-N may be a virtual BBU or vRAN controller operating on COTS compute infrastructure with HW acceleration for BBU/vRANFs.

In a second example implementation, the RANFs 1-N disaggregate layers of one or more RAT protocol stacks. As an example of this implementation, RANF 1 is a DU 731 operating on the first COTS compute infrastructure with HW acceleration for BBU/vRANFs, and RANF 2 is a virtual CU 732 operating on the second COTS compute infrastructure.

In a third example implementation, the RANFs 1-N disaggregate control plane and user plane functions. As an example of this implementation, the RANF 1 is a DU 731 operating on COTS compute infrastructure with HW acceleration for BBU/vRANFs, RANF 2 is a virtual CU-CP 732 operating on COTS compute infrastructure, and a third RANF (e.g., RANF 3 (not shown by FIG. 7)) is a virtual CU-UP 732 operating on the same or different COTS compute infrastructure as the virtual CU-CP 732. Additionally or alternatively, in this implementation, one or more CN NFs 1-x may be CN-UP functions, and one or more other CN NFs 1-x may be CN-CP functions.

In a fourth example implementation, the RANFs 1-N disaggregate layers of an [IEEE802] RAT. As an example of this implementation, the RRH 730 implements a WiFi PHY layer, RANF 1 implements a WiFi MAC sublayer, RANF 1 implements a WiFi logical link control (LLC) sublayer, RANF 2 implements one or more WiFi upper layer protocols (e.g., network layer, transport layer, session layer, presentation layer, and/or application layer), and so forth.

In a fifth example implementation, the RANFs 1-N disaggregate different O-RAN RANFs, including E2SMs. As an example of this implementation, RANF 1 implements the near-RT RIC, RANF 2 implements the E2SM-KPM, RANF 3 implements the E2SM-CCC, RANF 4 implements the E2SM RAN control, RANF 5 implements the E2SM-NI, RANF 6 implements functions for providing A1 services, and so forth.

In any of the implementations discussed herein, the lower layers of the RAN protocol stack can be characterized by real-time (RT) functions and relatively complex signal processing algorithms, and the higher layers of the RAN protocol stack can be characterized by non-RT functions. In these implementations, the RT functions and signal processing algorithms can be implemented in DUs 731 and/or RRHs 730, either using purpose-built network elements or COTS hardware augmented with purpose-built hardware accelerators.

FIG. 7 also shows various functional split options 700c for both DL and UL directions. The traditional RAN is an integrated network architecture based on a distributed RAN (D-RAN) model, in which D-RAN aggregates all RANFs into a few network elements. As previously alluded to, the disaggregated RAN architecture offers flexible function split options to overcome the various drawbacks of the D-RAN model. The disaggregated RAN breaks the integrated network system into several functional components that can be relocated individually as needed without hindering their ability to work together to provide holistic network services. The split options 700c are mostly split between the CU 732 and the DU 731, but can also include a split among the CU 732, DU 731, and RU 730. For each option 700c, protocol entities on the left side of the figure are included in the RANF implementing the CU 732, and the protocol entities on the right side of the figure are included in the RANF implementing the DU 731. For example, the Option 2 function split includes splitting non-RT processing (e.g., RRC and PDCP layers) from RT processing (e.g., RLC, MAC, and PHY layers), where the RANF implementing the CU 732 performs network functions of the RRC and PDCP layers, and the RANF implementing the DU 731 performs the baseband processing functions of the RLC (including high-RLC and low-RLC), MAC (including high-MAC and low-MAC), and PHY layers. In some implementations, the PHY layer is further split between the DU 731 and the RU 730, with the RANF in the DU 731 performing the high-PHY layer functions, and the RU 730 handling the low-PHY layer functions. In some implementations, the Low-PHY entity may be operated by the RU 730 regardless of the selected functional split option. Under the Option 2 split, the RANF implementing the CU 732 can connect to multiple DUs 731 (e.g., a centralized CU 732), eliminating the need to change the RRC and PDCP anchors during handovers across DUs 731 and allowing the centralized CU 732 to pool resources across several DUs 731. In this way, the Option 2 function split can improve resource efficiency. The specific function split option used may vary depending on service requirements and network deployment scenarios, and may be implementation-specific. It should also be noted that in some implementations, all of the function split options can be selected where each protocol stack entity is operated by a respective RANF (e.g., a first RANF operates the RRC layer, a second RANF operates the PDCP layer, a third RANF operates the high-RLC layer, and so forth until an eighth RANF operates the low-PHY layer). Other split options are possible, such as those discussed in [O-RAN.WG7.IPC-HRD-Opt6], [O-RAN.WG7.IPC-HRD-Opt7-2], [O-RAN.WG7.IPC-HRD-Opt8], [O-RAN.WG7.OMAC-HRD], and [O-RAN.WG7.OMC-HRD-Opt7-2].

For one or more embodiments, at least one of the components outlined in one or more of the preceding figures may be configured to perform one or more operations, techniques, processes, and/or methods as discussed herein (including the examples listed in the examples sections below). For example, baseband circuitry associated with one or more of the preceding figures may be configured to operate in accordance with one or more of the examples set forth below. For another example, circuitry associated with a UE, base station, satellite, network element, etc., as described above in connection with one or more of the preceding figures, may be configured to operate in accordance with one or more of the examples set forth below in the example section.

The term “application” may refer to a complete, deployable package or environment that performs a specific function in an operational environment. The term “AI/ML application,” or a similar term, may refer to an application that incorporates artificial intelligence (AI) and/or machine learning (ML) models, along with application-level descriptions. In some embodiments, an AI/ML application may be used to configure or implement one or more of the disclosed aspects.

The term “machine learning” or “ML” refers to the use of computer systems implementing algorithms and/or statistical models to perform a specific task(s) without using explicit instructions but instead relying on patterns and inferences. ML algorithms build or estimate mathematical models (referred to as “ML models” or the like) based on sample data (referred to as “training data,” “model training information,” or the like) to make predictions or decisions without being explicitly programmed to perform such tasks. Generally, an ML algorithm is a computer program that learns from experience regarding a specific task and a corresponding performance measure. An ML model, on the other hand, may be any object or data structure created after an ML algorithm is trained on one or more training datasets. After training, an ML model may be used to make predictions on new datasets. Although the term “ML algorithm” refers to concepts different from the term “ML model,” these terms, as discussed herein, may be used interchangeably.

The term “machine learning model,” “ML model,” or the like may also refer to ML methods and concepts used by an ML-assisted solution. An “ML-assisted solution” addresses a specific use case by using ML algorithms during operation. ML models include supervised learning (e.g., linear regression, k-nearest neighbor (KNN), decision tree algorithms, support machine vectors, Bayesian algorithm, ensemble algorithms, etc.), unsupervised learning (e.g., K-means clustering, principal component analysis (PCA), etc.), reinforcement learning (e.g., Q-learning, multi-armed bandit learning, deep RL, etc.), neural networks, and the like. Depending on the implementation, a specific ML model may comprise many sub-models, and the model may train all of them simultaneously. Separately trained ML models can also be chained together in an ML pipeline during inference. An “ML pipeline” is a set of functionalities, functions, or functional entities specific to an ML-assisted solution; an ML pipeline may include one or several data sources in a data pipeline, a model training pipeline, a model evaluation pipeline, and an actor. The “actor” is an entity that hosts an ML-assisted solution that uses the ML model's inference output. The term “ML training host” refers to an entity, such as a network function, that hosts the model training. The term “ML inference host” refers to an entity, such as a network function, that hosts the model during inference (including both model execution and any online learning, if applicable). The ML host informs the actor of the ML algorithm's output, and the actor decides on an action (an “action” is performed by an actor as a result of the ML-assisted solution's output). The term “model inference information” refers to information used as an input to the ML model for determining inference(s); the data used to train an ML model and the data used to determine inferences may overlap, however, “training data” and “inference data” refer to different concepts.

Performance of Physical Downlink Shared Channel (PDSCH) transmission in 5G New Radio (NR) cellular communication systems depends on the availability of Channel State Information (CSI) at the Base Station (BS) or gNodeB (gNB). CSI feedback can be used to derive CSI. In this case, User Equipment (UE) reports CSI to the BS based on UE measurements of CSI Reference Signals (CSI-RS) and CSI Interference Measurement (CSI-IM) signals. For future 6G standards, CSI feedback is expected to play a role in the performance of Downlink (DL) data transmission.

In some cases, a BS can configure a UE with multiple CSI Measurement Resources (CSI-RS/CSI-IM) and multiple CSI Reports for a given Component Carrier (CC) or across multiple CCs. There is a limit on the number of configured CSI Measurement Resources and CSI Reports due to finite computational resources and memory at the UE. Furthermore, the BS allows a certain latency for CSI processing at the UE.

Given that required processing time and computation complexity can vary across configurations and cases for CSI measurements and CSI Reports, and considering the range of UE implementations and approaches for CSI processing, aligning BS assumptions about UE processing functionalities with the actual UE situation is a non-trivial task. If the CSI processing assumptions are not aligned with the actual situation, either the BS is constrained to configure fewer CSI measurements and/or CSI Reports, or the UE is unable to process all of the configured CSI measurements and/or CSI Reports. In both cases, system performance is expected to degrade compared to the case of aligned CSI processing assumptions.

The disclosed techniques include methods related to alignment of CSI processing assumptions between a BS and a UE, including a CSI processing alignment framework with one or more CSI Processors assumed at the UE, each CSI Processor having one or more CSI Compute Resources. Rules are defined for CSI Compute Resource assignment (allocation) to CSI Reports and for CSI Compute Resource release. UE behavior is defined for the cases of CSI processing overflow and failure to compute a CSI Report.

The following configurations relate to the Channel State Information (CSI) feedback background.

In some aspects, CSI feedback is used in NR systems to assist scheduling, link adaptation, precoding, and spatial multiplexing operations for PDSCH transmission. A CSI Report is transmitted from user equipment (UE) to the Base Station (BS) or gNodeB (gNB) via the physical uplink control channel (PUCCH) or the physical uplink shared channel (PUSCH). The content of the CSI Report is determined at the UE based on BS configuration and UE channel and/or interference measurements from CSI Reference Signals (CSI-RS) and CSI Interference Measurements (CSI-IM).

In some aspects, there are four main components of the CSI Report:
(a) CSI-RS resource indicator (CRI) indicates the CSI-RS resource which is selected by the UE and used for computation of other CSI components in the CSI Report;
(b) Rank indicator (RI) contains information on the number of spatial layers (rank) recommended by the UE for PDSCH;
(c) Precoding matrix indicator (PMI) contains information on the precoding matrix recommended by the UE for PDSCH from the set of precoding matrices representing the PMI codebook; and
(d) Channel quality indicator (CQI) contains information about SE (Spectral Efficiency) and/or effective SINR (Signal-to-Interference-and-Noise-Ratio) of hypothetical PDSCH transmission estimated at the UE and/or modulation or coding scheme recommended by the UE for a hypothetical PDSCH transmission with the given QoS (e.g., BLER).

For a given CSI Report, the UE is configured with K≥1 CSI-RS resources, each corresponding to P≥1 CSI-RS ports. To determine CRI/RI/PMI/CQI for the CSI Report, the UE can measure the channel on the configured CSI-RS resources and CSI-RS ports.

The exact CSI content may vary depending on the Physical Layer (PHY) specification and BS configuration.

UL transmission (e.g., PUSCH or PUCCH) can carry multiple CSI Reports corresponding to different configurations of CSI content (e.g., PMI codebook), different configurations of reference signals (e.g., CSI-RS), and/or different DL Component Carriers (CCs).

In some aspects, the following three different time-domain behaviors can be considered for CSI Report transmission and/or reference signals for CSI measurements transmission:
(a) Periodic transmission: UE is semi-statically configured to transmit/receive a channel/signal every P time units (e.g., slots), where P is semi-statically configured;
(b) Semi-persistent transmission: upon receiving an activation message from the BS, the UE transmits/receives a channel/signal every P time units (e.g., slots), and the UE stops the transmission/reception upon reception of a deactivation message from the BS, where P is semi-statically configured or indicated in the activation message; and
(c) Aperiodic transmission: upon a trigger message received from the BS, UE transmits/receives a channel/signal N time units (e.g., slots) after reception of the corresponding trigger message, where N is semi-statically configured or indicated in the trigger message.

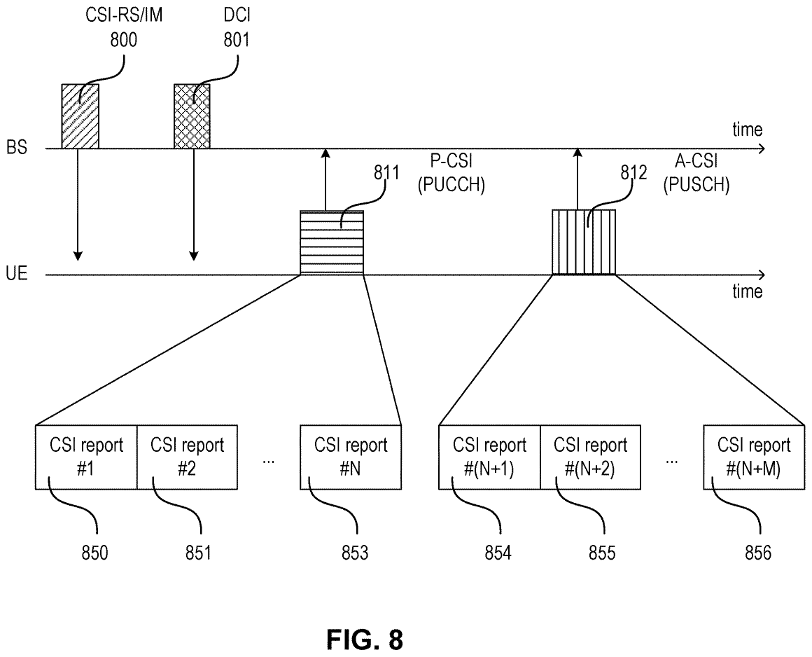

CSI with different time behaviors is possible for CSI Reporting (CSI transmission via PUCCH/PUSCH) and CSI measurements (CSI-RS/CSI-IM transmission). A time diagram with an example of CSI Report transmission from the UE is presented in FIG. 8.

FIG. 8 is a time diagram with an example of CSI report transmission from the UE, in accordance with some aspects.

In FIG. 8, reference 800 corresponds to reference signals (CSI-RS/CSI-IM) used by the UE to perform measurement and computation of CSI feedback; reference 801 corresponds to a DCI that triggers Aperiodic CSI (A-CSI); reference 811 corresponds to Periodic CSI (P-CSI) transmission from the UE via PUCCH; reference 812 corresponds to A-CSI transmission from the UE via PUSCH; references 850, 851, and 853 refer to CSI Reports configured to be included in P-CSI transmission; and references 854, 855, and 856 refer to CSI Reports triggered/configured to be included in A-CSI transmission.

The following description provides background on the UE/BS CSI processing alignment.

Considering that UE computational resources (including computation capacity and latency) and UE memory are limited, the UE cannot process an arbitrary number of CSI Reports with arbitrary complexity in an arbitrary time. For proper system operation, the BS needs to know the UE's CSI processing capabilities so it can configure or trigger an appropriate number of CSI Reports with acceptable complexity to be processed by the UE within an acceptable time. Otherwise, degradation of system performance might be expected due to the waste of time/frequency resources used for DCI and/or PUSCH/PUCCH and/or reference signals used for CSI Reports, which the UE is not able to process.

In 4G LTE (Long Term Evolution) and 5G NR, multiple mechanisms are defined to ensure alignment between the UE's actual processing capabilities and the BS's assumed processing capabilities.

The following configurations relate to UE/BS CSI processing alignment in 4G LTE.

The number of CSI Reports and CSI processing time can be configured as follows.

For a UE without Carrier Aggregation (CA) support, the UE shall be able to process at least one CSI Report per subframe (1 ms) when the CSI Report is triggered in every subframe. For a given CSI Report, the UE shall complete processing within 4 subframes (4 ms) after CSI triggering or after reference signal reception, with a minimum time gap between triggering and reporting of 4 subframes. If the UE indicates support for N>1 CSI processes, the UE shall be able to process N CSI Reports per subframe (1 ms) when the CSI Report is triggered in every subframe for all CSI processes.

For a UE supporting Carrier Aggregation (CA), the UE shall be able to process at least 5 CSI Reports per subframe (1 ms) when the CSI Report is triggered in every subframe (assuming support for 5 or more CCs). For a given CSI Report, the UE shall complete processing within 4 subframes (4 ms) after CSI triggering or after reference signal reception, with a minimum time gap between triggering and reporting of 4 subframes. If the UE indicates support of N>1 CSI Processes, the UE shall be able to process 5*N CSI Reports per one subframe (1 ms) for the case where the CSI Report is triggered in every subframe for all the CSI Processes.

The complexity of CSI Reports is described below. In some aspects, the UE can be configured to process all configured CSI Reports within the configured time, assuming the worst-case CSI Report complexity allowed by UE capabilities. For example, if the UE indicates support of a CSI Report with 2 CSI-RS resources and 8 CSI-RS ports in each CSI-RS resource, the UE shall be able to calculate 5*N CSI Report per one subframe (1 ms) for the case of UE support of CA with N CSI Processes.

In some aspects, LTE design does not provide any relaxation of CSI computation time and number of CSI Reports requirements—it is the same for any CSI Report complexity, which makes it challenging for a UE to support CSI Reporting for a larger number of CSI-RS resources/ports and higher accuracy, which corresponds to higher CSI complexity per CSI Report.

The following configurations relate to UE/BS CSI processing alignment in 5G NR.

The alignment between the actual number of CSI Reports that the UE can process and the UE processing capabilities assumed by the BS is supported via the CSI Processing Unit (CPU) feature. An NR UE indicates the maximum number of occupied CPUs, where CPU occupancy rules are specified. A CSI Report can run on one or more CPUs, depending on the number of CSI-RS resources and/or the configured PMI codebook.

Minimum CSI processing time requirements are specified for at least two cases of CSI configuration (low latency requirement for lower complexity CSI Reports and higher latency requirements for higher complexity CSI Reports). Additional CSI processing time relaxation may be applied to particular PMI codebooks with very high PMI search complexity and to CSI-RS cases with different subcarrier spacing that trigger CSI Reports.

Total complexity of triggered CSI Reports can be limited by the maximum number of active CSI-RS ports and active CSI-RS resources, and the maximum number of CSI-RS resources and CSI-RS ports per PMI codebook and per combination of CSI codebooks.

Multiple mechanisms for aligning actual UE processing capabilities with the UE processing capabilities assumed by the BS are supported by the disclosed techniques, allowing the UE to implement new features with greater flexibility than in LTE. However, some improvements can be made to unify different mechanisms, considering that the number of CSI Reports, complexity of the CSI Reports, and time requirements are related to each other (e.g., more CSI Reports can be processed assuming lower complexity of one CSI Report for a given time, or the same number of CSI Reports can be processed faster assuming lower complexity of one CSI Report).

The following description relates to UE/BS CSI processing alignment framework configurations.

The new framework for UE/BS CSI processing alignment can consider at least the following points:
(a) Different complexity for different CSI Report configurations;
(b) Different time-domain behavior for CSI measurements and CSI reporting; and
(c) Processing of multiple CSI Reports at the UE in parallel (e.g., using multiple CSI Processors simultaneously) or in serial (e.g., using one CSI Processor in time).

The following are embodiments for the UE/BS processing alignment framework.

In some aspects, the BS and/or UE emulates CSI processing at the UE by using a set of abstracted entities and a set of defined/specified rules to determine states of each entity with respect to the processing of CSI report(s). Depending on the status, the BS and/or UE determines whether/how to receive/transmit the corresponding CSI report(s).

In some aspects, a UE supports P CSI Processors, where each CSI Processor corresponds to Cp CSI Compute Resources. For a time instance t (e.g., symbol or slot), there are cp(t) occupied CSI Compute Resources for a CSI Processor p, p=1, 2, . . . , P. The number of occupied CSI Compute Resources cp(t) is determined at the UE and/or at the BS based on at least the following: the number of occupied CSI Compute Resources in the previous time instance cp(t−1), the number of released CSI Compute Resources c(−)p(t), and the number of CSI Compute Resources newly occupied c(+)p(t). For example, the following equation can be used: cp(t)=cp(t−1)+c(+)p(t)− c(−)p(t).

In one option, the UE indicates the number of CSI processors P as part of UE capability signaling. In another option, the UE Pmin is specified as the minimum number of CSI Processors supported by the UE.

Further, a set of CSI Processors can correspond to a subset of CSI configurations (e.g., those with AI/ML and/or specific PMI codebook(s) and/or CSI Report Quantities), so that CSI processing alignment is performed separately for that subset.

Also, CSI Processors and/or CSI Compute Resources can be used by non-CSI features that require processing (e.g., computations for link failure, mobility (Radio Resource Management), Beam Management, etc.).

For example, a set of CPUs can be dedicated to CRI/L1-RSRP (Layer 1 Reference Signal Received Power) computation, channel covariance matrix computation, CSI computation based on AI/ML (Artificial Intelligence/Machine Learning), or a mix of multiple computation types, including the above.

In one example, two different CSI Processor types may be supported in the specification within one UE, i.e., a first CSI processor type has C1 compute resources and a second CSI processor type has C2 compute resources, where C1 is not equal to C2.

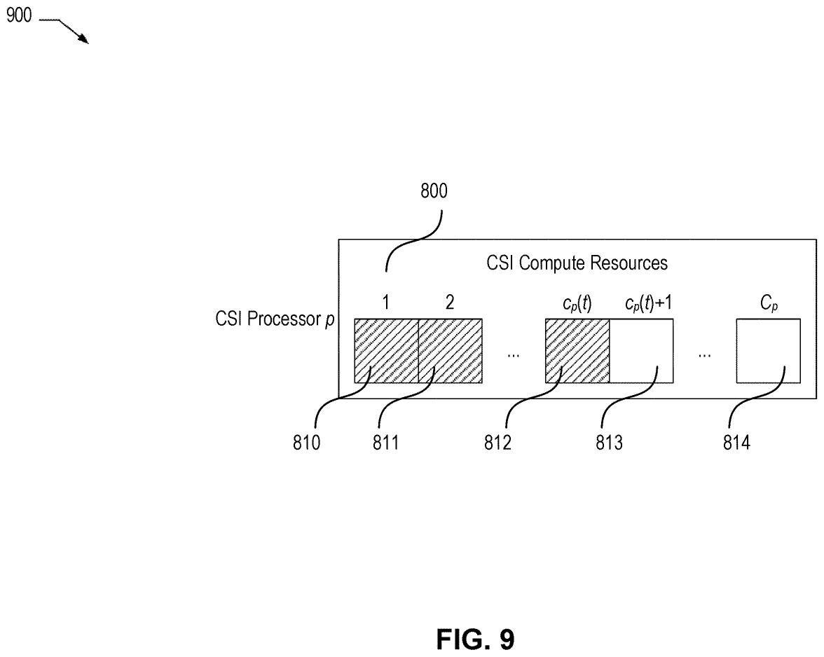

The CSI Processor concept is schematically represented in FIG. 9. FIG. 9 is a schematic representation 900 of a CSI processor concept, in accordance with some aspects. In FIG. 9, reference 800 corresponds to the CSI Processor p state assumed at the UE and/or at the BS for time instance t; references 810, 811, and 812 refer to occupied CSI Compute resources for time instance t and CSI processor p; and references 813 and 814 refer to unoccupied CSI Compute resources for time instance t and CSI processor p.

In some aspects, CSI Compute Resources for a CSI processor operate as a double-ended queue (deque), where allocation of CSI Compute Resources corresponds to an ‘Add to Front’ (or ‘Add to Rear’) operation, and release of CSI Compute Resources corresponds to a ‘Remove from Rear’ (or ‘Remove from Front’) operation.

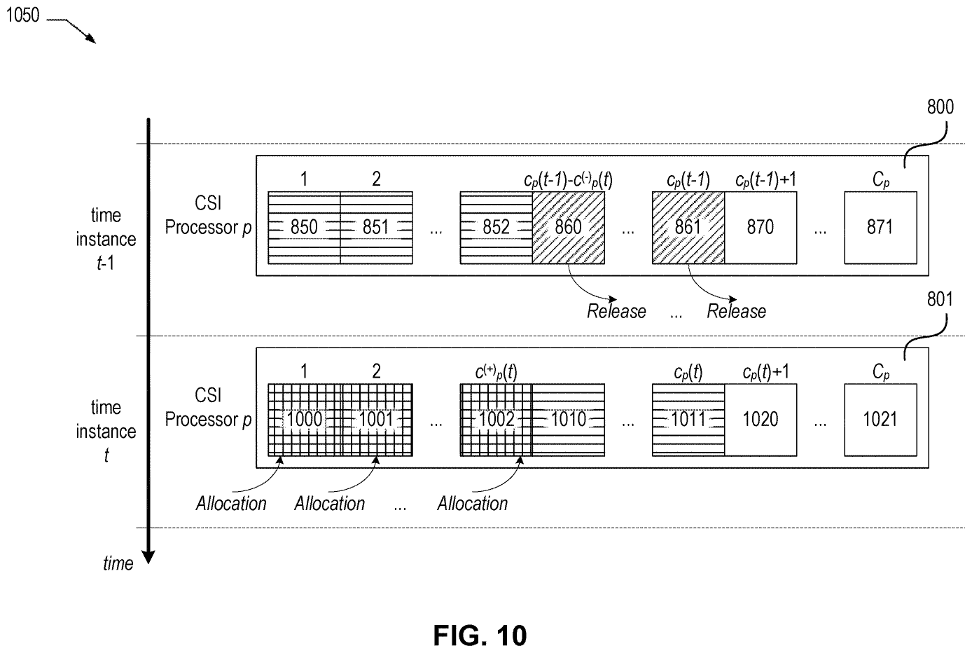

Schematic representation of the CSI Compute Resources release and allocation procedures for a time instance t is schematically represented in FIG. 10.

FIG. 10 is a schematic representation 1050 of CSI compute resources release and allocation procedures, in accordance with some aspects. In FIG. 10, reference 800 corresponds to the state of CSI Processor p in time instance t−1; reference 801 corresponds to the state of CSI Processor p in time instance t; references 850, 851, 852 correspond to CSI Compute Resources not to be released in time instance t; references 860 and 861 correspond to CSI Compute Resources to be released in time instance t; references 870 and 871 correspond to CSI Compute Resources not occupied in time instance t−1; references 1000, 1001, and 1002 correspond to CSI Compute Resources allocated in time instance t; references 1010 and 1011 correspond to CSI Compute Resources not released in time instance t (correspond to the same CSI Report(s) as 200, 202); and references 1020 and 1021 correspond to CSI Compute Resources not occupied in time instance t.

In some aspects, a CSI Compute Resource is assigned to a CSI Report. For example, a unique ID (nID) for a CSI Report is stored per CSI Processor and per CSI Compute Resource for each time instance t. For instance, Op,t(f)=nID, where Op,t is a data structure storing CSI Report IDs (e.g., vector or deque), f is the index of CSI Compute Resource f=1, 2, . . . , Cp, p is the CSI Processor index p=1, 2, . . . , P, t is a time instance (e.g., symbol or slot). If a CSI Compute Resource f is not assigned to a CSI Report for a CSI Processor p and time instance t, Op,t(f) can be empty, or store a specific value (e.g., −1 or infinity or NaN, etc.). A CSI Compute Resource can be assigned additional information (e.g., the used PMI codebook, CSI Report Quantity, etc.) to differentiate CSI Report Configurations.

Further, the time instance t corresponding to the allocation of CSI Compute Resources can be implicitly determined based on nID, or is stored in a separate structure.

In some cases, CSI processing across multiple CSI reports/configurations can be overlapped within a subset of CSI Compute Resources for a CSI processor. For example, a CSI Compute Resource corresponds to a list of CSI Reports/Configurations/IDs.

Full overlap of CSI Reports on the same set of CSI Compute Resources may correspond to parallel processing of the CSI Reports at the UE. Partial overlap of CSI Reports on a subset of CSI Compute Resources may correspond to pipelined processing of the CSI Reports at the UE.

In one example, the overlap of CSI Reports on a subset of CSI Compute Resources is indicated via UE capability.

The following description relates to the CSI Report CSI compute cost.

CSI compute cost corresponds to the number of allocated CSI Compute Resources across CSI Processors assumed at the UE and/or at the BS for a CSI Report.

In one embodiment, for a CSI Report n, UE and/or BS determine the CSI Compute Cost xₙ(p(k, K)) for a set of CSI Processors p(k, K) ∈ {1, 2, . . . , P}, k=1, 2, . . . , K, K=1, 2, . . . , P.

In another embodiment, if CSI Processors are equivalent, for a CSI Report n, CSI Compute Cost is xn(k, K), determined per CSI Processor k=1, 2, . . . , K, for K=1, 2, . . . , P.

In one specific option, when there are two CSI processor types, the compute cost can be defined as xn(k, K, 1) and xn(k, K, 2) for the first type and the second type, respectively. If a report n does not support calculation on a given CSI processor type, the CSI compute cost for this type is either undefined or considered to be infinity.

In one option, for a CSI Report n, one CSI Report is mapped to one CSI Processor (K=1), and the CSI Compute Cost is xn.

In some aspects, CSI Compute Cost (number of CSI Compute Resources and/or number of CSI Processors) is a function f(Y, E, F, D), e.g., xn=f(Y, E, F, D), where Y=[Y1, Y2, . . . ] corresponds to a set of specified parameters, E=[E1, E2, . . . ] corresponds to a set of parameters indicated by the UE via UE capability signaling, F=[F1, F2, . . . , FD] corresponds to the number of CSI-RS ports per CSI-RS resource, D corresponds to the number of CSI-RS resources.

For example, the CSI Compute Cost can correspond to a linear function of the number of CSI-RS resources: f(Y, E, F, D)=Y1+D*Y2; or, the CSI Compute Cost can correspond to a linear function of the total number of CSI-RS ports across CSI-RS resources: f(Y, E, F, D)=Y1+(F1+F2+ . . . +FD)*Y2.

In the above examples, Y1 and Y2 may represent a fixed value specified in a standards specification (e.g., Y1=Y2=1), or they may differ depending on the CSI configuration (e.g., the PMI codebook).

In one embodiment, Y and E are specified and/or indicated via UE capability signaling per PMI codebook and/or per CSI Report quantity corresponding to the CSI Report content and/or number of CSI-RS resources and/or CSI-RS ports corresponding to the CSI Report and/or channel bandwidth (e.g., CSI-RS bandwidth, number of subbands, number of carriers, etc.).

In another embodiment, Y and E are specified and/or indicated via UE capability signaling per PMI codebook and/or per CSI Report quantity corresponding to the CSI Report content and invariant of CSI-RS resources and CSI-RS ports corresponding to the CSI Report and/or channel bandwidth (e.g., CSI-RS bandwidth, number of subbands, number of carriers, etc.).

In one option, CSI Compute Cost is specified and/or indicated via UE capability signaling per PMI codebook and/or per CSI Report quantity corresponding to the CSI Report content as a function of the number of CSI-RS resources and CSI-RS ports corresponding to the CSI Report and/or channel bandwidth (e.g., CSI-RS bandwidth, number of subbands, number of carriers, etc.).

In another option, a UE can indicate multiple CSI Compute Costs, xn(k, K) and/or xn(p(k, K)), corresponding to processing across K=1, 2, . . . , P processors. E.g., CSI Compute Cost is xn(1,1)=4 for processing using K=1 CSI Processor and CSI Compute Cost is xn(1,2)=2, xn(2,2)=2 for processing using K=2 CSI Processors.

CSI Compute Resource allocation is discussed below.

CSI Compute Resources for one or multiple CSI Processors are allocated to a CSI Report according to the CSI Compute Cost for the CSI Report at time instance t.

In one embodiment, the CSI Compute Resource allocation operation corresponds to the ‘Add to Front’ (or ‘Add to Rear’) operation for a deque data structure associated with a CSI Processor.

The time instance for CSI Compute Resource allocation corresponds to the assumed start of UE processing for the CSI Report, which may include CSI measurements and/or the computation of CSI content.

In one embodiment, time instance t corresponds to a time instance (e.g., a slot or symbol) for the reception of control information (e.g., DCI) that triggers the corresponding CSI Report. In particular, the end of the last symbol carrying the triggering information may be considered as the instance t. In another embodiment, time instance t corresponds to the CSI reference resource location in the time domain (e.g., slot or symbol). Further, time instance t corresponds to the latest time instance (e.g., symbol) of the latest reference signal (e.g., CSI-RS and/or CSI-IM) corresponding to the CSI Report before the CSI Report transmission and/or before the corresponding CSI reference resource (if applicable).

The selection of CSI Processors is discussed below. For the below embodiments on selection of CSI Processors, it is assumed that the CSI Compute Cost for a CSI Report corresponds to the number of CSI Compute Resources for a single CSI processor. However, the framework can be extended to the case where multiple CSI processors are used for a single CSI Report.

In one embodiment, CSI Processor g assigned for a CSI Report is selected at the UE and/or at the BS based on the minimum cp(t) in the time instance for CSI Compute Resource allocation t across all CSI Processors p=1, 2, . . . , P (g=argmin(cp(t), p=1, 2, . . . , P)).

In another embodiment, CSI Processor g assigned for a CSI Report is selected at the UE and/or at the BS based on the minimum CSI Processor index p=1, 2, . . . , P, with the number of unoccupied CSI Compute Resources Cp− cp(t) larger than the CSI Compute Cost (e.g., xn) of the corresponding CSI Report n.

In one option, the CSI Processor g assigned for a CSI Report at the UE is indicated by the BS in DCI and/or configured via RRC.

In another option, the selection of the CSI Processor assigned to a CSI Report is based on the CC and/or PMI codebook and/or CSI quantity and/or CSI Report ID, and/or other information element/indicator corresponding to the CSI Report.

Prioritization of CSI Reports is discussed below.

For the below embodiments on prioritization of CSI Reports, it is assumed that the CSI Compute Cost for a CSI Report corresponds to the number of CSI Compute Resources for a single CSI processor. However, the framework can be extended to the case where multiple CSI processors are used for a single CSI Report.

In one embodiment, if processing of N>1 CSI Reports started at time instance t, CSI Compute Resources are allocated to the CSI Reports based on the order determined by a priority function, PRI, either in ascending or descending order. In one example, the priority function, PRI, depends on the CSI Report ID, CSI Report Quantity, PMI codebook, time-domain behavior, and other information elements/indicators associated with the CSI Report.

In another embodiment, if processing of N>1 CSI Reports started at time instance t, the order of the CSI Compute Resource allocation is indicated by the BS and/or configured by higher layers.

In some aspects, all the CSI Compute Resources previously allocated for a CSI Report n are released in a time instance t+Tn, where t corresponds to a time instance (e.g., symbol or slot) in which the CSI Compute Resources were allocated, and Tn corresponds to the time period assumed at the UE and/or at the BS for the processing of the CSI Report n. In one example, Tn is specified and/or indicated by the UE as part of UE capability for a subset of CSI Report configurations (e.g., number of CSI-RS ports/resources, CSI Report Quantity, PMI codebook, etc.).

In some aspects, for a CSI Processor P in a time instance t, either before or after allocation of CSI Compute Resources, the number of occupied CSI Compute Resources cp(t) is updated as follows: cp(t)=max(cp(t−1)−c(−)p(t), 0), where c(−)p(t) is the number of released CSI Compute Resources.

In one example, c(−)p(t) is specified and/or indicated via UE capability signaling.

In one example, release of CSI Compute Resources is periodic and corresponds to time period TP, where c(−)p(t) is 0 for time instances mod(t, TP)≠0 and c(−)p(t)=c(−)p for time instances mod(t, TP)=0, where c(−)p is specified and/or indicated via UE capability signaling.

CSI processing event configurations are discussed below.

In some aspects, the CSI processing event is determined at the UE and gNB side and may include at least the following: normal CSI operation, CSI processing overflow, and failure to finish CSI processing for a CSI report. In case of normal CSI operation, it is assumed that the UE processes and transmits the CSI reports as configured by the BS.

A CSI processing overflow event occurs when the CSI Compute Cost for a CSI Report exceeds the number of available (unoccupied) CSI Compute Resources for the CSI Processor p selected for CSI Compute Resource allocation at the time of CSI Compute Resource allocation for the CSI Report. CSI Compute Resource allocation may follow disclosed embodiments, including usage of the priority function PRI. In this case, the CSI processing overflow event occurs for a subset of CSI Reports, based on the CSI Report ordering determined by the PRI function.

In some cases, when a CSI processing overflow event occurs for a CSI Report, the UE is not expected to update it. In some aspects, in case of a CSI processing overflow event for a CSI Report, the UE shall not transmit the CSI Report and/or omit the CSI Report from PUSCH/PUCCH. Further, in case of CSI processing overflow event for a CSI Report, the UE indicates a specified combination of CSI bits (e.g., all bits are zero and/or CQI bits correspond to out-of-range CQI, etc.) or indicates the event explicitly (e.g., by using a special bit for the CSI Report).

In another embodiment, in the case of a CSI processing overflow event for a CSI Report, CSI Compute Resources allocated to the CSI Report are distributed across multiple CSI Processors, if allowed by UE capability and/or specification.

Failure to finish CSI processing for a CSI report corresponds to the event in which, at time instance tR corresponding to the transmission of the CSI report, one or more CSI Compute Resources are left assigned to the CSI Report.

In one embodiment, if CSI processing for a CSI report fails, the UE is not expected to update the CSI Report. In another embodiment, in case of failure to finish CSI processing for a CSI report, the UE shall not transmit the CSI Report and/or omit the CSI Report from PUSCH/PUCCH. Further, in case of failure to finish CSI processing for a CSI report, the UE indicates a specified combination of CSI bits (e.g., all bits are zero and/or CQI bits correspond to out-of-range CQI, etc.) or indicates the event explicitly (e.g., by using a special bit for the CSI Report).

Configurations related to alignment between UE and BS are discussed below.

In one aspect, the BS and UE are aligned with respect to the UE's processing capacity, measured in time units (TU) associated with CSI Compute Resources. As an example, (see below), a processing capacity of 6 TU per 4 CSI Compute Resources is abstracted as a fully or partially parallel processing unit of 4 CSI Compute Resources, whereas a 3 TU per 3 CSI Compute Resources is abstracted as a fully or partially parallel processing unit of 2 CSI Compute Resources.

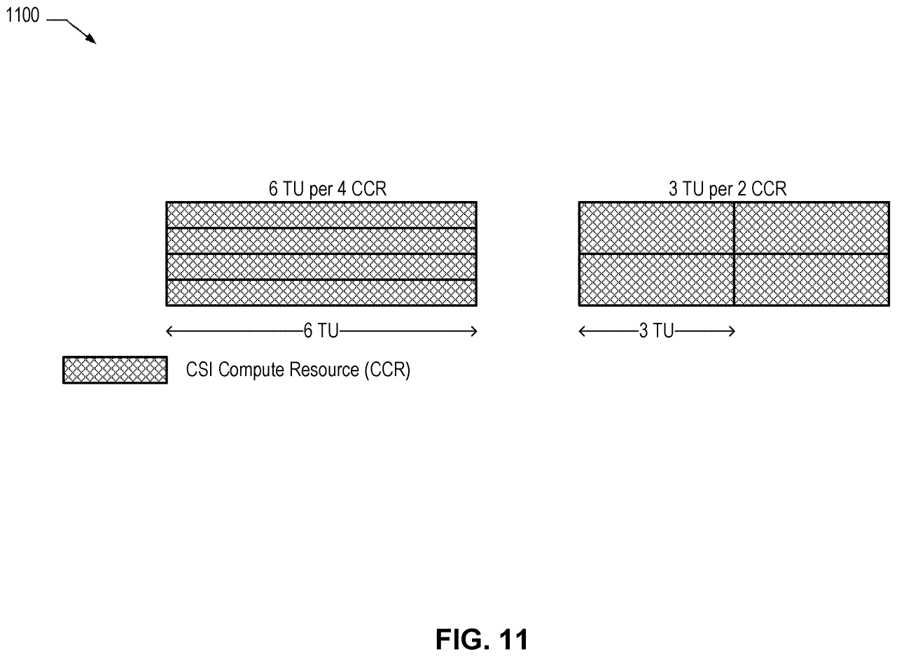

FIG. 11 illustrates a diagram 1100 of the alignment of UE processing capabilities and base station (BS) assumptions on the number of Time Units (TU) and CSI Compute Resources (CCR), in accordance with some aspects.

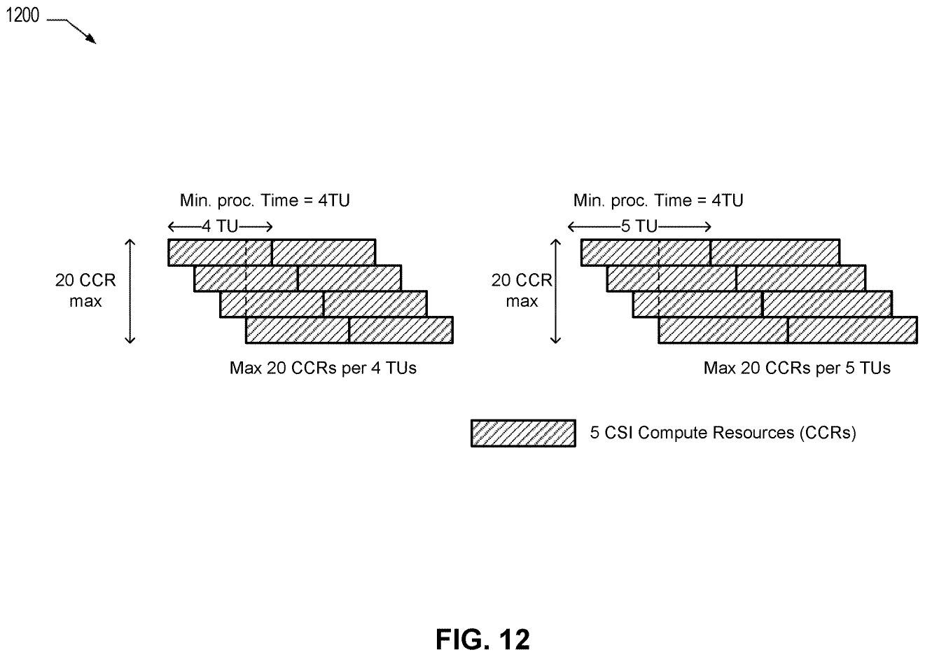

FIG. 12 illustrates a diagram 1200 of the alignment of UE processing capabilities and BS assumptions on the number of CCRs within a minimum processing time, in accordance with some aspects.

In one aspect, the BS and UE are aligned with respect to the UE's processing capacity, as measured by the maximum number of CSI Compute Resources. As an example, a maximum of 20 CSI Compute Resources.

In one aspect, BS and UE are aligned on the UE's processing capacity, i.e., the minimum processing time for N CSI Compute Resources. As an example, a minimum of 4 TUs for 5 CSI Compute Resources.

In one aspect, BS and UE are aligned in terms of the UE's processing capacity, i.e., the maximum number of CSI Compute Resource requests over N TUs. As an example, a maximum of 20 CSI Compute Resources for 4 TUs or a maximum of 20 CSI Compute Resources for 5 TUs.

The disclosed techniques include a method of CSI measurements and reporting at the UE. The method includes configuring CSI measurements and CSI reporting at the UE by the base station (BS), and determining a CSI processing event at the UE and/or BS based on the state of one or multiple CSI Processors.

In some aspects, a CSI processor corresponds to a set of CSI Compute Resources, where each CSI Compute Resource may be associated with one or more CSI Reports at time instance t.

In some aspects, the state of CSI Processors in time instance t corresponds to the number of CSI Compute Resources occupied by CSI Reports c(t).

In some respects, a set of rules governs the allocation of CSI Compute Resources for CSI Reports and their release.

In some cases, the number of CSI Compute Resources allocated to a CSI Report across one or more CSI Processors is defined in the corresponding specification and/or reported by the UE as the CSI Compute Cost.

In some aspects, CSI Compute Cost is a function of the number of CSI-RS resources, or CSI-RS ports, or CSI-RS bandwidth, and the number of subbands configured for the CSI report.

In some cases, the CSI processing event corresponds to normal CSI operation, CSI processing overflow, or failure to complete CSI processing for a CSI report.

In some cases, for normal CSI operation, it is assumed that the UE processes and transmits a set of CSI reports as configured by the BS if no CSI Compute Resources are left associated with the set.

In some aspects, for CSI processing overflow, it is assumed that the UE drops and/or does not update a set of CSI reports if the number of occupied CSI Compute Resources exceeds the UE's supported limit.

In some cases, if CSI processing for a CSI report fails, it is assumed that the UE drops and/or does not update the CSI report if CSI Compute Resources remain associated with the set of CSI reports at the time instance corresponding to CSI report transmission.

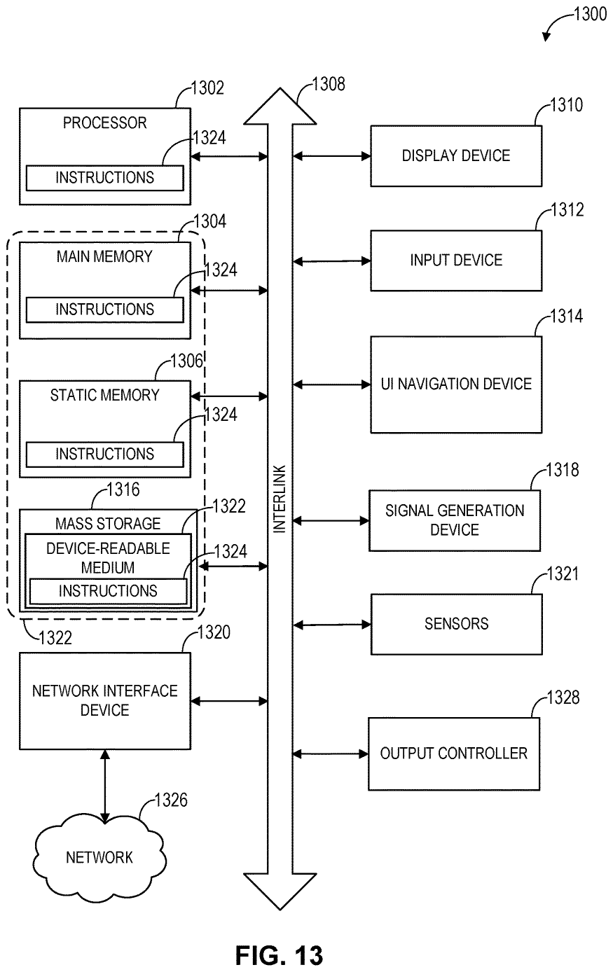

FIG. 13 illustrates a block diagram of a communication device, such as an evolved Node-B (eNB), a new generation Node-B (gNB) (or another RAN node, such as a base station), a network-controlled repeater (NCR), an access point (AP), a wireless station (STA), a mobile station (MS), or user equipment (UE), in accordance with some aspects, and to perform one or more of the techniques disclosed herein. In alternative aspects, the communication device 1300 may operate as a standalone device or may be connected (e.g., networked) to other communication devices.

Circuitry (e.g., processing circuitry) is a collection of circuits implemented in tangible components of the device 1300, including hardware (e.g., simple circuits, gates, logic). Circuitry membership may be flexible over time. Circuitries include members that may, alone or in combination, perform specified operations when operating. For example, the circuitry hardware may be immutably designed to carry out a specific operation (e.g., hardwired). For example, the circuitry may include variably connected physical components (e.g., execution units, transistors, simple circuits, etc.), including a machine-readable medium physically modified (e.g., magnetically, electrically, or by moving invariant-mass particles) to encode instructions for the specific operation.

In connecting the physical components, the underlying electrical properties of a hardware constituent are changed, for example, from an insulator to a conductor or vice versa. The instructions enable embedded hardware (e.g., execution units or a loading mechanism) to create members of the circuitry in hardware via variable connections, thereby carrying out portions of the specific operation during operation. Accordingly, in an example, the machine-readable medium elements are part of the circuitry or are communicatively coupled to the other components of the circuitry when the device is operating. For example, any physical component may be used in more than one member of more than one circuitry. For example, under operation, execution units may be used in the first circuit of a first circuitry at one point in time and reused by a second circuit in the first circuitry or by a third circuit in a second circuitry at a different time. Additional examples of these components with respect to the device 1300 follow.

In some aspects, the device 1300 may operate as a standalone device or may be connected (e.g., networked) to other devices. In a networked deployment, the communication device 1300 may operate as a server or client communication device, or both, in server-client network environments. For example, the communication device 1300 may act as a peer-to-peer (P2P) communication device in a peer-to-peer (P2P) or other distributed network environment. The communication device 1300 may be a UE, eNB, PC, tablet PC, STB, PDA, mobile telephone, smartphone, a web appliance, network router, a switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include or may operate on logic or several components, modules, or mechanisms. Modules are tangible entities (e.g., hardware) capable of performing specified operations and may be configured or arranged in a particular manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each module does not need to be instantiated at any one moment in time. For example, where the modules comprise a general-purpose hardware processor configured using the software, the general-purpose hardware processor may be configured as different modules at different times. The software may accordingly configure a hardware processor, for example, to constitute a particular module at one instance of time and to constitute a different module at a different instance of time.

The communication device (e.g., UE) 1300 may include a hardware processor 1302 (e.g., a central processing unit (CPU), a graphics processing unit (GPU), a hardware processor core, or any combination thereof), a main memory 1304, a static memory 1306, and a storage device 1316 (e.g., hard drive, tape drive, flash storage, or other block or storage devices), some or all of which may communicate with each other via an interlink 1308 (e.g., a bus).

The communication device 1300 may further include a display device 1310, an input device 1312 (e.g., a keyboard), and a user interface (UI) navigation device 1314 (e.g., a mouse). In an example, the display device 1310, input device 1312, and UI navigation device 1314 may be a touchscreen display. The communication device 1300 may additionally include a signal generation device 1318 (e.g., a speaker), a network interface device 1320, and one or more sensors 1321, such as a global positioning system (GPS) sensor, compass, accelerometer, or another sensor. The communication device 1300 may include an output controller 1328, such as a serial (e.g., universal serial bus (USB)), parallel, or other wired or wireless (e.g., infrared (IR), near field communication (NFC), etc.) connection to communicate or control one or more peripheral devices (e.g., a printer, card reader, etc.).

The storage device 1316 may include a device-readable medium 1322, on which one or more sets of data structures or instructions 1324 (e.g., software) are stored, embodying or utilized by any one or more of the techniques or functions described herein. In some aspects, registers of the hardware processor 1302, the main memory 1304, the static memory 1306, and/or the storage device 1316 may be, or include (entirely or at least partially), the device-readable medium 1322, on which are stored the one or more sets of data structures or instructions 1324, embodying or utilized by any one or more of the techniques or functions described herein. In an example, one or any combination of the hardware processor 1302, the main memory 1304, the static memory 1306, or the storage device 1316 may constitute the device-readable medium 1322.

As used herein, the term “device-readable medium” is interchangeable with “computer-readable medium” or “machine-readable medium.” While the device-readable medium 1322 is illustrated as a single medium, the term “communication device-readable medium” may refer to a single medium or to multiple media (e.g., a centralized or distributed database and/or associated caches and servers) configured to store the instructions 1324. The term “communication device-readable medium” is inclusive of the terms “machine-readable medium” or “computer-readable medium” and may include any medium that is capable of storing, encoding, or carrying instructions (e.g., instructions 1324) for execution by the communication device 1300 and that causes the communication device 1300 to perform any one or more of the disclosed techniques, or that is capable of storing, encoding, or carrying data structures used by or associated with such instructions. Non-limiting examples of communication device-readable media may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that are not transitory propagating signals.

Instructions 1324 may further be transmitted or received over a communications network 1326 using a transmission medium via the network interface device 1320, utilizing any one of several transfer protocols. In an example, the network interface device 1320 may include one or more physical jacks (e.g., Ethernet, coaxial, or phone jacks) or one or more antennas to connect to the communications network 1326. In an example, the network interface device 1320 may include a plurality of antennas to wirelessly communicate using at least one of the single-input-multiple-output (SIMO), multiple-input-multiple-output (MIMO), or multiple-input-single-output (MISO) techniques. In some examples, the network interface device 1320 may wirelessly communicate using multiple-user MIMO techniques.

The term “transmission medium” shall be taken to include any intangible medium that is capable of storing, encoding, or carrying instructions for execution by the communication device 1300, and includes digital or analog communications signals or another intangible medium to facilitate communication of such software. In this regard, a transmission medium in the context of the disclosed techniques is a device-readable medium.

The terms “machine-readable medium,” “computer-readable medium,” and “device-readable medium” mean the same thing and may be used interchangeably. The terms are defined to include both machine-storage media and transmission media. Thus, the terms include both storage devices/media and carrier waves/modulated data signals.

Described implementations of the subject matter can include one or more features, alone or in combination, as illustrated below by way of examples.

Example 1 is an apparatus for a user equipment (UE) configured for operation in a New Radio (NR) network, the apparatus comprising: processing circuitry, wherein the processing circuitry is to: decode configuration information for one or more channel state information (CSI) reports, the configuration information received from a base station; maintain a state of one or more CSI processors of the UE, each CSI processor associated with a plurality of CSI compute resources, the state indicating occupancy of the CSI compute resources at a time instance; allocate, for a CSI report of the one or more CSI reports, one or more CSI compute resources of at least one CSI processor of the one or more CSI processors based on the state; determine a CSI processing event for the CSI report based on the state of the one or more CSI processors; and encode, for transmission to the base station, content of the CSI report based on the CSI processing event; and memory coupled to the processing circuitry and configured to store the configuration information.

In Example 2, the subject matter of Example 1 includes functionalities such as, wherein the state of a CSI processor of the one or more CSI processors at the time instance is based on a number of occupied CSI compute resources at a previous time instance, a number of released CSI compute resources at the time instance, and a number of CSI compute resources newly occupied at the time instance.

In Example 3, the subject matter of Examples 1-2 includes functionalities such as, wherein the processing circuitry is further to encode, for transmission to the base station, UE capability signaling indicating a number of CSI processors supported by the UE.

In Example 4, the subject matter of Example 3 includes functionalities such as, wherein the one or more CSI processors include a first CSI processor of a first type associated with a first number of CSI compute resources and a second CSI processor of a second type associated with a second number of CSI compute resources, the first number being different from the second number.

In Example 5, the subject matter of Examples 1-4 includes functionalities such as, wherein a subset of the one or more CSI processors corresponds to a subset of CSI configurations, the subset of CSI configurations including at least one of CSI configurations based on artificial intelligence or machine learning (AI/ML), CSI configurations associated with a specified precoding matrix indicator (PMI) codebook, or CSI configurations associated with a specified CSI report quantity.

In Example 6, the subject matter of Examples 1-5 includes functionalities such as, wherein at least one of the CSI compute resources of a CSI processor of the one or more CSI processors is further associated with processing of a non-CSI feature, the non-CSI feature including at least one of link failure detection, radio resource management for mobility, or beam management.

In Example 7, the subject matter of Examples 1-6 includes functionalities such as, wherein the plurality of CSI compute resources of a CSI processor of the one or more CSI processors is organized as a double-ended queue, allocation of a CSI compute resource corresponding to an add operation on the double-ended queue and release of a CSI compute resource corresponding to a remove operation on the double-ended queue.

In Example 8, the subject matter of Examples 1-7 includes functionalities such as, wherein the processing circuitry is further to store, for a CSI compute resource of the one or more CSI compute resources allocated to the CSI report, an identifier of the CSI report.

In Example 9, the subject matter of Example 8 includes functionalities such as, wherein the processing circuitry is further to store, in association with the CSI compute resource, at least one of a precoding matrix indicator (PMI) codebook associated with the CSI report or a CSI report quantity associated with the CSI report.

In Example 10, the subject matter of Examples 1-9 includes functionalities such as wherein the processing circuitry is further to overlap processing of a plurality of CSI reports on a subset of the CSI compute resources of a CSI processor of the one or more CSI processors, a full overlap of the plurality of CSI reports on a same set of CSI compute resources corresponding to parallel processing and a partial overlap of the plurality of CSI reports on a subset of CSI compute resources corresponding to pipelined processing.

In Example 11, the subject matter of Examples 1-10 includes functionalities such as wherein the processing circuitry is to allocate the one or more CSI compute resources based on a CSI compute cost for the CSI report, the CSI compute cost corresponding to a number of CSI compute resources to be allocated across one or more CSI processors for the CSI report.

In Example 12, the subject matter of Example 11 includes functionalities such as wherein the CSI compute cost is a function of at least one of a number of CSI reference signal (CSI-RS) resources configured for the CSI report, a number of CSI-RS ports per CSI-RS resource configured for the CSI report, a CSI-RS bandwidth configured for the CSI report, or a number of subbands configured for the CSI report.

In Example 13, the subject matter of Examples 11-12 includes functionalities such as wherein the CSI compute cost is determined per at least one of a precoding matrix indicator (PMI) codebook or a CSI report quantity associated with the CSI report.

In Example 14, the subject matter of Examples 11-13 includes functionalities such as wherein the processing circuitry is further to encode, for transmission to the base station, UE capability signaling indicating a plurality of CSI compute costs corresponding to processing of the CSI report across different numbers of CSI processors.

In Example 15, the subject matter of Examples 1-14 includes functionalities such as wherein the time instance for allocation of the one or more CSI compute resources corresponds to one of a time instance for reception of downlink control information (DCI) triggering the CSI report, a location of a CSI reference resource in a time domain, or a latest time instance of a latest reference signal associated with the CSI report.

In Example 16, the subject matter of Examples 1-15 includes functionalities such as wherein the at least one CSI processor is selected based on a minimum number of occupied CSI compute resources across the one or more CSI processors at the time instance.

In Example 17, the subject matter of Examples 1-16 includes functionalities such as wherein the at least one CSI processor is selected based on a minimum CSI processor index among CSI processors having a number of unoccupied CSI compute resources greater than a CSI compute cost for the CSI report.

In Example 18, the subject matter of Examples 1-17 includes functionalities such as wherein the at least one CSI processor is selected based on an indication received from the base station in downlink control information (DCI) or based on radio resource control (RRC) configuration.

In Example 19, the subject matter of Examples 1-18 includes functionalities such as wherein when processing of a plurality of CSI reports starts in the time instance, the processing circuitry is to allocate CSI compute resources for the plurality of CSI reports in an order determined by a priority function.

In Example 20, the subject matter of Example 19 includes functionalities such as wherein the priority function is a function of at least one of a CSI report identifier, a CSI report quantity, a precoding matrix indicator (PMI) codebook, or a time-domain behavior associated with a CSI report of the plurality of CSI reports.

In Example 21, the subject matter of Examples 1-20 includes functionalities such as wherein the processing circuitry is to release all CSI compute resources previously allocated to the CSI report at a time instance offset from the time instance of allocation by a processing time period associated with the CSI report.

In Example 22, the subject matter of Examples 1-21 includes functionalities such as wherein the processing circuitry is to release CSI compute resources of a CSI processor of the one or more CSI processors periodically with a release time period.

In Example 23, the subject matter of Examples 1-22 includes functionalities such as wherein the CSI processing event corresponds to one of a normal CSI operation, a CSI processing overflow, or a failure to finish CSI processing for the CSI report.

In Example 24, the subject matter of Example 23 includes functionalities such as wherein the CSI processing overflow corresponds to a condition in which a CSI compute cost for the CSI report is greater than a number of unoccupied CSI compute resources of the at least one CSI processor at the time instance.

In Example 25, the subject matter of Examples 23-24 includes functionalities such as wherein when the CSI processing event corresponds to the CSI processing overflow for the CSI report, the processing circuitry is to omit the CSI report from transmission on a physical uplink shared channel (PUSCH) or a physical uplink control channel (PUCCH).

In Example 26, the subject matter of Examples 23-25 includes functionalities such as wherein when the CSI processing event corresponds to the CSI processing overflow for the CSI report, the processing circuitry is to encode, for transmission to the base station, a specified combination of CSI bits for the CSI report, the specified combination of CSI bits including at least one of all zero bits, an out-of-range channel quality indicator (CQI), or a dedicated bit indicating the CSI processing overflow.

In Example 27, the subject matter of Examples 23-26 includes functionalities such as wherein when the CSI processing event corresponds to the CSI processing overflow for the CSI report, the processing circuitry is to distribute CSI compute resources allocated for the CSI report across a plurality of CSI processors of the one or more CSI processors.

In Example 28, the subject matter of Examples 23-27 includes functionalities such as wherein the failure to finish CSI processing for the CSI report corresponds to a condition in which, at a time instance corresponding to transmission of the CSI report, one or more CSI compute resources remain allocated to the CSI report.

In Example 29, the subject matter of Example 28 includes functionalities such as wherein when the CSI processing event corresponds to the failure to finish CSI processing for the CSI report, the processing circuitry is to omit the CSI report from transmission on a physical uplink shared channel (PUSCH) or a physical uplink control channel (PUCCH), or to encode for transmission to the base station a specified combination of CSI bits for the CSI report.

In Example 30, the subject matter of Examples 1-29 includes functionalities such as wherein the one or more CSI reports are configured with at least one of a periodic time-domain behavior, a semi-persistent time-domain behavior, or an aperiodic time-domain behavior.

In Example 31, the subject matter of Examples 1-30 includes functionalities such as wherein the content of the CSI report includes at least one of a CSI reference signal resource indicator (CRI), a rank indicator (RI), a precoding matrix indicator (PMI), or a channel quality indicator (CQI).

In Example 32, the subject matter of Examples 1-31 includes functionalities such as wherein the processing circuitry is further to encode, for transmission to the base station, UE capability signaling indicating an alignment parameter, the alignment parameter including at least one of a number of time units associated with a number of CSI compute resources, a maximum number of CSI compute resources, a minimum processing time for a number of CSI compute resources, or a maximum number of CSI compute resource requests over a number of time units.

In Example 33, the subject matter of Examples 1-32 includes functionalities such as, further comprising: transceiver circuitry coupled to the processing circuitry; and one or more antennas coupled to the transceiver circuitry.

Example 34 is a computer-readable storage medium that stores instructions for execution by one or more processors of a user equipment (UE), the instructions to configure the UE for operation in a New Radio (NR) network, and to cause the UE to perform operations comprising: decoding configuration information for one or more channel state information (CSI) reports, the configuration information received from a base station; maintaining a state of one or more CSI processors of the UE, each CSI processor associated with a plurality of CSI compute resources, the state indicating occupancy of the CSI compute resources at a time instance; allocating, for a CSI report of the one or more CSI reports, one or more CSI compute resources of at least one CSI processor of the one or more CSI processors based on the state; determining a CSI processing event for the CSI report based on the state of the one or more CSI processors; and encoding, for transmission to the base station, content of the CSI report based on the CSI processing event.

In Example 35, the subject matter of Example 34 includes functionalities such as wherein the state of a CSI processor of the one or more CSI processors at the time instance is based on a number of occupied CSI compute resources at a previous time instance, a number of released CSI compute resources at the time instance, and a number of CSI compute resources newly occupied at the time instance.

In Example 36, the subject matter of Examples 34-35 includes functionalities such as wherein the operations further comprise encoding, for transmission to the base station, UE capability signaling indicating a number of CSI processors supported by the UE.

In Example 37, the subject matter of Examples 34-36 includes functionalities such as wherein a subset of the one or more CSI processors corresponds to a subset of CSI configurations, the subset of CSI configurations including at least one of CSI configurations based on artificial intelligence or machine learning (AI/ML), CSI configurations associated with a specified precoding matrix indicator (PMI) codebook, or CSI configurations associated with a specified CSI report quantity.

In Example 38, the subject matter of Examples 34-37 includes functionalities such as wherein the plurality of CSI compute resources of a CSI processor of the one or more CSI processors is organized as a double-ended queue, allocation of a CSI compute resource corresponding to an add operation on the double-ended queue, and release of a CSI compute resource corresponding to a remove operation on the double-ended queue.

In Example 39, the subject matter of Examples 34-38 includes functionalities wherein the operations further comprise storing, for a CSI compute resource of the one or more CSI compute resources allocated to the CSI report, an identifier of the CSI report.

In Example 40, the subject matter of Examples 34-39 includes functionalities wherein allocating the one or more CSI compute resources is based on a CSI compute cost for the CSI report, the CSI compute cost corresponding to a number of CSI compute resources to be allocated across one or more CSI processors for the CSI report.

In Example 41, the subject matter of Example 40 includes functionalities such as wherein the CSI compute cost is a function of at least one of a number of CSI reference signal (CSI-RS) resources configured for the CSI report, a number of CSI-RS ports per CSI-RS resource configured for the CSI report, a CSI-RS bandwidth configured for the CSI report, or a number of subbands configured for the CSI report.

In Example 42, the subject matter of Examples 34-41 includes functionalities such as wherein the time instance for allocation of the one or more CSI compute resources corresponds to one of a time instance for reception of downlink control information (DCI) triggering the CSI report, a location of a CSI reference resource in a time domain, or a latest time instance of a latest reference signal associated with the CSI report.

In Example 43, the subject matter of Examples 34-42 includes functionalities such as wherein the at least one CSI processor is selected based on a minimum number of occupied CSI compute resources across the one or more CSI processors at the time instance.

In Example 44, the subject matter of Examples 34-43 includes functionalities such as wherein the operations further comprise, when processing of a plurality of CSI reports starts in the time instance, allocating CSI compute resources for the plurality of CSI reports in an order determined by a priority function.

In Example 45, the subject matter of Examples 34-44 includes functionalities such as wherein the operations further comprise releasing all CSI compute resources previously allocated to the CSI report at a time instance offset from the time instance of allocation by a processing time period associated with the CSI report.

In Example 46, the subject matter of Examples 34-45 includes functionalities wherein the CSI processing event corresponds to one of a normal CSI operation, a CSI processing overflow, or a failure to finish CSI processing for the CSI report.

In Example 47, the subject matter of Example 46 includes functionalities wherein the CSI processing overflow corresponds to a condition in which a CSI compute cost for the CSI report is greater than a number of unoccupied CSI compute resources of the at least one CSI processor at the time instance.

In Example 48, the subject matter of Examples 46-47 includes functionalities such as wherein when the CSI processing event corresponds to the CSI processing overflow for the CSI report, the operations further comprise omitting the CSI report from transmission on a physical uplink shared channel (PUSCH) or a physical uplink control channel (PUCCH), or encoding, for transmission to the base station, a specified combination of CSI bits for the CSI report.

In Example 49, the subject matter of Examples 46-48 includes functionalities wherein the failure to finish CSI processing for the CSI report corresponds to a condition in which, at a time instance corresponding to transmission of the CSI report, one or more CSI compute resources remain allocated to the CSI report.

In Example 50, the subject matter of Examples 34-49 includes functionalities wherein the content of the CSI report includes at least one of a CSI reference signal resource indicator (CRI), a rank indicator (RI), a precoding matrix indicator (PMI), or a channel quality indicator (CQI).

Example 51 is a computer-readable storage medium that stores instructions for execution by one or more processors of a base station, the instructions to configure the base station for operation in a New Radio (NR) network, and to cause the base station to perform operations comprising: encoding, for transmission to a user equipment (UE), configuration information for one or more channel state information (CSI) reports; maintaining a state of one or more CSI processors assumed at the UE, each CSI processor associated with a plurality of CSI compute resources, the state indicating occupancy of the CSI compute resources at a time instance; determining, for a CSI report of the one or more CSI reports, an allocation of one or more CSI compute resources of at least one CSI processor of the one or more CSI processors based on the state; determining a CSI processing event for the CSI report based on the state of the one or more CSI processors; and decoding content of the CSI report received from the UE based on the CSI processing event.

In Example 52, the subject matter of Example 51 includes functionalities wherein the state of a CSI processor of the one or more CSI processors at the time instance is based on a number of occupied CSI compute resources at a previous time instance, a number of released CSI compute resources at the time instance, and a number of CSI compute resources newly occupied at the time instance.

In Example 53, the subject matter of Examples 51-52 includes functionalities wherein the operations further comprise decoding UE capability signaling received from the UE, the UE capability signaling indicating a number of CSI processors supported by the UE.

In Example 54, the subject matter of Examples 51-53 includes functionalities such as wherein a subset of the one or more CSI processors corresponds to a subset of CSI configurations, the subset of CSI configurations including at least one of CSI configurations based on artificial intelligence or machine learning (AI/ML), CSI configurations associated with a specified precoding matrix indicator (PMI) codebook, or CSI configurations associated with a specified CSI report quantity.

In Example 55, the subject matter of Examples 51-54 includes functionalities wherein the allocation of the one or more CSI compute resources is based on a CSI compute cost for the CSI report, the CSI compute cost corresponding to a number of CSI compute resources to be allocated across one or more CSI processors for the CSI report.

In Example 56, the subject matter of Example 55 includes functionalities such as wherein the CSI compute cost is a function of at least one of a number of CSI reference signal (CSI-RS) resources configured for the CSI report, a number of CSI-RS ports per CSI-RS resource configured for the CSI report, a CSI-RS bandwidth configured for the CSI report, or a number of subbands configured for the CSI report.

In Example 57, the subject matter of Examples 55-56 includes functionalities wherein the operations further comprise decoding UE capability signaling received from the UE, the UE capability signaling indicating a plurality of CSI compute costs corresponding to processing of the CSI report across different numbers of CSI processors.

In Example 58, the subject matter of Examples 51-57 includes functionalities such as wherein the time instance for the allocation of the one or more CSI compute resources corresponds to one of a time instance for transmission of downlink control information (DCI) triggering the CSI report, a location of a CSI reference resource in a time domain, or a latest time instance of a latest reference signal associated with the CSI report.

In Example 59, the subject matter of Examples 51-58 includes functionalities wherein the at least one CSI processor is selected based on a minimum number of occupied CSI compute resources across the one or more CSI processors at the time instance.

In Example 60, the subject matter of Examples 51-59 includes functionalities such as, wherein the operations further comprise encoding, for transmission to the UE in downlink control information (DCI) or via radio resource control (RRC) configuration, an indication of the at least one CSI processor assigned to the CSI report.

In Example 61, the subject matter of Examples 51-60 includes functionalities such as, wherein the CSI processing event corresponds to one of a normal CSI operation, a CSI processing overflow, or a failure to finish CSI processing for the CSI report.

In Example 62, the subject matter of Example 61 includes functionalities, wherein the CSI processing overflow corresponds to a condition in which a CSI compute cost for the CSI report is greater than a number of unoccupied CSI compute resources of the at least one CSI processor at the time instance.

In Example 63, the subject matter of Examples 61-62 includes functionalities such as, wherein when the CSI processing event corresponds to the CSI processing overflow for the CSI report, the operations further comprise detecting that the CSI report is omitted from a physical uplink shared channel (PUSCH) or a physical uplink control channel (PUCCH), or decoding a specified combination of CSI bits for the CSI report received from the UE.

In Example 64, the subject matter of Examples 51-63 includes functionalities such as, wherein the operations further comprise decoding UE capability signaling received from the UE, the UE capability signaling indicating an alignment parameter, the alignment parameter including at least one of a number of time units associated with a number of CSI compute resources, a maximum number of CSI compute resources, a minimum processing time for a number of CSI compute resources, or a maximum number of CSI compute resource requests over a number of time units.

In Example 65, the subject matter of Examples 51-64 includes functionalities such as, wherein the content of the CSI report includes at least one of a CSI reference signal resource indicator (CRI), a rank indicator (RI), a precoding matrix indicator (PMI), or a channel quality indicator (CQI).

Example 66 is a user equipment (UE) configured for operation in a New Radio (5G NR) network, the UE comprising: front-end circuitry coupled to one or more antennas; and processing circuitry coupled to the front-end circuitry, the processing circuitry is to: decode configuration information for one or more channel state information (CSI) reports, the configuration information received from a base station; maintain a state of one or more CSI processors of the UE, each CSI processor associated with a plurality of CSI compute resources, the state indicating occupancy of the CSI compute resources at a time instance; allocate, for a CSI report of the one or more CSI reports, one or more CSI compute resources of at least one CSI processor of the one or more CSI processors based on the state; determine a CSI processing event for the CSI report based on the state of the one or more CSI processors; and encode, for transmission to the base station, content of the CSI report based on the CSI processing event.

In Example 67, the subject matter of Example 66 includes functionalities such as, wherein the state of a CSI processor of the one or more CSI processors at the time instance is based on a number of occupied CSI compute resources at a previous time instance, a number of released CSI compute resources at the time instance, and a number of CSI compute resources newly occupied at the time instance.

In Example 68, the subject matter of Examples 66-67 includes functionalities such as, wherein the processing circuitry is further to encode, for transmission to the base station, UE capability signaling indicating a number of CSI processors supported by the UE.

In Example 69, the subject matter of Examples 66-68 includes functionalities such as, wherein the plurality of CSI compute resources of a CSI processor of the one or more CSI processors is organized as a double-ended queue, allocation of a CSI compute resource corresponding to an add operation on the double-ended queue, and release of a CSI compute resource corresponding to a remove operation on the double-ended queue.

In Example 70, the subject matter of Examples 66-69 includes functionalities, wherein the processing circuitry is to allocate the one or more CSI compute resources based on a CSI compute cost for the CSI report, the CSI compute cost corresponding to a number of CSI compute resources to be allocated across one or more CSI processors for the CSI report.

In Example 71, the subject matter of Example 70 includes functionalities such as, wherein the CSI compute cost is a function of at least one of a number of CSI reference signal (CSI-RS) resources configured for the CSI report, a number of CSI-RS ports per CSI-RS resource configured for the CSI report, a CSI-RS bandwidth configured for the CSI report, or a number of subbands configured for the CSI report.

In Example 72, the subject matter of Examples 66-71 includes functionalities such as, wherein the at least one CSI processor is selected based on a minimum number of occupied CSI compute resources across the one or more CSI processors at the time instance.

In Example 73, the subject matter of Examples 66-72 includes functionalities, wherein when processing of a plurality of CSI reports starts in the time instance, the processing circuitry is to allocate CSI compute resources for the plurality of CSI reports in an order determined by a priority function.

In Example 74, the subject matter of Examples 66-73 includes functionalities such as, wherein the processing circuitry is to release all CSI compute resources previously allocated to the CSI report at a time instance offset from the time instance of allocation by a processing time period associated with the CSI report.

In Example 75, the subject matter of Examples 66-74 includes functionalities such as, wherein the CSI processing event corresponds to one of a normal CSI operation, a CSI processing overflow, or a failure to finish CSI processing for the CSI report.

In Example 76, the subject matter of Example 75 includes functionalities such as, wherein when the CSI processing event corresponds to the CSI processing overflow for the CSI report, the processing circuitry is to omit the CSI report from transmission on a physical uplink shared channel (PUSCH) or a physical uplink control channel (PUCCH), or to encode, for transmission to the base station, a specified combination of CSI bits for the CSI report.

In Example 77, the subject matter of Examples 75-76 includes functionalities such as, wherein the failure to finish CSI processing for the CSI report corresponds to a condition in which, at a time instance corresponding to transmission of the CSI report, one or more CSI compute resources remain allocated to the CSI report.

In Example 78, the subject matter of Examples 66-77 includes functionalities such as, wherein the content of the CSI report includes at least one of a CSI reference signal resource indicator (CRI), a rank indicator (RI), a precoding matrix indicator (PMI), or a channel quality indicator (CQI).

Example 79 is at least one machine-readable medium including instructions that, when executed by processing circuitry, cause the processing circuitry to perform operations to implement any of Examples 1-78.

Example 80 is an apparatus comprising means to implement any of Examples 1-78.

Example 81 is a system to implement any of Examples 1-78.

Example 82 is a method to implement any of Examples 1-78.

Example 83 is at least one machine-readable storage including machine-readable instructions, which, when executed, cause a computer to implement a method or a process as claimed in any of Examples 1-78.

Example 84 is a computer program comprising instructions which, when the program is executed by a computer, cause the computer to carry out one or more operations according to at least one of Examples 1-78.

Example 85 is an apparatus comprising means to perform a method or a process as recited by at least one of Examples 1-78.

Example 86 is a computer storage medium that stores instructions for execution by one or more processors of a communication device, the instructions to cause the communication device to perform a method or a process as recited by at least one of Examples 1-78.

Although an aspect has been described concerning specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus for a user equipment (UE) configured for operation in a New Radio (NR) network, the apparatus comprising:
processing circuitry, wherein the processing circuitry is to:
decode configuration information for one or more channel state information (CSI) reports, the configuration information received from a base station;
maintain a state of one or more CSI processors of the UE, each CSI processor associated with a plurality of CSI compute resources, the state indicating occupancy of the CSI compute resources at a time instance;
allocate, for a CSI report of the one or more CSI reports, one or more CSI compute resources of at least one CSI processor of the one or more CSI processors based on the state;
determine a CSI processing event for the CSI report based on the state of the one or more CSI processors; and
encode, for transmission to the base station, content of the CSI report based on the CSI processing event; and
memory coupled to the processing circuitry and configured to store the configuration information.

2. The apparatus of claim 1, wherein the state of a CSI processor of the one or more CSI processors at the time instance is based on a number of occupied CSI compute resources at a previous time instance, a number of released CSI compute resources at the time instance, and a number of CSI compute resources newly occupied at the time instance.

3. The apparatus of claim 1, wherein the processing circuitry is further to encode, for transmission to the base station, UE capability signaling indicating a number of CSI processors supported by the UE.

4. The apparatus of claim 3, wherein the one or more CSI processors include a first CSI processor of a first type associated with a first number of CSI compute resources and a second CSI processor of a second type associated with a second number of CSI compute resources, the first number being different from the second number.

5. The apparatus of claim 1, wherein a subset of the one or more CSI processors corresponds to a subset of CSI configurations, the subset of CSI configurations including at least one of CSI configurations based on artificial intelligence or machine learning (AI/MIL), CSI configurations associated with a specified precoding matrix indicator (PMI) codebook, or CSI configurations associated with a specified CSI report quantity.

6. The apparatus of claim 1, wherein at least one of the CSI compute resources of a CSI processor of the one or more CSI processors is further associated with processing of a non-CSI feature, the non-CSI feature including at least one of link failure detection, radio resource management for mobility, or beam management.

7. The apparatus of claim 1, wherein the plurality of CSI compute resources of a CSI processor of the one or more CSI processors is organized as a double-ended queue, allocation of a CSI compute resource corresponding to an add operation on the double-ended queue and release of a CSI compute resource corresponding to a remove operation on the double-ended queue.

8. The apparatus of claim 1, wherein the processing circuitry is further to store, for a CSI compute resource of the one or more CSI compute resources allocated to the CSI report, an identifier of the CSI report.

9. The apparatus of claim 8, wherein the processing circuitry is further to store, in association with the CSI compute resource, at least one of a precoding matrix indicator (PMI) codebook associated with the CSI report or a CSI report quantity associated with the CSI report.

10. The apparatus of claim 1, wherein the processing circuitry is further to overlap processing of a plurality of CSI reports on a subset of the CSI compute resources of a CSI processor of the one or more CSI processors, a full overlap of the plurality of CSI reports on a same set of CSI compute resources corresponding to parallel processing and a partial overlap of the plurality of CSI reports on a subset of CSI compute resources corresponding to pipelined processing.

11. The apparatus of claim 1, wherein the one or more CSI reports are configured with at least one of a periodic time-domain behavior, a semi-persistent time-domain behavior, or an aperiodic time-domain behavior.

12. The apparatus of claim 1, further comprising:
transceiver circuitry coupled to the processing circuitry; and
one or more antennas coupled to the transceiver circuitry.

13. A non-transitory computer-readable storage medium that stores instructions for execution by one or more processors of a base station, the instructions to configure the base station for operation in a New Radio (NR) network, and to cause the base station to perform operations comprising:
encoding, for transmission to a user equipment (UE), configuration information for one or more channel state information (CSI) reports;
maintaining a state of one or more CSI processors assumed at the UE, each CSI processor associated with a plurality of CSI compute resources, the state indicating occupancy of the CSI compute resources at a time instance;
determining, for a CSI report of the one or more CSI reports, an allocation of one or more CSI compute resources of at least one CSI processor of the one or more CSI processors based on the state;
determining a CSI processing event for the CSI report based on the state of the one or more CSI processors; and
decoding content of the CSI report received from the UE based on the CSI processing event.

14. The non-transitory computer-readable storage medium of claim 13, wherein the state of a CSI processor of the one or more CSI processors at the time instance is based on a number of occupied CSI compute resources at a previous time instance, a number of released CSI compute resources at the time instance, and a number of CSI compute resources newly occupied at the time instance.

15. The non-transitory computer-readable storage medium of claim 13, wherein the operations further comprise decoding UE capability signaling received from the UE, the UE capability signaling indicating a number of CSI processors supported by the UE.

16. The non-transitory computer-readable storage medium of claim 13, wherein a subset of the one or more CSI processors corresponds to a subset of CSI configurations, the subset of CSI configurations including at least one of CSI configurations based on artificial intelligence or machine learning (AI/ML), CSI configurations associated with a specified precoding matrix indicator (PMI) codebook, or CSI configurations associated with a specified CSI report quantity.

17. A user equipment (UE) configured for operation in a New Radio (5G NR) network, the UE comprising:
front-end circuitry coupled to one or more antennas; and
processing circuitry coupled to the front-end circuitry, the processing circuitry is to:
decode configuration information for one or more channel state information (CSI) reports, the configuration information received from a base station;
maintain a state of one or more CSI processors of the UE, each CSI processor associated with a plurality of CSI compute resources, the state indicating occupancy of the CSI compute resources at a time instance;
allocate, for a CSI report of the one or more CSI reports, one or more CSI compute resources of at least one CSI processor of the one or more CSI processors based on the state;
determine a CSI processing event for the CSI report based on the state of the one or more CSI processors; and
encode, for transmission to the base station, content of the CSI report based on the CSI processing event.

18. The UE of claim 17, wherein the state of a CSI processor of the one or more CSI processors at the time instance is based on a number of occupied CSI compute resources at a previous time instance, a number of released CSI compute resources at the time instance, and a number of CSI compute resources newly occupied at the time instance.

19. The UE of claim 17, wherein the processing circuitry is further to encode, for transmission to the base station, UE capability signaling indicating a number of CSI processors supported by the UE.

20. The UE of claim 17, wherein the plurality of CSI compute resources of a CSI processor of the one or more CSI processors is organized as a double-ended queue, allocation of a CSI compute resource corresponding to an add operation on the double-ended queue and release of a CSI compute resource corresponding to a remove operation on the double-ended queue.
